(19) United States
(12) Patent Application Publication
(10) Pub. No.: US 2026/0219476 A1
(43) Pub. Date: Jul. 30, 2026

(54) OPTICAL SYSTEM AND CAMERA MODULE

(71) Applicant: LG INNOTEK CO., LTD., Seoul (KR)

(72) Inventors: Hye Jung JEONG, Seoul (KR); Kyung Tae KIM, Seoul (KR)

(21) Appl. No.: 19/141,448

(22) PCT Filed: Dec. 19, 2023
(86) PCT No.: PCT/KR2023/020929

§ 371 Date: Jun. 20, 2025

(30) Foreign Application Priority Data
Dec. 19, 2022 (KR) 10-2022-0178792
Dec. 19, 2022 (KR) 10-2022-0178793

(51) Int. Cl. G02B 13/00; G02B 9/64

(52) U.S. Cl. CPC G02B 13/0045; G02B 9/64

(57) ABSTRACT

An optical system according to an embodiment of the present invention comprises, in sequence from an object side to an image side: a first lens having negative (−) refractive power; a second lens having negative (−) refractive power; a third lens having positive (+) refractive power; a fourth lens having positive (+) refractive power; a fifth lens; a sixth lens; a seventh lens having positive (+) refractive power; an eighth lens; and a ninth lens.

### TECHNICAL FIELDS

The teachings in accordance with exemplary and non-limiting embodiments of the present invention relate generally to an optical system for improved optical performance and a camera module including the same.

### Background Arts of the Invention

Recently, camera modules for communication terminals, digital still cameras (DSCs), camcorders, and PC cameras (imaging devices attached to personal computers) have been studied in relation to image pick-up systems. Among the camera modules related to image pick-up systems, one of the most critical components for capturing images is the imaging lens, which forms the image.

Portable devices such as mobile phones or vehicle cameras are increasingly being miniaturized and/or lightweighted. In line with this trend, imaging lenses are also being miniaturized. Additionally, alongside the miniaturization of imaging lenses, high performance is also required for imaging lenses in response to the high performance of light-receiving elements.

### SUMMARY OF THE INVENTION

### Technical Subject

The present invention is intended to provide an imaging lens capable of wide-angle shooting.

In addition, the present invention is intended to provide an imaging lens that is compact and suitable for high resolution.

Furthermore, the present invention is intended to provide an imaging lens with excellent aberration characteristics and good aberration correction capability.

### Technical Solution

To solve the above technical problems, the optical system according to an embodiment of the present invention comprises, in order from an object side to a sensor side, a first lens having a negative (−) refractive power; a second lens having a positive (+) refractive power; a third lens; a fourth lens having a negative (−) refractive power; a fifth lens having a positive (+) refractive power; a sixth lens; a seventh lens having a positive (+) refractive power; an eighth lens having a negative (−) refractive power; a ninth lens having a positive (+) refractive power; and a tenth lens having a negative (−) refractive power.

Preferably, but not necessarily, the ninth lens may have the greatest thickness among the first to tenth lenses on the optical axis.

Preferably, but not necessarily, the thickness of the ninth lens on the optical axis may be greater than the thickness of the tenth lens.

Preferably, but not necessarily, the thickness of the ninth lens on the optical axis may be greater than the distance between the ninth lens and the tenth lens.

Preferably, but not necessarily, the thickness of the second lens along the optical axis may be greater than the distance between the seventh and eighth lenses.

Preferably, but not necessarily, the second lens may have a convex shape on both sides.

Preferably, but not necessarily, the tenth lens may have a convex meniscus shape toward the object side.

Preferably, but not necessarily, the following condition may be satisfied.

$$1 < TTL / F < 2 \qquad < Condition >$$

(In the above condition, TTL refers to the distance from the object side of the first lens on the optical axis to the image sensor, and F refers to the total focal length).

Preferably, but not necessarily, the following condition may be satisfied

$$0.5 < TTL / ImgH * 2 < 0.9 \qquad < Condition >$$

(In the above condition, TTL refers to the distance from the object side surface of the first lens to the image sensor along the optical axis, and ImgH refers to the diagonal length of the image sensor along the optical axis).

Preferably, but not necessarily, the following condition may be satisfied.

$$4 < L 10 R 1 / CT 10 < 30 \qquad < Condition >$$

(In the above condition, L10R1 denotes the curvature radius of the object side of the tenth lens, and CT10 denotes the thickness of the tenth lens from the optical axis).

To solve the above technical problems, the optical system according to another embodiment of the present invention may comprise, in order from the object side to the sensor side: a first lens having a negative (−) refractive power; a second lens having a negative (−) refractive power; a third lens having a positive (+) refractive power; a fourth lens having a positive (+) refractive power; a fifth lens; a sixth lens; a seventh lens having a positive (+) refractive power; an eighth lens; and a ninth lens.

Preferably, but not necessarily, along the optical axis, the thickness of the first lens among the first to ninth lenses may be the smallest.

Preferably, but not necessarily, among the first to seventh lenses, the absolute value of the focal length of the first lens may be the largest.

Preferably, but not necessarily, along the optical axis, the thickness of the first lens may be smaller than the thickness of the second lens.

Preferably, but not necessarily, the thickness of the sixth lens on the optical axis may be smaller than the thickness of the seventh lens.

Preferably, but not necessarily, the distance between the fifth lens and the sixth lens on the optical axis may be greater than the distance between the eighth lens and the ninth lens.

Preferably, but not necessarily, the fifth lens and the sixth lens may have a negative (−) refractive power, and the eighth lens and the ninth lens may have a negative (−) refractive power.

Preferably, but not necessarily, a first lens group comprising the first to third lenses and a second lens group comprising the fourth to ninth lenses may be included, and the focal length of the first lens group may be shorter than the focal length of the second lens group.

Preferably, but not necessarily, the absolute value of the difference between the focal length of the first lens group and the focal length of the second lens group may satisfy the condition of being 0 or greater and 10 or less.

Preferably, but not necessarily, the following condition may be satisfied:

$$0.5 < TTL / ImgH * 2 < 1 \qquad < Condition >$$

(In the above condition, TTL denotes the distance from the object side surface of the first lens on the optical axis to the image sensor, and ImgH denotes the diagonal length of the image sensor on the optical axis).

### Advantageous Effects

The optical system and camera module according to the embodiments may have improved optical characteristics. In detail, in the optical system according to the embodiment, multiple lenses may have a set thickness, refractive power, and gap (spacing) between adjacent lenses. Accordingly, the optical system and camera module according to the embodiments may have improved MTF characteristics, aberration control characteristics, resolution characteristics, etc., within a set field of view range, and may have good optical performance in the peripheral region of the field of view.

Additionally, the optical system and camera module according to the embodiments can satisfy the specified field of view and achieve excellent optical characteristics. As a result, the optical system can provide a slimmer camera module. Therefore, the optical system and camera module can be provided for various applications and devices.

### BRIEF DESCRIPTION OF DRAWINGS

FIG. 1 is a side cross-sectional view of the optical system and a camera module having the same according to the first embodiment.

FIG. 2 is a table showing the values of the aspheric coefficients of each lens surface and the conic constants (k) in the optical system according to the first embodiment.

FIG. 3 is a table showing the Sag values of the object side surface and sensor side surface of the ninth lens and tenth lens according to the first embodiment.

FIG. 4 is a side cross-sectional view of the optical system and the camera module comprising the same according to the second embodiment.

FIG. 5 is a table showing the values of the aspheric coefficients and the conic constants (k) of each lens surface in the optical system according to the second embodiment.

FIG. 6 is a table showing the Sag values of the object side surface and sensor side surface of the ninth lens and tenth lens according to the second embodiment.

FIG. 7 is a side cross-sectional view of the optical system and a camera module comprising the same according to the third embodiment.

FIG. 8 is a table showing the values of the aspheric coefficients and the conic constants (k) of each lens surface in the optical system according to the third embodiment.

FIG. 9 is a table showing the Sag values of the object side surface and sensor side surface of the ninth lens and tenth lens according to the third embodiment.

FIG. 10 is a side cross-sectional view of the optical system and a camera module having the same according to the fourth embodiment.

FIG. 11 is a table showing the values of the aspheric coefficients and the conic constants (k) of each lens surface in the optical system according to the fourth embodiment.

FIG. 12 is a table showing the Sag values of the object side and sensor side of the ninth lens and tenth lens according to the fourth embodiment.

FIG. 13 is a side cross-sectional view of the optical system and a camera module having the same according to the fifth embodiment.

FIG. 14 is a table showing the values of the aspheric coefficients and the conic constants (k) for each lens surface in the optical system according to the fifth embodiment.

FIG. 15 is a table showing the thickness of each lens and the gap (spacing) between adjacent lenses in the optical system according to the fifth embodiment.

FIG. 16 is a table showing the Sag values of each lens surface in the optical system according to the fifth embodiment.

FIG. 17 is a graph showing data on the aberration characteristics of the optical system according to the fifth embodiment.

FIG. 18 is a graph showing data on the diffraction MTF (Modulation Transfer Function) of the optical system according to the fifth embodiment.

FIG. 19 is a cross-sectional view of the optical system and a camera module having the same according to the sixth embodiment.

FIG. 20 is a table showing the values of the aspheric coefficients and the conic constants (k) of each lens surface in the optical system according to the sixth embodiment.

FIG. 21 is a table showing the thickness of each lens and the spacing between adjacent lenses in the optical system according to the sixth embodiment.

FIG. 22 is a table showing the Sag values of each lens surface in the optical system according to the sixth embodiment.

FIG. 23 is a graph showing data on the aberration characteristics of the optical system according to the sixth embodiment.

FIG. 24 is a graph showing data on the diffraction MTF (Modulation Transfer Function) of the optical system according to the sixth embodiment.

FIG. 25 is a side cross-sectional view of the optical system and a camera module comprising the same according to the seventh embodiment.

FIG. 26 is a table showing the values of the aspheric coefficients and the conic constants (k) of each lens surface in the optical system according to the seventh embodiment.

FIG. 27 is a table showing the thickness of each lens and the spacing between adjacent lenses in the optical system according to the seventh embodiment.

FIG. 28 is a table showing the Sag values of each lens surface in the optical system according to the seventh embodiment.

FIG. 29 is a graph showing data on the aberration characteristics of the optical system according to the seventh embodiment.

FIG. 30 is a graph showing data on the diffraction MTF (Modulation Transfer Function) of the optical system according to the seventh embodiment.

FIG. 31 is an exploded perspective view of the camera module according to the present embodiment.

### BEST MODE

Hereinafter, exemplary embodiments of the present invention will be described in detail with reference to the accompanying drawings.

However, the present invention is not limited to the given exemplary embodiments described, but may be implemented in a variety of different forms, and one or more of components among the exemplary embodiments may be optionally combined or substituted between embodiments within the scope of the present invention.

Furthermore, terms (including technical and scientific terms) used in the embodiments of the present invention, unless expressly specifically defined and described, are to be interpreted in the sense in which they would be understood by a person of ordinary skill in the art to which the present invention belongs, and commonly used terms, such as dictionary-defined terms, are to be interpreted in light of their contextual meaning in the relevant art.

Furthermore, the terms used in the embodiments of the invention are intended to describe the embodiments and are not intended to limit the invention.

In this specification, the singular may include the plural unless the context otherwise requires, and references to “at least one (or more) of A and (or) B and C” may include one or more of any combination of A, B, and C that may be assembled.

In addition, the terms first, second, A, B, (a), (b), and the like may be used to describe components of embodiments of the invention. Such terms are intended only to distinguish one component from another, and are not intended to limit the nature or sequence or order of such components by such terms.

Furthermore, when a component is described as “connected,” “coupled,” or “attached” to another component, it can include cases where the component is “connected,” “coupled,” or “attached” to the other component directly, as well as cases where the component is “connected,” “coupled,” or “attached” to another component that is between the component and the other component.

Still furthermore, when described as being formed or disposed “above” or “below” each component, “above” or “below” includes not only when two components are in direct contact with each other, but also when one or more other components are formed or disposed between the two components. Furthermore, when expressed as “above” or “below”, it may include the meaning of upward as well as downward with respect to a single component.

In the description of the invention, ‘object side surface’ may refer to the surface of the lens facing the object side with respect to the optical axis (OA), and ‘sensor side surface’ may refer to the surface of the lens facing the imaging surface (image sensor) with respect to the optical axis. ‘Object side surface’ may be referred to as “object surface,” and “sensor side surface” may be referred to as “image surface.” A convex surface of a lens may refer to a convex shape on the optical axis or paraxial region, and a concave surface of a lens may refer to a concave shape on the optical axis or paraxial region. The curvature radius, center thickness, and optical axis gap (spacing) between lenses listed in the lens data table may refer to values measured along the optical axis (unit: mm). The vertical direction may refer to the direction perpendicular to the optical axis, and the end of the lens or lens surface may refer to the end of the effective area of the lens through which incident light passes. The size of the effective diameter of the lens surface may have a measurement error of up to +0.4 mm depending on the measurement method. The term ‘paraxial region (near-axis) region’ refers to a very narrow area near the optical axis, where the distance from the optical axis (OA) to the light rays is almost zero. Hereinafter, the term ‘optical axis’ may refer to the center of each lens or a very narrow area near the optical axis.

The effective diameter is the diameter of the effective area (region) where effective light enters each lens. The effective diameter is the length in the direction perpendicular to the optical axis (X, Y), and it is the average of the effective diameters on the object side surface and the sensor side surface of each lens. ‘Lens diameter’ may refer to the ‘effective diameter of the lens.’ ‘Lens diameter’ may refer to the overall diameter of the lens, including the flange portion of the lens beyond the effective area. Although the flange of the lens is not shown in the drawing, the flange may be the portion protruding from the side of the lens in a direction perpendicular to the optical axis for the purpose of attaching the lens to the barrel. The flange may not allow effective light to enter. Spacers may be additionally arranged between the flanges of different lenses for the purpose of attaching the lenses to the barrel.

Each lens may include an effective area and an ineffective area. The effective area may be the area through which light incident on each lens passes. In other words, the effective area may be defined as the effective region or effective path where incident light is refracted to realize optical characteristics. The ineffective area may be arranged around the effective area. The ineffective area may be the region where effective light does not enter in multiple lenses. In other words, the ineffective area may be a region unrelated to optical characteristics. Additionally, the edges of the ineffective area may be regions fixed to lens barrels or other structures that accommodate the lenses.

The configuration of the optical system according to the first embodiment of the present invention will be described below with reference to the drawings.

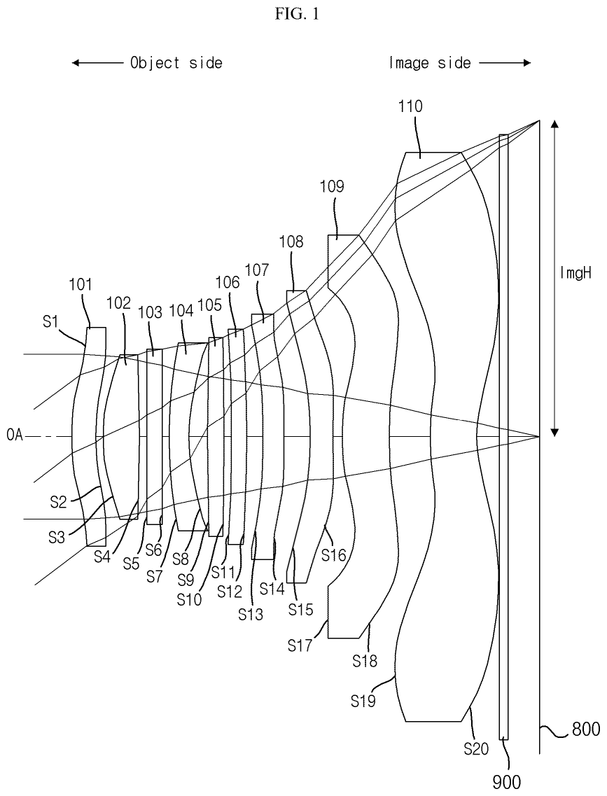

FIG. 1 is a side cross-sectional view of an optical system and a camera module having the same according to the first embodiment.

The optical system according to the first embodiment may include a lens unit, which may include a first lens (101) to a tenth lens (110). The first to tenth lenses (101, 102, 103, 104, 105, 106, 107, 108, 109, 110) may be disposed sequentially along the optical axis (OA). Light corresponding to the information of the object may pass through the first lens (101) to the tenth lens (110) and the filter (900) and enter the image sensor (800). The lens unit may be disposed, in order from an object side to an image side, the first lens (101), the aperture (STOP), the second lens (102), the third lens (103), the fourth lens (104), the fifth lens (105), the sixth lens (106), the seventh lens (107), the eighth lens (108), the ninth lens (109), and the tenth lens (110). The imaging lens according to the first embodiment may be composed of eight or fewer lenses. Alternatively, the imaging lens according to the first embodiment may be composed of nine or more lenses.

In other embodiments, one or more additional lenses, plates, or optical elements may be added between the first lens (101) and the tenth lens (110). Additionally, one or more additional lenses, plates, or optical elements may be added in front of the first lens (101) or behind the tenth lens (110). Furthermore, one or more additional lenses, plates, or optical elements may be added between the aperture (STOP) and the lens, between the lens and the filter (900), and between the filter (900) and the image sensor (800). In this case, the filter (900) may be a plate lens. The refractive power of the plate lens may be ‘0’. The refractive power of the flat lens may be zero.

Additionally, a filter layer may be disposed between the aperture (STOP) and the lens, between the lens and the filter (900), and between the filter (900) and the image sensor (800). In this case, the filter layer may be coated to function as a filter.

The lens unit may include a first lens (101). The first lens (101) may be closest to the object side. The first lens (101) may be the first lens disposed on the object side. The first lens (101) may be the first lens adjacent to the object side. An additional lens may be disposed between the first lens (101) and the second lens (102). The second to eighth lenses (102, 103, 104, 105, 106, 107, 108) may be disposed between the first lens (101) and the tenth lens (110). Between the first lens (101) and the tenth lens (110), additional lenses other than the second to ninth lenses (102, 103, 104, 105, 106, 107, 108, 109) may be disposed. At least two lenses may be additionally disposed between the first to tenth lenses (101, 102, 103, 104, 105, 106, 107, 108, 109, 110).

The first lens (101) may have a negative (−) refractive power. The first lens (101) may have a convex meniscus shape on the object side. The first lens (101) may have the object side (S1) formed convexly. The first lens (101) may have the object side (S1) formed convexly relative to the optical axis. The first lens (101) may have a concave upper surface (S2). The first lens (101) may have a concave upper side surface (S2) relative to the optical axis. The object side surface or upper side surface of the first lens (101) may include at least one inflection point.

The curvature radius of the object side surface (S1) of the first lens (101) may be positive. The curvature radius of the object side surface (S1) of the first lens (101) relative to the optical axis may be positive. The curvature radius of the upper side surface (S2) of the first lens (101) may be positive. The curvature radius of the upper side surface (S2) of the first lens (101) along the optical axis may be positive. The absolute value of the curvature radius of the object side surface (S1) of the first lens (101) may be greater than the absolute value of the curvature radius of the upper side surface (S2) of the first lens (101). The first lens (101) may be a solid lens. Both surfaces of the first lens (101) may be formed as aspherical surfaces. One of the two surfaces of the first lens (101) may be formed as a spherical surface, and the other surface may be formed as an aspherical surface.

The first lens (101) may satisfy the range of 1.5<N1<1.6. Additionally, the first lens (101) may satisfy the range of 1.52<N1<1.58. N1 is the refractive index of the first lens (101). The first lens (101) may satisfy the range of 50<V1<60. Additionally, the first lens (101) may satisfy the range of 52<V1<58. V1 is the Abbe number of the first lens (101).

The lens unit may include a second lens (102). The second lens (102) may be the second lens disposed from the object side. The second lens (102) may be the second lens adjacent to the first lens (101) from the object side. The second lens (102) may be disposed between the first lens (101) and the image side. The second lens (102) may be disposed between the first lens (101) and the third lens (103). An additional lens may be disposed between the second lens (102) and the first lens (101) or between the second lens (102) and the third lens (103).

The second lens (102) may have a positive (+) refractive power. The second lens (102) may be formed with both surfaces convex. The second lens (102) may be formed with the object side (S3) convex. The second lens (102) may be formed with the object side (S3) convex relative to the optical axis. The second lens (102) may have an upper side surface (S4) formed concavely. The second lens (102) may have the upper side surface (S4) formed concavely relative to the optical axis. The object side (S3) or upper side surface (S4) of the second lens (102) may include at least one inflection point.

The curvature radius of the object side surface (S3) of the second lens (102) may be positive. The curvature radius of the object side surface (S3) of the second lens (102) on the optical axis may be positive. The curvature radius of the upper side surface (S4) of the second lens (102) may be negative. The curvature radius of the second lens (102) on the optical axis of the upper side surface (S4) may be negative. The absolute value of the curvature radius of the object side surface (S3) of the second lens (102) may be smaller than the absolute value of the curvature radius of the upper side surface (S4) of the second lens (102). The second lens (102) may be a solid lens. Both surfaces of the second lens (102) may be formed as aspherical surfaces. One of the two surfaces of the second lens (102) may be formed as a spherical surface, and the other surface may be formed as an aspherical surface.

The second lens (102) may satisfy the range 1.5<N2<1.6. Additionally, the second lens (102) may satisfy the range 1.52<N2<1.58. N2 is the refractive index of the second lens (102). The second lens (102) may satisfy the range 50<V2<60. Additionally, the second lens (102) may satisfy the range 55<V2<58. V2 is the Abbe number of the second lens (102).

The lens unit may include a third lens (103). The third lens (103) may be the third lens disposed from the object side. The third lens (103) may be the third lens adjacent to the object side. The third lens (103) may be disposed between the second lens (102) and the image side. The third lens (103) may be disposed between the second lens (102) and the fourth lens (104). An additional lens may be disposed between the third lens (103) and the second lens (102) or between the third lens (103) and the fourth lens (104).

The third lens (103) may have a positive (+) refractive power. The third lens (103) may be formed with both sides convex. The third lens (103) may be formed with the object side (S5) convex. The third lens (103) may be formed with the object side (S5) convex relative to the optical axis. The third lens (103) may have an upper side surface (S6) formed convexly. The third lens (103) may have the upper side surface (S6) formed convexly relative to the optical axis. The object side surface or upper side surface of the third lens (103) may include at least one inflection point.

The curvature radius of the object side surface (S5) of the third lens (103) may be positive. The curvature radius of the object side surface (S5) of the third lens (103) relative to the optical axis may be positive. The curvature radius of the upper side surface (S6) of the third lens (103) may be negative. The curvature radius of the upper side surface (S6) of the third lens (103) along the optical axis may be negative. The absolute value of the curvature radius of the object side surface of the third lens (103) may be greater than the absolute value of the curvature radius of the upper side surface of the third lens (103). The third lens (103) may be a solid lens. Both surfaces of the third lens (103) may be formed as aspherical surfaces. One of the two surfaces of the third lens (103) may be formed as a spherical surface, and the other surface may be formed as an aspherical surface.

The third lens (103) may satisfy the range of 1.5<N3<1.6. Additionally, the third lens (103) may satisfy the range of 1.52<N3<1.58. N3 is the refractive index of the third lens (103). The third lens (103) may satisfy the range of 50<V3<60. Additionally, the third lens (103) may satisfy the range of 52<V3<58. V3 is the Abbe number of the third lens (103).

The lens unit may include a fourth lens (104). The fourth lens (104) may be the fourth lens disposed from the object side. The fourth lens (104) may be the seventh lens disposed from the image side. The fourth lens (104) may be disposed between the third lens (103) and the image side. The fourth lens (104) may be disposed between the third lens (103) and the fifth lens (105). An additional lens may be disposed between the fourth lens (104) and the third lens (103) or between the fourth lens (104) and the fifth lens (105).

The fourth lens (104) may have a negative (−) refractive power. The fourth lens (104) may have a convex meniscus shape on the object side. The fourth lens (104) may have a convex object side surface (S7). The fourth lens (104) may have a convex object side surface (S7) relative to the optical axis. The fourth lens (104) may have a concave upper side surface (S8). The fourth lens (104) may have an upper side surface (S8) that is concave relative to the optical axis. The object side surface or upper side surface of the fourth lens (104) may include at least one inflection point.

The curvature radius of the object side surface (S7) of the fourth lens (104) may be positive. The curvature radius of the object side surface (S7) of the fourth lens (104) on the optical axis may be positive. The curvature radius of the upper side surface (S8) of the fourth lens (104) may be positive. The curvature radius of the fourth lens (104) on the optical axis of the upper side surface (S8) may be positive. The absolute value of the curvature radius of the object side surface (S7) of the fourth lens (104) may be greater than the absolute value of the curvature radius of the upper side surface (S8) of the fourth lens (104). The fourth lens (104) may be a solid lens. Both surfaces of the fourth lens (104) may be formed as aspherical surfaces. One of the two surfaces of the fourth lens (104) may be formed as a spherical surface, and the other surface may be formed as an aspherical surface.

The fourth lens (104) may satisfy the range 1.6<N4<1.7. Additionally, the fourth lens (104) may satisfy the range 1.65<N4<1.7. N4 is the refractive index of the fourth lens (104). The fourth lens (104) may satisfy the range 15<V4<30. Additionally, the fourth lens (104) may satisfy the range 17<V4<20. V4 is the Abbe number of the fourth lens (104).

The lens unit may include a fifth lens (105). The fifth lens (105) may be the fifth lens disposed from the object side. The fifth lens (105) may be the sixth lens disposed from the image side. The fifth lens (105) may be disposed between the fourth lens (104) and the upper side. The fifth lens (105) may be disposed between the fourth lens (104) and the sixth lens (106). An additional lens may be disposed between the fifth lens (105) and the fourth lens (104) or between the fifth lens (105) and the sixth lens (106).

The fifth lens (105) may have a positive (+) refractive power. The fifth lens (105) may have a shape that is convex on both sides. The fifth lens (105) may have an object side surface (S9) that is convex. The fifth lens (105) may have an object side surface (S9) that is convex relative to the optical axis. The fifth lens (105) may have an upper side surface (S10) formed convexly. The fifth lens (105) may have the upper side surface (S10) formed convexly relative to the optical axis. The object side surface or upper side surface of the fifth lens (105) may include at least one inflection point.

The curvature radius of the object side (S9) of the fifth lens (105) may be positive. The curvature radius of the object side surface (S9) of the fifth lens (105) relative to the optical axis may be positive. The curvature radius of the upper side surface (S10) of the fifth lens (105) may be negative. The curvature radius of the upper side surface (S10) of the fifth lens (105) along the optical axis may be negative. The absolute value of the curvature radius of the object side surface (S9) of the fifth lens (105) may be greater than the absolute value of the curvature radius of the upper side surface (S10) of the fifth lens (105). The fifth lens (105) may be a solid lens. Both surfaces of the fifth lens (105) may be formed as aspherical surfaces. One of the two surfaces of the fifth lens (105) may be formed as a spherical surface, and the other surface may be formed as an aspherical surface.

The fifth lens (105) may satisfy the range 1.5<N5<1.6. Additionally, the fifth lens (105) may satisfy the range 1.52<N5<1.58. N5 is the refractive index of the fifth lens (105). The fifth lens (105) may satisfy the range 50<V5<60. Additionally, the fifth lens (105) may satisfy the range 52<V5<58. V5 is the Abbe number of the fifth lens (105).

The lens unit may include a sixth lens (106). The sixth lens (106) may be the sixth lens disposed from the object side. The sixth lens (106) may be the fifth lens disposed from the image side. The sixth lens (106) may be disposed between the fifth lens (105) and the seventh lens (107). The sixth lens (106) may be disposed between the fifth lens (105) and the image side. An additional lens may be disposed between the sixth lens (106) and the fifth lens (105) or between the sixth lens (106) and the seventh lens (107).

The sixth lens (106) may have a positive (+) refractive power. The sixth lens (106) may have a convex meniscus shape on the image side. The sixth lens (106) may have an object side surface (S11) formed concavely. The sixth lens (106) may have the object side surface (S11) formed concavely relative to the optical axis. The sixth lens (106) may have an upper side surface (S12) formed convexly. The sixth lens (106) may have the upper side surface (S12) convex relative to the optical axis. The object side surface or upper side surface of the sixth lens (106) may include at least one inflection point.

The curvature radius of the object side surface (S11) of the sixth lens (106) may be negative. The curvature radius of the object side surface (S11) of the sixth lens (106) relative to the optical axis may be negative. The curvature radius of the upper side surface (S12) of the sixth lens (106) may be negative. The curvature radius of the upper side surface (S12) of the sixth lens (106) along the optical axis may be negative. The absolute value of the curvature radius of the object side surface of the sixth lens (106) may be greater than the absolute value of the curvature radius of the upper side surface of the sixth lens (106). The sixth lens (106) may be a solid lens. Both surfaces of the sixth lens (106) may be formed as aspherical surfaces. One of the two surfaces of the sixth lens (106) may be formed as a spherical surface, and the other surface may be formed as an aspherical surface. The sixth lens (106) may have a surface including one or more inflection points.

The sixth lens (106) may satisfy the range 1.5<N6<1.6. Additionally, the sixth lens (106) may satisfy the range 1.52<N6<1.58. N6 is the refractive index of the sixth lens (106). The sixth lens (106) may satisfy the range 50<V6<60. Additionally, the sixth lens (106) may satisfy the range 52<V6<58. V6 is the Abbe number of the sixth lens (106).

The lens unit may include a seventh lens (107). The seventh lens (107) may be the seventh lens disposed from the object side. The seventh lens (107) may be the fourth lens disposed from the image side. The seventh lens (107) may be disposed between the sixth lens (106) and the eighth lens (108). The seventh lens (107) may be disposed between the sixth lens (106) and the image side. An additional lens may be disposed between the seventh lens (107) and the sixth lens (106) or between the seventh lens (107) and the eighth lens (108).

The seventh lens (107) may have a positive (+) refractive power. The seventh lens (107) may have a convex meniscus shape on the image side. The seventh lens (107) may have an object side surface (S13) formed concavely. The seventh lens (107) may have the object side surface (S13) formed concavely relative to the optical axis. The seventh lens (107) may have an upper side surface (S14) formed convexly. The seventh lens (107) may have an upper side surface (S14) that is convex relative to the optical axis. The object side surface or upper side surface of the seventh lens (107) may include at least one inflection point.

The curvature radius of the object side surface (S13) of the seventh lens (107) may be negative. The curvature radius of the object side surface (S13) of the seventh lens (107) relative to the optical axis may be negative. The curvature radius of the upper side surface (S14) of the seventh lens (107) may be negative. The curvature radius of the upper side surface (S14) of the seventh lens (107) along the optical axis may be negative. The absolute value of the curvature radius of the object side surface of the seventh lens (107) may be greater than the absolute value of the curvature radius of the upper side surface of the seventh lens (107). The seventh lens (107) may be a solid lens. Both surfaces of the seventh lens (107) may be formed as aspherical surfaces. One of the two surfaces of the seventh lens (107) may be formed as a spherical surface, and the other surface may be formed as an aspherical surface. The seventh lens (107) may have a surface including one or more inflection points.

The seventh lens (107) may satisfy the range of 1.5<N7<1.6. Additionally, the seventh lens (107) may satisfy the range of 1.52<N7<1.58. N7 is the refractive index of the seventh lens (107). The seventh lens (107) may satisfy the range of 50<V7<60. Additionally, the seventh lens (107) may satisfy the range of 52<V7<58. V6 is the Abbe number of the seventh lens (107).

The lens unit may include the eighth lens (108). The eighth lens (108) may be the eighth lens disposed from the object side. The eighth lens (108) may be the third lens disposed from the image side. The eighth lens (108) may be disposed between the seventh lens (107) and the ninth lens (109). The eighth lens (108) may be disposed between the seventh lens (107) and the image side. An additional lens may be disposed between the eighth lens (108) and the seventh lens (107) or between the eighth lens (108) and the ninth lens (109).

The eighth lens (108) may have a negative (−) refractive power. The eighth lens (108) may have a concave shape on both sides. The eighth lens (108) may have the object side surface (S15) formed concavely. The eighth lens (108) may have the object side surface (S15) convexly formed relative to the optical axis. The eighth lens (108) may have the upper side surface (S16) concavely formed. The eighth lens (108) may have the upper side surface (S16) concavely formed relative to the optical axis. The object side surface or upper side surface of the eighth lens (108) may include at least one inflection point.

The curvature radius of the object side (S15) of the eighth lens (108) may be negative.

The curvature radius of the object side surface (S16) of the eighth lens (108) on the optical axis may be negative. The curvature radius of the upper side surface (S16) of the eighth lens (108) may be positive. The curvature radius of the upper side surface (S16) of the eighth lens (108) on the optical axis may be positive. The value of the curvature radius of the object side surface of the eighth lens (108) may be greater than the value of the curvature radius of the upper side surface of the eighth lens (108). The eighth lens (108) may be a solid lens. Both sides of the eighth lens (108) may be formed as aspherical surfaces. One of the two surfaces of the eighth lens (108) may be formed as a spherical surface, and the other surface may be formed as an aspherical surface. The eighth lens (108) may have a surface including one or more inflection points.

The eighth lens (108) may satisfy the range 1.6<N8<1.7. Additionally, the eighth lens (108) may satisfy the range 1.65<N8<1.7. N8 is the refractive index of the eighth lens (108). The eighth lens (108) may satisfy the range 10<V8<25. Additionally, the eighth lens (108) may satisfy the range 15<V8<20. V8 is the Abbe number of the eighth lens (108).

The lens unit may include the ninth lens (109). The ninth lens (109) may be the ninth lens disposed from the object side. The ninth lens (109) may be the second lens disposed from the image side. The ninth lens (109) may be disposed between the eighth lens (108) and the tenth lens (110). The ninth lens (109) may be disposed between the eighth lens (108) and the image side. An additional lens may be disposed between the ninth lens (109) and the eighth lens (108) or between the ninth lens (109) and the tenth lens (110).

The ninth lens (109) may have a positive (+) refractive power. The ninth lens (109) may have a convex meniscus shape on the object side. The ninth lens (109) may have the object side surface (S17) formed convexly. The ninth lens (109) may have the object side surface (S17) formed convexly relative to the optical axis. The ninth lens (109) may have an upper side surface (S18) formed concavely. The ninth lens (109) may have an upper side surface (S18) formed concavely relative to the optical axis. The object side surface or upper side surface of the ninth lens (109) may include at least one inflection point.

The curvature radius of the object side surface (S17) of the ninth lens (109) may be positive. The curvature radius of the object side surface (S17) of the ninth lens (109) relative to the optical axis may be positive. The curvature radius of the upper side surface (S18) of the ninth lens (109) may be positive. The curvature radius of the upper side surface (S18) of the ninth lens (109) along the optical axis may be positive. The value of the curvature radius of the object side surface of the ninth lens (109) may be smaller than the value of the curvature radius of the upper side surface of the ninth lens (109). The ninth lens (109) may be a solid lens. Both surfaces of the ninth lens (109) may be formed as aspherical surfaces. One of the two surfaces of the ninth lens (109) may be formed as a spherical surface, and the other surface may be formed as an aspherical surface. The ninth lens (109) may have a surface including one or more inflection points.

The ninth lens (109) may satisfy the range of 1.6<N9<1.7. Additionally, the ninth lens (109) may satisfy the range of 1.65<N9<1.7. N9 is the refractive index of the ninth lens (109). The ninth lens (109) may satisfy the range of 20<V9<30. Additionally, the ninth lens (109) may satisfy the range of 22<V9<28. V9 is the Abbe number of the ninth lens (109).

The lens unit may include a tenth lens (110). The tenth lens (110) may be the lens most adjacent to the image side. The tenth lens (110) may be disposed between the ninth lens (109) and the image side. An additional lens may be disposed between the tenth lens (110) and the ninth lens (109) or between the tenth lens (110) and the filter (900).

The tenth lens (110) may have a negative (−) refractive power. The tenth lens (110) may have a convex meniscus shape on the object side. The tenth lens (110) may have the object side surface (S19) formed convexly. The tenth lens (110) may have the object side surface (S19) formed convexly relative to the optical axis. The tenth lens (110) may have an upper side surface (S20) formed concavely. The tenth lens (110) may have the upper side surface (S20) formed concavely relative to the optical axis. The object side surface or upper side surface of the tenth lens (110) may include at least one inflection point.

The curvature radius of the object side surface (S19) of the tenth lens (110) may be positive. The curvature radius of the object side surface (S19) of the tenth lens (110) relative to the optical axis may be positive. The curvature radius of the upper side surface (S20) of the tenth lens (110) may be positive.

The curvature radius of the upper side surface (S20) of the tenth lens (110) on the optical axis may be positive. The value of the curvature radius of the object side surface of the tenth lens (110) may be greater than the value of the curvature radius of the upper side surface of the tenth lens (110). The tenth lens (110) may be a solid lens. Both surfaces of the 10th lens (110) may be formed as aspherical surfaces. One of the two surfaces of the 10th lens (110) may be formed as a spherical surface, and the other surface may be formed as an aspherical surface. The 10th lens (110) may have a surface including one or more inflection points.

The tenth lens (110) may satisfy the range 1.5<N10<1.6. Additionally, the tenth lens (110) may satisfy the range 1.52<N10<1.55. N10 is the refractive index of the tenth lens (110). The tenth lens (110) may satisfy the range of 50<V10<60. Additionally, the tenth lens (110) may satisfy the range of 52<V10<58. V10 is the Abbe number of the tenth lens (110).

The lens unit may include an aperture (STOP). The aperture can control the amount of light entering the optical system. In lenses placed between the object and the aperture, the effective diameter of the lens surface tends to increase as the distance from the object to the aperture increases. For the lens surfaces disposed between the aperture and the sensor, there is a tendency for the effective diameter of the lens surfaces to decrease as they move from the aperture toward the sensor side. The fact that there is a tendency for the effective diameter of the lens surfaces to increase or decrease does not mean that the effective diameter of the lens surfaces only increases or decreases. For example, it also includes cases where the effective diameter of the lens surfaces increases and then decreases as they move from the aperture toward the sensor side.

The aperture (STOP) may be disposed between the first lens (101) and the second lens (102). The aperture (STOP) may be disposed closer to the second lens (102) than to the first lens (101). The aperture (STOP) may be spaced apart from the object side surface of the first lens (101).

The aperture (STOP) can regulate the amount of light entering from the subject. The aperture (STOP) can regulate the amount of light passing through the first lens (101). The aperture (STOP) can regulate the amount of light entering the second lens (102). The aperture (STOP) may include a diameter aperture.

The optical system or camera module may include a filter (900). The filter (900) may be disposed between the lens closest to the sensor side among the lenses of the lens unit (100) and the image sensor (800). For example, the filter (900) may be disposed between the nth lens and the image sensor (800).

A cover glass may be disposed between the filter (900) and the image sensor (800), protecting the upper portion of the image sensor (800) and preventing a decrease in the reliability of the image sensor (800). The cover glass may be removable. The cover glass may serve as a protective glass.

The filter (900) may include an infrared filter or an infrared cut-off filter (IR cut-off). The filter (900) can transmit light within a set wavelength band and filter out light from other wavelength bands. When the filter (900) includes an infrared filter, it can block radiant heat emitted from external light from being transmitted to the image sensor (800). Additionally, the filter (900) can transmit visible light and reflect infrared light.

The following describes the concept of the diagonal field of view (DFOV) of the imaging lens according to the present embodiment.

The imaging lens may have a field of view (FOV) of 70° or more. In this case, the field of view (FOV) may be the diagonal field of view (DFOV). The diagonal field of view (DFOV) may be distinguished from the horizontal field of view (HFOV) and the vertical field of view (VFOV). For example, the horizontal field of view (HFOV) may be 0.8 times the diagonal field of view (DFOV). Additionally, the field of view (FOV) may be distinguished from the horizontal field of view (HFOV). The field of view (FOV) refers to the diameter of an imaginary circle connecting the four corners of an image sensor, while the horizontal field of view (HFOV) may refer to the radius of the aforementioned imaginary circle. In other words, the field of view (FOV) may be twice the horizontal field of view (HFOV).

The diagonal field of view (DFOV) may be calculated using the following mathematical equation.

$$DFOV = 2 * arctan ( ImgH / F ) \qquad [ Mathematical Equation ]$$

Here, ImgH*2 refers to the diagonal length of the effective area of imaging surface of the image sensor (800), and F refers to the effective focal length of the entire optical system.

TABLE 1

| | | | | | | Semi | Focal |
|---|---|---|---|---|---|---|---|
| Lens | Surface | Radius | Thickness | nd | vd | Aperture | length |
| 1 | S1 | 2.62 | 0.31 | 1.55 | 56.11 | 1.422 | −408.76 |
| | S2 | 2.48 | 0.10 | | | 1.314 | |
| 2 | S3(Stop) | 2.29 | 0.47 | 1.55 | 56.11 | 1.046 | 3.89 |
| | S4 | −27.59 | 0.10 | | | 1.067 | |
| 3 | S5 | 1352.68 | 0.19 | 1.55 | 56.11 | 1.100 | 421.5 |
| | S6 | −277.62 | 0.10 | | | 1.130 | |
| 4 | S7 | 4.54 | 0.25 | 1.68 | 19.24 | 1.183 | −10.52 |
| | S8 | 2.71 | 0.25 | | | 1.215 | |
| 5 | S9 | 159.02 | 0.20 | 1.55 | 56.11 | 1.217 | 130.66 |
| | S10 | −129.55 | 0.10 | | | 1.288 | |
| 6 | S11 | −24.57 | 0.20 | 1.55 | 56.11 | 1.326 | 240.55 |
| | S12 | −20.76 | 0.20 | | | 1.397 | |
| 7 | S13 | −20.14 | 0.29 | 1.55 | 56.11 | 1.455 | 25.7 |
| | S14 | −8.32 | 0.33 | | | 1.595 | |
| 8 | S15 | −5.78 | 0.31 | 1.68 | 19.24 | 1.734 | −5.3 |
| | S16 | 9.77 | 0.11 | | | 1.897 | |
| 9 | S17 | 2.09 | 0.62 | 1.62 | 25.59 | 1.930 | 4.77 |
| | S18 | 6.36 | 0.53 | | | 2.610 | |
| 10 | S19 | 3.17 | 0.60 | 1.54 | 55.66 | 3.304 | −8.66 |
| | S20 | 1.76 | 0.30 | | | 3.697 | |
| Filter | S21 | Infinity | 0.11 | 1.52 | 64.2 | 3.900 | |
| | S22 | Infinity | 0.38 | | | 3.928 | |
| | Image | Infinity | 0.01 | | | 4.111 | |

Table 1 shows the surface number (Surface), curvature radius (Radius), center thickness of each lens or distance between lens surfaces (Thickness), refractive index (Index, nd), Abbe number (Abbe, vd), effective radius (Semi Aperture), and focal length (Focal length) of the lens according to the first embodiment of the present invention. Here, the units for curvature radius and thickness or distance may be mm.

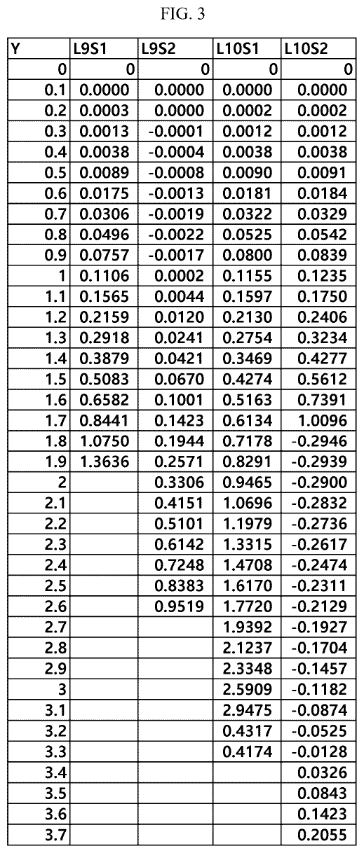

FIG. 3 is a table showing the Sag values of the object side surface and sensor side surface of the ninth lens and tenth lens according to the first embodiment of the present invention.

The object side 17th surface (S17) and sensor side 18th surface (S18) of the ninth lens (109) may have at least one critical point extending from the optical axis (OA) to the end of the effective area. The sensor side 18th surface (S18) of the 9th lens (109) may have a critical point at a point where the Y value is 0.8 mm to 1.0 mm from the optical axis (OA). If the sensor side 18th surface (S18) of the 9th lens (109) has a critical point, the critical point may be located within a range of 30% to 40% of the effective radius from the optical axis (OA).

The object side 19th surface (S19) and the sensor side 20th surface (S20) of the 10th lens (110) may have at least one critical point extending from the optical axis (OA) to the end of the effective area. The object-side 19th surface (S19) of the 10th lens (110) may have a critical point at a point where the Y value is 3.1 mm to 3.2 mm along the optical axis (OA). Here, Y denotes the distance in the direction perpendicular to the optical axis (OA). When the object-side 19th surface (S19) of the 10th lens (110) has a critical point, the critical point may be located within a range that is 90% or more and 95% or less of the effective radius from the optical axis (OA). The sensor-side 20th surface (S20) of the 10th lens (110) may have a critical point at a point where the Y value is between 1.7 mm and 1.8 mm from the optical axis (OA). If the sensor side 20th surface (S20) of the 10th lens (110) has a critical point, the critical point may be located within a range where the distance from the optical axis (OA) is 40% or more but 50% or less of the effective radius.

TABLE 2

| | First |
|---|---|
| | embodiment |
| TTL | 6.05 |
| F | 4.71 |
| Fno | 2.2 |
| ImgH * 2 | 8.2 |
| FOV | 73.7 |

Table 2 shows the characteristics of the imaging lens according to the first embodiment of the present invention.

TTL denotes the optical axis distance from the object-side surface vertex of the first lens (101) to the image surface, F denotes the total focal length, Fno denotes the ratio of the focal length to the effective diameter of the lens, ImgH denotes the distance from the optical axis (OA) to the diagonal end of the image sensor (800) or half of the maximum diagonal length, FOV denotes the field of view in the diagonal direction of the optical system. Here, the units of TTL, F, and ImgH may be mm, and the unit of FOV may be degrees.

The following describes the configuration of the optical system according to the second embodiment of the present invention with reference to the drawings.

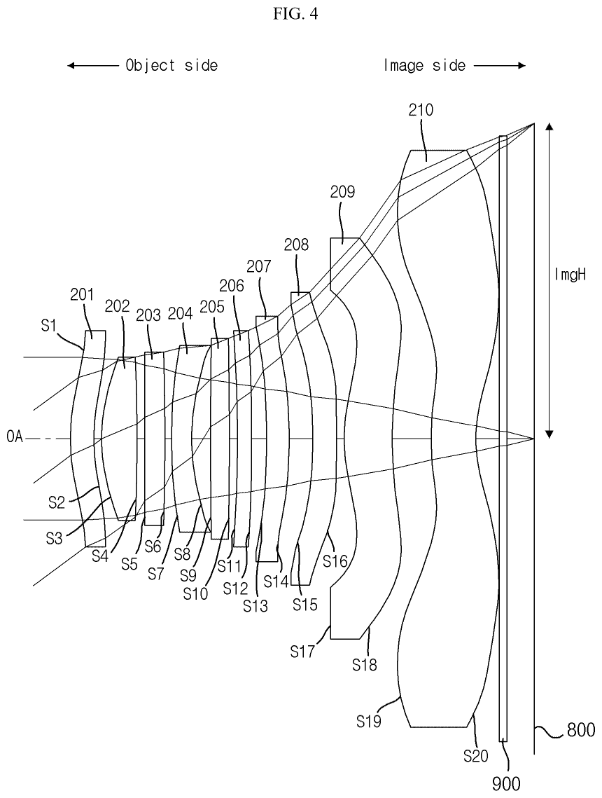

FIG. 4 is a side cross-sectional view of the optical system and a camera module having the same according to the second embodiment.

The optical system according to the second embodiment may include a lens unit, which may include a first lens (201) to a tenth lens (210). The first to tenth lenses (201, 202, 203, 204, 205, 206, 207, 208, 209, 210) may be disposed sequentially along the optical axis (OA). Light corresponding to the information of the object may pass through the first lens (201) to the tenth lens (210) and the filter (900) and enter the image sensor (800).

The lens unit may be disposed, in order from the object side to the image side, as the first lens (201), the aperture (STOP), the second lens (202), the third lens (203), the fourth lens (204), the fifth lens (205), the sixth lens (206), the seventh lens (207), an eighth lens (208), a ninth lens (209), and a tenth lens (210). The imaging lens according to the second embodiment may be composed of eight or fewer lenses. Alternatively, the imaging lens according to the second embodiment may be composed of nine or more lenses.

In other embodiments, one or more additional lenses, plates, or optical elements may be added between the first lens (201) and the tenth lens (210). Additionally, one or more additional lenses, plates, or optical members may be added in front of the first lens (201) or behind the tenth lens (210). Furthermore, one or more additional lenses, plates, or optical members may be added between the aperture (STOP) and the lens, between the lens and the filter (900), and between the filter (900) and the image sensor (800). In this case, the filter (900) may be a plate lens. The refractive power of the plate lens may be ‘0’. The refractive power of the flat lens may be zero.

Additionally, a filter layer may be disposed between the aperture (STOP) and the lens, between the lens and the filter (900), and between the filter (900) and the image sensor (800). In this case, the filter layer may be coated to function as a filter.

The lens unit may include a first lens (201). The first lens (201) may be closest to the object side. The first lens (201) may be the first lens disposed on the object side. The first lens (201) may be the first lens adjacent to the object side.

An additional lens may be disposed between the first lens (201) and the second lens (202). The second to eighth lenses (202, 203, 204, 205, 206, 207, 208) may be disposed between the first lens (201) and the tenth lens (210). Between the first lens (201) and the tenth lens (210), other lenses besides the second to ninth lenses (202, 203, 204, 205, 206, 207, 208, 209) may be additionally disposed. At least two lenses may be additionally disposed between at least two of the first to tenth lenses (201, 202, 203, 204, 205, 206, 207, 208, 209, 210).

The first lens (201) may have a negative (−) refractive power. The first lens (201) may have a convex meniscus shape on the object side. The first lens (201) may have the object side surface (S1) formed convexly. The first lens (201) may have the object side surface (S1) formed convexly relative to the optical axis. The first lens (201) may have a concave upper side surface (S2). The first lens (201) may have a concave upper side surface (S2) relative to the optical axis. The object side surface or upper side surface of the first lens (201) may include at least one inflection point.

The curvature radius of the object side surface (S1) of the first lens (201) may be positive. The curvature radius of the object side surface (S1) of the first lens (201) at the optical axis may be positive. The curvature radius of the upper side surface (S2) of the first lens (201) may be positive. The curvature radius of the upper side surface (S2) of the first lens (201) along the optical axis may be positive. The absolute value of the curvature radius of the object side surface (S1) of the first lens (201) may be greater than the absolute value of the curvature radius of the upper side surface (S2) of the first lens (201). The first lens (201) may be a solid lens. Both surfaces of the first lens (201) may be formed as aspherical surfaces. One of the two surfaces of the first lens (201) may be formed as a spherical surface, and the other surface may be formed as an aspherical surface.

The first lens (201) may satisfy the range of 1.5<N1<1.6. Additionally, the first lens (201) may satisfy the range of 1.52<N1<1.58. N1 is the refractive index of the first lens (201). The first lens (201) may satisfy the range of 50<V1<60. Additionally, the first lens (201) may satisfy the range of 52<V1<58. V1 is the Abbe number of the first lens (201).

The lens unit may include a second lens (202). The second lens (202) may be the second lens disposed from the object side. The second lens (202) may be the second lens adjacent to the first lens (201) from the object side. The second lens (202) may be disposed between the first lens (201) and the image side. The second lens (202) may be disposed between the first lens (201) and the third lens (203). An additional lens may be disposed between the second lens (202) and the first lens (201) or between the second lens (202) and the third lens (203).

The second lens (202) may have a positive (+) refractive power. The second lens (202) may be formed with both surfaces convex. The second lens (202) may have the object side surface (S3) formed convex. The second lens (202) may have the object side surface (S3) formed convex relative to the optical axis. The second lens (202) may have an upper surface (S4) formed concavely. The second lens (202) may have the upper side surface (S4) formed concavely relative to the optical axis. The object side surface (S3) or upper side surface (S4) of the second lens (202) may include at least one inflection point.

The curvature radius of the object side surface (S3) of the second lens (202) may be positive. The curvature radius of the object side surface (S3) of the second lens (202) on the optical axis may be positive. The curvature radius of the upper side surface (S4) of the second lens (202) may be negative. The curvature radius of the second lens (202) on the optical axis of the upper side surface (S4) may be negative. The absolute value of the curvature radius of the object side surface (S3) of the second lens (202) may be smaller than the absolute value of the curvature radius of the upper side surface (S4) of the second lens (202). The second lens (202) may be a solid lens. Both surfaces of the second lens (202) may be formed as aspherical surfaces. One of the two surfaces of the second lens (202) may be formed as a spherical surface, and the other surface may be formed as an aspherical surface.

The second lens (202) may satisfy the range 1.5<N2<1.6. Additionally, the second lens (202) may satisfy the range 1.52<N2<1.58. N2 is the refractive index of the second lens (202). The second lens (202) may satisfy the range 50<V2<60. Additionally, the second lens (202) may satisfy the range 55<V2<58. V2 is the Abbe number of the second lens (202).

The lens unit may include a third lens (203). The third lens (203) may be the third lens dispose from the object side. The third lens (203) may be the third lens adjacent to the object side. The third lens (203) may be disposed between the second lens (202) and the upper side. The third lens (203) may be disposed between the second lens (202) and the fourth lens (204). An additional lens may be disposed between the third lens (203) and the second lens (202) or between the third lens (203) and the fourth lens (204).

The third lens (203) may have a positive (+) refractive power. The third lens (203) may be formed with both surfaces convex. The third lens (203) may be formed with the object side surface (S5) convex. The third lens (203) may be formed with the object side surface (S5) convex relative to the optical axis. The third lens (203) may have an upper side surface (S6) formed convexly. The third lens (203) may have the upper side surface (S6) formed convexly relative to the optical axis. The object side surface or upper side surface of the third lens (203) may include at least one inflection point.

The curvature radius of the object side surface (S5) of the third lens (203) may be positive. The curvature radius of the object side surface (S5) of the third lens (203) relative to the optical axis may be positive. The curvature radius of the upper side surface (S6) of the third lens (203) may be negative. The curvature radius of the upper side surface (S6) of the third lens (203) along the optical axis may be negative. The absolute value of the curvature radius of the object side surface of the third lens (203) may be greater than the absolute value of the curvature radius of the upper side surface of the third lens (203). The third lens (203) may be a solid lens. Both surfaces of the third lens (203) may be formed as aspherical surfaces. One of the two surfaces of the third lens (203) may be formed as a spherical surface, and the other surface may be formed as an aspherical surface.

The third lens (203) may satisfy the range of 1.5<N3<1.6. Additionally, the third lens (203) may satisfy the range of 1.52<N3<1.58. N3 is the refractive index of the third lens (203). The third lens (203) may satisfy the range of 50<V3<60. Additionally, the third lens (203) may satisfy the range of 52<V3<58. V3 is the Abbe number of the third lens (203).

The lens unit may include a fourth lens (204). The fourth lens (204) may be the fourth lens disposed from the object side. The fourth lens (204) may be the seventh lens disposed from the image side. The fourth lens (204) may be disposed between the third lens (203) and the image side. The fourth lens (204) may be disposed between the third lens (203) and the fifth lens (205). An additional lens may be disposed between the fourth lens (204) and the third lens (203) or between the fourth lens (204) and the fifth lens (205).

The fourth lens (204) may have a negative (−) refractive power. The fourth lens (204) may have a convex meniscus shape on the object side. The fourth lens (204) may have a convex object side (S7). The fourth lens (204) may have a convex object side (S7) relative to the optical axis. The fourth lens (204) may have a concave upper side surface (S8). The fourth lens (204) may have the upper side surface (S8) concave relative to the optical axis. The object side surface or upper side surface of the fourth lens (204) may include at least one inflection point.

The curvature radius of the object side surface (S7) of the fourth lens (204) may be positive. The curvature radius of the object side surface (S7) of the fourth lens (204) on the optical axis may be positive. The curvature radius of the upper side surface (S8) of the fourth lens (204) may be positive. The curvature radius of the fourth lens (204) on the optical axis of the upper side surface (S8) may be positive. The absolute value of the curvature radius of the object side surface (S7) of the fourth lens (204) may be greater than the absolute value of the curvature radius of the upper side surface (S8) of the fourth lens (204). The fourth lens (204) may be a solid lens. Both surfaces of the fourth lens (204) may be formed as aspherical surfaces. One of the two surfaces of the fourth lens (204) may be formed as a spherical surface, and the other surface may be formed as an aspherical surface.

The fourth lens (204) may satisfy the range 1.6<N4<1.7. Additionally, the fourth lens (204) may satisfy the range 1.65<N4<1.7. N4 is the refractive index of the fourth lens (204). The fourth lens (204) may satisfy the range 15<V4<30. Additionally, the fourth lens (204) may satisfy the range 17<V4<20. V4 is the Abbe number of the fourth lens (204).

The lens unit may include a fifth lens (205). The fifth lens (205) may be the fifth lens disposed from the object side. The fifth lens (205) may be the sixth lens disposed from the image side. The fifth lens (205) may be dispose between the fourth lens (204) and the image side. The fifth lens (205) may be disposed between the fourth lens (204) and the sixth lens (206). An additional lens may be disposed between the fifth lens (205) and the fourth lens (204) or between the fifth lens (205) and the sixth lens (206).

The fifth lens (205) may have a positive (+) refractive power. The fifth lens (205) may have a convex shape on both sides. The fifth lens (205) may have an object side surface (S9) formed convexly. The fifth lens (205) may have an object side surface (S9) formed convexly relative to the optical axis. The fifth lens (205) may have an upper side surface (S10) formed convexly. The fifth lens (205) may have the upper side surface (S10) formed convexly relative to the optical axis. The object side surface or upper side surface of the fifth lens (205) may include at least one inflection point.

The curvature radius of the object side surface (S9) of the fifth lens (205) may be positive.

The curvature radius of the object side surface (S9) of the fifth lens (205) relative to the optical axis may be positive. The curvature radius of the upper side surface (S10) of the fifth lens (205) may be negative. The curvature radius of the upper side surface (S10) of the fifth lens (205) along the optical axis may be negative. The absolute value of the curvature radius of the object side surface (S9) of the fifth lens (205) may be greater than the absolute value of the curvature radius of the upper side surface (S10) of the fifth lens (205). The fifth lens (205) may be a solid lens. Both surfaces of the fifth lens (205) may be formed as aspherical surfaces. One of the two surfaces of the fifth lens (205) may be formed as a spherical surface, and the other surface may be formed as an aspherical surface.

The fifth lens (205) may satisfy the range of 1.5<N5<1.6. Additionally, the fifth lens (205) may satisfy the range of 1.52<N5<1.58. N5 is the refractive index of the fifth lens (205). The fifth lens (205) may satisfy the range of 50<V5<60. Additionally, the fifth lens (205) may satisfy the range of 52<V5<58. V5 is the Abbe number of the fifth lens (205).

The lens unit may include a sixth lens (206). The sixth lens (206) may be the sixth lens disposed from the object side. The sixth lens (206) may be the fifth lens disposed from the image side. The sixth lens (206) may be disposed between the fifth lens (205) and the seventh lens (207). The sixth lens (206) may be disposed between the fifth lens (205) and the image side. An additional lens may be disposed between the sixth lens (206) and the fifth lens (205) or between the sixth lens (206) and the seventh lens (207).

The sixth lens (206) may have a negative (−) refractive power. The sixth lens (206) may have a convex meniscus shape on the image side. The sixth lens (206) may have the object side surface (S11) formed concavely. The sixth lens (206) may have the object side surface (S11) concave relative to the optical axis. The sixth lens (206) may have the upper side surface (S12) convex. The sixth lens (206) may have the upper side surface (S12) convex relative to the optical axis. The object side surface or upper side surface of the sixth lens (206) may include at least one inflection point.

The curvature radius of the object side surface (S11) of the sixth lens (206) may be negative. The curvature radius of the object side surface (S11) of the sixth lens (206) on the optical axis may be negative. The curvature radius of the upper side surface (S12) of the sixth lens (206) may be negative. The curvature radius of the upper side surface (S12) of the sixth lens (206) along the optical axis may be negative. The absolute value of the curvature radius of the object side surface of the sixth lens (206) may be smaller than the absolute value of the curvature radius of the upper side surface of the sixth lens (206). The sixth lens (206) may be a solid lens. Both surfaces of the sixth lens (206) may be formed as aspherical surfaces. One of the two surfaces of the sixth lens (206) may be formed as a spherical surface, and the other surface may be formed as an aspherical surface. The sixth lens (206) may have a surface including one or more inflection points.

The sixth lens (206) may satisfy the range 1.5<N6<1.6. Additionally, the sixth lens (206) may satisfy the range 1.52<N6<1.58. N6 is the refractive index of the sixth lens (206). The sixth lens (206) may satisfy the range 50<V6<60. Additionally, the sixth lens (206) may satisfy the range 52<V6<58. V6 is the Abbe number of the sixth lens (206).

The lens unit may include a seventh lens (207). The seventh lens (207) may be the seventh lens disposed from the object side. The seventh lens (207) may be the fourth lens disposed from the image side. The seventh lens (207) may be disposed between the sixth lens (206) and the eighth lens (208). The seventh lens (207) may be disposed between the sixth lens (206) and the image side. An additional lens may be disposed between the seventh lens (207) and the sixth lens (206) or between the seventh lens (207) and the eighth lens (208).

The seventh lens (207) may have a positive (+) refractive power. The seventh lens (207) may have a convex meniscus shape on the image side. The seventh lens (207) may have an object side surface (S13) formed concavely. The seventh lens (207) may have the object side surface (S13) formed concavely relative to the optical axis. The seventh lens (207) may have an upper side surface (S14) formed convexly. The seventh lens (207) may have its upper side surface (S14) convexly formed relative to the optical axis. The object side surface or upper side surface of the seventh lens (207) may include at least one inflection point.

The curvature radius of the object side surface (S13) of the seventh lens (207) may be negative. The curvature radius of the object side surface (S13) of the seventh lens (207) on the optical axis may be negative. The curvature radius of the upper side surface (S14) of the seventh lens (207) may be negative. The curvature radius of the upper side surface (S14) of the 7th lens (207) along the optical axis may be negative. The absolute value of the curvature radius of the object side surface of the 7th lens (207) may be greater than the absolute value of the curvature radius of the upper side surface of the 7th lens (207). The 7th lens (207) may be a solid lens. Both surfaces of the seventh lens (207) may be formed as aspherical surfaces. One of the two surfaces of the seventh lens (207) may be formed as a spherical surface, and the other surface may be formed as an aspherical surface. The seventh lens (207) may have a surface including one or more inflection points.

The seventh lens (207) may satisfy the range 1.5<N7<1.6. Additionally, the seventh lens (207) may satisfy the range 1.52<N7<1.58. N7 is the refractive index of the seventh lens (207). The seventh lens (207) may satisfy the range 50<V7<60. Additionally, the seventh lens (207) may satisfy the range 52<V7<58. V6 is the Abbe number of the seventh lens (207).

The lens unit may include an eighth lens (208). The eighth lens (208) may be the eighth lens disposed from the object side. The eighth lens (208) may be the third lens disposed from the image side. The eighth lens (208) may be disposed between the seventh lens (207) and the ninth lens (209). The eighth lens (208) may be disposed between the seventh lens (207) and the image side. An additional lens may be disposed between the eighth lens (208) and the seventh lens (207) or between the eighth lens (208) and the ninth lens (209).

The eighth lens (208) may have a negative (−) refractive power. The eighth lens (208) may have a concave shape on both sides. The eighth lens (208) may have an object side surface (S15) formed concavely. The eighth lens (208) may have the object side surface (S15) formed convexly relative to the optical axis. The eighth lens (208) may have an upper side surface (S16) formed concavely. The eighth lens (208) may have the upper side surface (S16) concave relative to the optical axis. The object side surface or upper side surface of the eighth lens (208) may include at least one inflection point.

The curvature radius of the object side surface (S15) of the eighth lens (208) may be negative. The curvature radius of the object side surface (S16) of the eighth lens (208) relative to the optical axis may be negative. The curvature radius of the upper side surface (S16) of the eighth lens (208) may be positive. The curvature radius of the upper sider surface (S16) of the eighth lens (208) along the optical axis may be positive. The value of the curvature radius of the object side surface of the eighth lens (208) may be greater than the value of the curvature radius of the upper side surface of the eighth lens (208). The eighth lens (208) may be a solid lens. Both surfaces of the eighth lens (208) may be formed as aspherical surfaces. One of the two surfaces of the eighth lens (208) may be formed as a spherical surface, and the other surface may be formed as an aspherical surface. The eighth lens (208) may have a surface including one or more inflection points.

The eighth lens (208) may satisfy the range of 1.6<N8<1.7. Additionally, the eighth lens (208) may satisfy the range of 1.65<N8<1.7. N8 is the refractive index of the eighth lens (208). The eighth lens (208) may satisfy the range of 10<V8<25. Additionally, the eighth lens (208) may satisfy the range of 15<V8<20. V8 is the Abbe number of the eighth lens (208).

The lens unit may include a ninth lens (209). The ninth lens (209) may be the ninth lens disposed from the object side. The ninth lens (209) may be the second lens disposed from the image side. The ninth lens (209) may be disposed between the eighth lens (208) and the tenth lens (210). The ninth lens (209) may be disposed between the eighth lens (208) and the image side. An additional lens may be disposed between the ninth lens (209) and the eighth lens (208) or between the ninth lens (209) and the tenth lens (210).

The ninth lens (209) may have a positive (+) refractive power. The ninth lens (209) may have a convex meniscus shape on the object side. The ninth lens (209) may have the object side surface (S17) formed convexly. The ninth lens (209) may have the object side surface (S17) convexly formed relative to the optical axis. The ninth lens (209) may have the upper side surface (S18) concavely formed. The ninth lens (209) may have the upper side surface (S18) concavely formed relative to the optical axis. The object side surface or upper side surface of the ninth lens (209) may include at least one inflection point.

The curvature radius of the object side surface (S17) of the ninth lens (209) may be positive. The curvature radius of the object side surfacer (S17) of the ninth lens (209) relative to the optical axis may be positive. The curvature radius of the upper side surface (S18) of the ninth lens (209) may be positive. The curvature radius of the upper side surface (S18) of the ninth lens (209) along the optical axis may be positive. The value of the curvature radius of the object side surface of the ninth lens (209) may be smaller than the value of the curvature radius of the upper side surface of the ninth lens (209). The ninth lens (209) may be a solid lens. Both surfaces of the ninth lens (209) may be formed as aspherical surfaces. One of the two surfaces of the ninth lens (209) may be formed as a spherical surface, and the other surface may be formed as an aspherical surface. The ninth lens (209) may have a surface including one or more inflection points.

The ninth lens (209) may satisfy the range of 1.6<N9<1.7. Additionally, the ninth lens (209) may satisfy the range of 1.65<N9<1.7. N9 is the refractive index of the ninth lens (209). The ninth lens (209) may satisfy the range of 20<V9<30. Additionally, the ninth lens (209) may satisfy the range of 22<V9<28. V9 is the Abbe number of the ninth lens (209).

The lens unit may include a tenth lens (210). The tenth lens (210) may be the lens most adjacent to the image side. The tenth lens (210) may be disposed between the ninth lens (209) and the image side. An additional lens may be disposed between the tenth lens (210) and the ninth lens (209) or between the tenth lens (210) and the filter (900).

The tenth lens (210) may have a negative (−) refractive power. The tenth lens (210) may have a convex meniscus shape on the object side. The tenth lens (210) may have the object side surface (S19) formed convexly. The tenth lens (210) may have the object side surface (S19) formed convexly relative to the optical axis. The tenth lens (210) may have an upper side surface (S20) formed concavely. The tenth lens (210) may have an upper side surface (S20) formed concavely relative to the optical axis. The object side surface or upper side surface of the tenth lens (210) may include at least one inflection point.

The curvature radius of the object side surface (S19) of the tenth lens (210) may be positive. The curvature radius of the object side surface (S19) of the tenth lens (210) relative to the optical axis may be positive. The curvature radius of the upper side surface (S20) of the tenth lens (210) may be positive. The curvature radius of the upper side surface (S20) of the tenth lens (210) along the optical axis may be positive. The value of the curvature radius of the object side surface of the tenth lens (210) may be greater than the value of the curvature radius of the upper side surface of the tenth lens (210). The tenth lens (210) may be a solid lens. Both surfaces of the 10th lens (210) may be formed as aspherical surfaces. One of the two surfaces of the 10th lens (210) may be formed as a spherical surface, and the other surface may be formed as an aspherical surface. The 10th lens (210) may have a surface including one or more inflection points.

The tenth lens (210) may satisfy the range of 1.5<N10<1.6. Additionally, the tenth lens (210) may satisfy the range of 1.52<N10<1.55. N10 is the refractive index of the tenth lens (210). The tenth lens (210) may satisfy the range of 50<V10<60. Additionally, the tenth lens (210) may satisfy the range of 52<V10<58. V10 is the Abbe number of the tenth lens (210).

The imaging lens may include an aperture (STOP). The aperture (STOP) may be disposed between the first lens (201) and the second lens (202). The aperture (STOP) may be disposed closer to the second lens (202) than to the first lens (201). The aperture (STOP) may be spaced apart from the object side surface of the first lens (201). The aperture (STOP) may regulate the amount of light incident from a subject. The aperture (STOP) may regulate the amount of light passing through the first lens (201). The aperture (STOP) can regulate the amount of light entering the second lens (202). The aperture (STOP) may include an aperture stop.

TABLE 3

| | | | | | | Semi | Focal |
|---|---|---|---|---|---|---|---|
| Lens | Surface | Radius | Thickness | nd | vd | Aperture | length |
| 1 | S1 | 2.63 | 0.31 | 1.55 | 56.11 | 1.407 | −283.68 |
| | S2 | 2.48 | 0.10 | | | 1.301 | |
| 2 | S3(Stop) | 2.27 | 0.46 | 1.55 | 56.11 | 1.036 | 3.89 |
| | S4 | −29.82 | 0.10 | | | 1.057 | |
| 3 | S5 | 268.51 | 0.25 | 1.55 | 56.11 | 1.090 | 112.50 |
| | S6 | −79.72 | 0.10 | | | 1.129 | |
| 4 | S7 | 4.72 | 0.26 | 1.68 | 19.24 | 1.181 | −9.91 |
| | S8 | 2.71 | 0.24 | | | 1.216 | |
| 5 | S9 | 105.25 | 0.25 | 1.55 | 56.11 | 1.217 | 82.87 |
| | S10 | −79.43 | 0.10 | | | 1.303 | |
| 6 | S11 | −21.06 | 0.19 | 1.55 | 56.11 | 1.336 | −1658.57 |
| | S12 | −21.63 | 0.20 | | | 1.409 | |
| 7 | S13 | −19.17 | 0.28 | 1.55 | 56.11 | 1.461 | 26.25 |
| | S14 | −8.25 | 0.32 | | | 1.604 | |
| 8 | S15 | −5.80 | 0.30 | 1.68 | 19.24 | 1.742 | −5.32 |
| | S16 | 9.79 | 0.11 | | | 1.905 | |
| 9 | S17 | 2.10 | 0.62 | 1.62 | 25.59 | 1.930 | 4.78 |
| | S18 | 6.34 | 0.51 | | | 2.608 | |
| 10 | S19 | 3.14 | 0.58 | 1.54 | 55.66 | 3.373 | −9.24 |
| | S20 | 1.80 | 0.30 | | | 3.765 | |
| Filter | S21 | Infinity | 0.11 | 1.52 | 64.2 | 3.927 | |
| | S22 | Infinity | 0.38 | | | 3.954 | |
| | Image | Infinity | 0.014 | | | 4.104 | |

Table 3 shows the surface number (Surface), curvature radius (Radius), center thickness of each lens or distance between lens surfaces (Thickness), refractive index (Index, nd), Abbe number (Abbe, vd), effective radius (Semi Aperture), and focal length (Focal length) of the lens according to the second embodiment of the present invention. Here, the units for the curvature radius and thickness or distance may be mm.

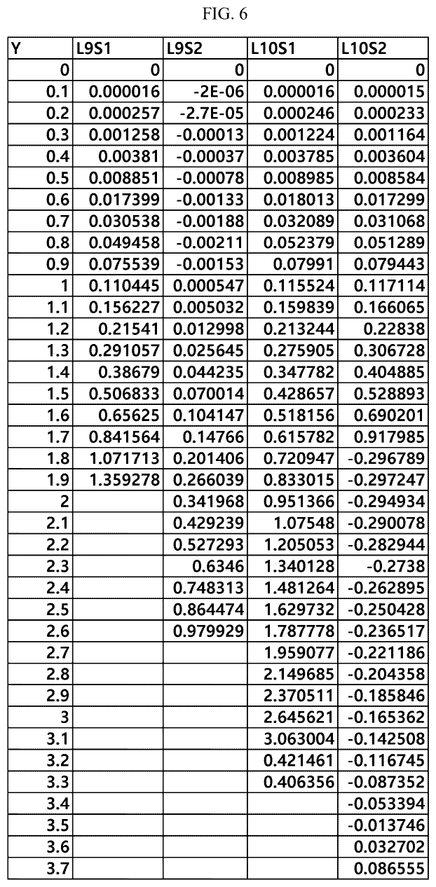

FIG. 6 is a table showing the Sag values of the object side surface and sensor side surface of the ninth lens and tenth lens according to the second embodiment of the present invention.

The object side 17th surface (S17) and sensor side 18th surface (S18) of the ninth lens (209) may have at least one critical point extending from the optical axis (OA) to the end of the effective area. The sensor side 18th surface (S18) of the ninth lens (209) may have a critical point at a point where the Y value is 0.8 mm to 1.0 mm from the optical axis (OA). If the sensor side 18th surface (S18) of the 9th lens (209) has a critical point, the critical point may be located within a range of 30% to 40% of the effective radius from the optical axis (OA).

The object-side 19th surface (S19) and sensor-side 20th surface (S20) of the 10th lens (210) may have at least one critical point extending to the end of the effective area along the optical axis (OA). The object-side 19th surface (S19) of the 10th lens (210) may have a critical point at a point where the Y value is 3.1 mm to 3.2 mm from the optical axis (OA). Here, Y denotes the distance from the optical axis (OA) in a direction perpendicular to the optical axis. When the object-side 19th surface (S19) of the 10th lens (210) has a critical point, the critical point may be located within a range that is 90% or more and 95% or less of the effective radius from the optical axis (OA). The sensor-side 20th surface (S20) of the 10th lens (210) may have a critical point at a point where the Y value is 1.7 mm to 1.8 mm from the optical axis (OA). If the sensor-side 20th surface (S20) of the 10th lens (210) has a critical point, the critical point may be located within a range where the distance from the optical axis (OA) is between 40% and 50% of the effective radius.

TABLE 4

| | Second |
|---|---|
| | embodiment |
| TTL | 6.06 |
| F | 4.67 |
| Fno | 2.2 |
| ImgH * 2 | 8.2 |
| FOV | 72.8 |

Table 4 shows the characteristics of the imaging lens according to the second embodiment of the present invention.

TTL denotes the optical axis distance from the object-side surface vertex of the first lens (201) to the image surface, F denotes the total focal length, Fno denotes the ratio of the focal length to the effective diameter of the lens, ImgH denotes the distance from the optical axis (OA) to the diagonal end of the image sensor (800) or half of the maximum diagonal length, FOV denotes the field of view in the diagonal direction of the optical system. Here, the units of TTL, F, and ImgH may be mm, and the unit of FOV may be degrees.

The configuration of the optical system according to the third embodiment of the present invention will now be described with reference to the drawings.

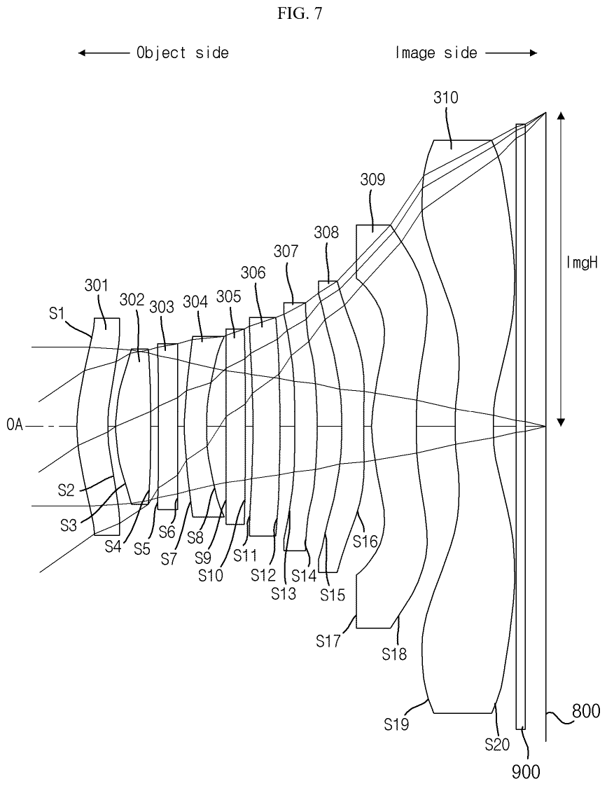

FIG. 7 is a side cross-sectional view of the optical system and a camera module having the same according to the third embodiment.

The optical system according to the third embodiment may include a lens unit, which may include a first lens (301) to a tenth lens (310). The first to tenth lenses (301, 302, 303, 304, 305, 306, 307, 308, 309, 310) may be disposed sequentially along the optical axis (OA). Light corresponding to the information of the object may pass through the first lens (301) to the tenth lens (310) and the filter (900) and enter the image sensor (800).

The lens unit may be disposed, in order from the object side to the image side, as the first lens (301), the aperture (STOP), the second lens (302), the third lens (303), the fourth lens (304), the fifth lens (305), the sixth lens (306), the seventh lens (307), an eighth lens (308), a ninth lens (309), and a tenth lens (310). The imaging lens according to the third embodiment may be composed of eight or fewer lenses. Alternatively, the imaging lens according to the third embodiment may be composed of nine or more lenses.

In other embodiments, one or more additional lenses, plates, or optical members may be added between the first lens (301) and the tenth lens (310). Additionally, one or more additional lenses, plates, or optical members may be added in front of the first lens (301) or behind the tenth lens (310). Furthermore, one or more additional lenses, plates, or optical members may be added between the aperture (STOP) and the lens, between the lens and the filter (900), and between the filter (900) and the image sensor (800). In this case, the filter (900) may be a plate lens. The refractive power of the plate lens may be ‘0’. The refractive power of the flat lens may be zero. Additionally, a filter layer may be disposed between the aperture (STOP) and the lens, between the lens and the filter (900), and between the filter (900) and the image sensor (800). In this case, the filter layer may be coated to function as a filter.

The lens unit may include a first lens (301). The first lens (301) may be closest to the object side. The first lens (301) may be the first lens disposed on the object side. The first lens (301) may be the first lens adjacent to the object side. An additional lens may be disposed between the first lens (301) and the second lens (302).

Between the first lens (301) and the tenth lens (310), the second to eighth lenses (302, 303, 304, 305, 306, 307, 308) may be disposed. Between the first lens (301) and the tenth lens (310), additional lenses other than the second to ninth lenses (302, 303, 304, 305, 306, 307, 308, 309) may be further arranged. At least two lenses may be additionally disposed between any two of the first to tenth lenses (301, 302, 303, 304, 305, 306, 307, 308, 309, 310).

The first lens (301) may have a negative (−) refractive power. The first lens (301) may have a convex meniscus shape on the object side. The first lens (301) may have the object side surface (S1) formed convexly. The first lens (301) may have the object side surface (S1) formed convexly relative to the optical axis. The first lens (301) may have a concave upper side surface (S2). The first lens (301) may have a concave upper side surface (S2) relative to the optical axis. The object side surface or upper side surface of the first lens (301) may include at least one inflection point.

The curvature radius of the object side surface (S1) of the first lens (301) may be positive. The curvature radius of the object side surface (S1) of the first lens (301) relative to the optical axis may be positive. The curvature radius of the upper side surface (S2) of the first lens (301) may be positive. The curvature radius of the upper side surface (S2) of the first lens (301) along the optical axis may be positive. The absolute value of the curvature radius of the object side surface (S1) of the first lens (301) may be greater than the absolute value of the curvature radius of the upper side surface (S2) of the first lens (301). The first lens (301) may be a solid lens. Both surfaces of the first lens (301) may be formed as aspherical surfaces. One of the two surfaces of the first lens (301) may be formed as a spherical surface, and the other surface may be formed as an aspherical surface.

The first lens (301) may satisfy the range of 1.5<N1<1.6. Additionally, the first lens (301) may satisfy the range of 1.52<N1<1.58. N1 is the refractive index of the first lens (301). The first lens (301) may satisfy the range of 50<V1<60. Additionally, the first lens (301) may satisfy the range of 52<V1<58. V1 is the Abbe number of the first lens (301).

The lens unit may include a second lens (302). The second lens (302) may be the second lens disposed from the object side. The second lens (302) may be the second lens adjacent to the first lens (301) from the object side. The second lens (302) may be disposed between the first lens (301) and the upper side. The second lens (302) may be disposed between the first lens (301) and the third lens (303). An additional lens may be disposed between the second lens (302) and the first lens (301) or between the second lens (302) and the third lens (303).

The second lens (302) may have a positive (+) refractive power. The second lens (302) may be formed with both surfaces convex. The second lens (302) may have the object side surface (S3) formed convex. The second lens (302) may have the object side surface (S3) formed convex relative to the optical axis. The second lens (302) may have an upper side surface (S4) formed concavely. The second lens (302) may have the upper side surface (S4) formed concavely relative to the optical axis. The object side surface (S3) or upper side surface (S4) of the second lens (302) may include at least one inflection point.

The curvature radius of the object side surface (S3) of the second lens (302) may be positive. The curvature radius of the object side surface (S3) of the second lens (302) on the optical axis may be positive. The curvature radius of the upper side surface (S4) of the second lens (302) may be negative. The curvature radius of the second lens (302) on the optical axis of the upper side surface (S4) may be negative. The absolute value of the curvature radius of the object side surface (S3) of the second lens (302) may be smaller than the absolute value of the curvature radius of the upper side surface (S4) of the second lens (302). The second lens (302) may be a solid lens. Both surfaces of the second lens (302) may be formed as aspherical surfaces. One of the two surfaces of the second lens (302) may be formed as a spherical surface, and the other surface may be formed as an aspherical surface.

The second lens (302) may satisfy the range 1.5<N2<1.6. Additionally, the second lens (302) may satisfy the range 1.52<N2<1.58. N2 is the refractive index of the second lens (302). The second lens (302) may satisfy the range 50<V2<60. Additionally, the second lens (302) may satisfy the range 55<V2<58. V2 is the Abbe number of the second lens (302).

The lens unit may include a third lens (303). The third lens (303) may be the third lens disposed from the object side. The third lens (303) may be the third lens adjacent to the object side. The third lens (303) may be disposed between the second lens (302) and the image side. The third lens (303) may be disposed between the second lens (302) and the fourth lens (304). An additional lens may be disposed between the third lens (303) and the second lens (302) or between the third lens (303) and the fourth lens (304).

The third lens (303) may have a negative (−) refractive power. The third lens (303) may have a convex meniscus shape on the image side. The third lens (303) may have the object side surface (S5) formed concavely. The third lens (303) may have the object side surface (S5) formed concavely relative to the optical axis. The third lens (303) may have a convex upper side surface (S6). The third lens (303) may have a convex upper side surface (S6) relative to the optical axis. The object side surface or upper side surface of the third lens (303) may include at least one inflection point.

The curvature radius of the object side surface (S5) of the third lens (303) may be negative. The curvature radius of the object side surface (S5) of the third lens (303) relative to the optical axis may be negative. The curvature radius of the upper side surface (S6) of the third lens (303) may be negative. The curvature radius of the upper side surface (S6) of the third lens (303) along the optical axis may be negative. The absolute value of the curvature radius of the object side surface of the third lens (303) may be smaller than the absolute value of the curvature radius of the upper side surface of the third lens (303). The third lens (303) may be a solid lens. Both surfaces of the third lens (303) may be formed as aspherical surfaces. One of the two surfaces of the third lens (303) may be formed as a spherical surface, and the other surface may be formed as an aspherical surface.

The third lens (303) may satisfy the range 1.5<N3<1.6. Additionally, the third lens (303) may satisfy the range 1.52<N3<1.58. N3 is the refractive index of the third lens (303). The third lens (303) may satisfy the range 50<V3<60. Additionally, the third lens (303) may satisfy the range 52<V3<58. V3 is the Abbe number of the third lens (303).

The lens unit may include a fourth lens (304). The fourth lens (304) may be the fourth lens disposed from the object side. The fourth lens (304) may be the seventh lens disposed from the image side. The fourth lens (304) may be disposed between the third lens (303) and the image side. The fourth lens (304) may be disposed between the third lens (303) and the fifth lens (305). An additional lens may be disposed between the fourth lens (304) and the third lens (303) or between the fourth lens (304) and the fifth lens (305).

The fourth lens (304) may have a negative (−) refractive power. The fourth lens (304) may have a convex meniscus shape on the object side. The fourth lens (304) may have a convex object side surface (S7). The fourth lens (304) may have a convex object side surface (S7) relative to the optical axis. The fourth lens (304) may have a concave upper side surface (S8). The fourth lens (304) may have an upper side surface (S8) that is concave relative to the optical axis. The object side surface or upper side surface of the fourth lens (304) may include at least one inflection point.

The curvature radius of the object side surface (S7) of the fourth lens (304) may be positive. The curvature radius of the object side surface (S7) of the fourth lens (304) relative to the optical axis may be positive. The curvature radius of the upper side surface (S8) of the fourth lens (304) may be positive. The curvature radius of the fourth lens (304) on the optical axis of the upper side surface (S8) may be positive. The absolute value of the curvature radius of the object side surface (S7) of the fourth lens (304) may be greater than the absolute value of the curvature radius of the upper side surface (S8) of the fourth lens (304). The fourth lens (304) may be a solid lens. Both surfaces of the fourth lens (304) may be formed as aspherical surfaces. One of the two surfaces of the fourth lens (304) may be formed as a spherical surface, and the other surface may be formed as an aspherical surface.

The fourth lens (304) may satisfy the range of 1.6<N4<1.7. Additionally, the fourth lens (304) may satisfy the range of 1.65<N4<1.7. N4 is the refractive index of the fourth lens (304). The fourth lens (304) may satisfy the range of 15<V4<30. Additionally, the fourth lens (304) may satisfy the range of 17<V4<20. V4 is the Abbe number of the fourth lens (304).

The lens unit may include a fifth lens (305). The fifth lens (305) may be the fifth lens disposed from the object side. The fifth lens (305) may be the sixth lens disposed from the image side. The fifth lens (305) may be disposed between the fourth lens (304) and the image side. The fifth lens (305) may be disposed between the fourth lens (304) and the sixth lens (306). An additional lens may be disposed between the fifth lens (305) and the fourth lens (304) or between the fifth lens (305) and the sixth lens (306).

The fifth lens (305) may have a positive (+) refractive power. The fifth lens (305) may have a convex meniscus shape on the image side. The fifth lens (305) may have an object side surface (S9) formed concavely. The fifth lens (305) may have the object side surface (S9) formed concavely relative to the optical axis. The fifth lens (305) may have an upper side surface (S10) formed convexly. The fifth lens (305) may have the upper side surface (S10) convex relative to the optical axis. The object side surface or upper side surface of the fifth lens (305) may include at least one inflection point.

The curvature radius of the object side surface (S9) of the fifth lens (305) may be negative. The curvature radius of the object side surface (S9) of the fifth lens (305) relative to the optical axis may be negative. The curvature radius of the upper side surface (S10) of the fifth lens (305) may be negative. The curvature radius of the upper side surface (S10) of the fifth lens (305) along the optical axis may be negative. The absolute value of the curvature radius of the object side surface (S9) of the fifth lens (305) may be greater than the absolute value of the curvature radius of the upper side surface (S10) of the fifth lens (305). The fifth lens (305) may be a solid lens. Both surfaces of the fifth lens (305) may be formed as aspherical surfaces. One of the two surfaces of the fifth lens (305) may be formed as a spherical surface, and the other surface may be formed as an aspherical surface.

The fifth lens (305) may satisfy the range of 1.5<N5<1.6. Additionally, the fifth lens (305) may satisfy the range of 1.52<N5<1.58. N5 is the refractive index of the fifth lens (305). The fifth lens (305) may satisfy the range of 50<V5<60. Additionally, the fifth lens (305) may satisfy the range of 52<V5<58. V5 is the Abbe number of the fifth lens (305).

The lens unit may include a sixth lens (306). The sixth lens (306) may be the sixth lens disposed from the object side. The sixth lens (306) may be the fifth lens disposed from the image side. The sixth lens (306) may be disposed between the fifth lens (305) and the seventh lens (307). The sixth lens (306) may be disposed between the fifth lens (305) and the image side. An additional lens may be disposed between the sixth lens (306) and the fifth lens (305) or between the sixth lens (306) and the seventh lens (307).

The sixth lens (306) may have a negative (−) refractive power. The sixth lens (306) may have a convex meniscus shape on the image side. The sixth lens (306) may have the object side surface (S11) formed concavely. The sixth lens (306) may have the object side surface (S11) concave relative to the optical axis. The sixth lens (306) may have the upper side surface (S12) convex. The sixth lens (306) may have the upper side surface (S12) convex relative to the optical axis. The object side surface or upper side surface of the sixth lens (306) may include at least one inflection point.

The curvature radius of the object side surface (S11) of the sixth lens (306) may be negative. The curvature radius of the object side surface (S11) of the sixth lens (306) relative to the optical axis may be negative. The curvature radius of the upper side surface (S12) of the sixth lens (306) may be negative. The curvature radius of the upper side surface (S12) of the sixth lens (306) along the optical axis may be negative. The absolute value of the curvature radius of the object side surface of the sixth lens (306) may be smaller than the absolute value of the curvature radius of the upper side surface of the sixth lens (306). The sixth lens (306) may be a solid lens.

The two surfaces of the sixth lens (306) may be formed as aspherical surfaces. One of the two surfaces of the sixth lens (306) may be formed as a spherical surface, and the other surface may be formed as an aspherical surface. The sixth lens (306) may have a surface including one or more inflection points.

The sixth lens (306) may satisfy the range 1.5<N6<1.6. Additionally, the sixth lens (306) may satisfy the range 1.52<N6<1.58. N6 is the refractive index of the sixth lens (306). The sixth lens (306) may satisfy the range 50<V6<60. Additionally, the sixth lens (306) may satisfy the range 52<V6<58. V6 is the Abbe number of the sixth lens (306).

The lens unit may include a seventh lens (307). The seventh lens (307) may be the seventh lens disposed from the object side. The seventh lens (307) may be the fourth lens disposed from the image side. The seventh lens (307) may be disposed between the sixth lens (306) and the eighth lens (308). The seventh lens (307) may be disposed between the sixth lens (306) and the image side. An additional lens may be disposed between the seventh lens (307) and the sixth lens (306) or between the seventh lens (307) and the eighth lens (308).

The seventh lens (307) may have a positive (+) refractive power. The seventh lens (307) may have a convex meniscus shape on the image side. The seventh lens (307) may have the object side surface (S13) formed concavely. The seventh lens (307) may have the object side surface (S13) formed concavely relative to the optical axis. The seventh lens (307) may have a convex upper side surface (S14). The seventh lens (307) may have a convex upper side surface (S14) relative to the optical axis. The object side surface or upper side surface of the seventh lens (307) may include at least one inflection point.

The curvature radius of the object side surface (S13) of the seventh lens (307) may be negative. The curvature radius of the object side surface (S13) of the seventh lens (307) on the optical axis may be negative. The curvature radius of the upper side surface (S14) of the seventh lens (307) may be negative. The curvature radius of the upper side surface (S14) of the 7th lens (307) along the optical axis may be negative. The absolute value of the curvature radius of the object side surface of the 7th lens (307) may be greater than the absolute value of the curvature radius of the upper side surface of the 7th lens (307). The 7th lens (307) may be a solid lens. Both surfaces of the seventh lens (307) may be formed as aspherical surfaces. One of the two surfaces of the seventh lens (307) may be formed as a spherical surface, and the other surface may be formed as an aspherical surface. The seventh lens (307) may have a surface including one or more inflection points.

The seventh lens (307) may satisfy the range 1.5<N7<1.6. Additionally, the seventh lens (307) may satisfy the range 1.52<N7<1.58. N7 is the refractive index of the seventh lens (307). The seventh lens (307) may satisfy the range 50<V7<60. Additionally, the seventh lens (307) may satisfy the range 52<V7<58. V6 is the Abbe number of the seventh lens (307).

The lens unit may include an eighth lens (308). The eighth lens (308) may be the eighth lens disposed from the object side. The eighth lens (308) may be the third lens from the image side. The eighth lens (308) may be disposed between the seventh lens (307) and the ninth lens (309). The eighth lens (308) may be disposed between the seventh lens (307) and the image side. An additional lens may be disposed between the eighth lens (308) and the seventh lens (307) or between the eighth lens (308) and the ninth lens (309).

The eighth lens (308) may have a negative (−) refractive power. The eighth lens (308) may have a concave shape on both sides. The eighth lens (308) may have an object side surface (S15) formed concavely. The eighth lens (308) may have the object side surface (S15) formed convexly relative to the optical axis. The eighth lens (308) may have an upper side surface (S16) formed concavely. The eighth lens (308) may have the upper side surface (S16) concave relative to the optical axis. The object side surface or upper side surface of the eighth lens (308) may include at least one inflection point.

The curvature radius of the object side surface (S15) of the eighth lens (308) may be negative. The curvature radius of the object side surface (S16) of the eighth lens (308) on the optical axis may be negative. The curvature radius of the upper side surface (S16) of the eighth lens (308) may be positive. The curvature radius of the upper side surface (S16) of the 8th lens (308) along the optical axis may be positive. The value of the curvature radius of the object side surface of the 8th lens (308) may be greater than the value of the curvature radius of the upper side surface of the 8th lens (308). The 8th lens (308) may be a solid lens. Both surfaces of the eighth lens (308) may be formed as aspherical surfaces. One of the two surfaces of the eighth lens (308) may be formed as a spherical surface, and the other surface may be formed as an aspherical surface. The eighth lens (308) may have a surface including one or more inflection points.

The eighth lens (308) may satisfy the range 1.6<N8<1.7. Additionally, the eighth lens (308) may satisfy the range 1.65<N8<1.7. N8 is the refractive index of the eighth lens (308). The eighth lens (308) may satisfy the range 10<V8<25. Additionally, the eighth lens (308) may satisfy the range 15<V8<20. V8 is the Abbe number of the eighth lens (308).

The lens unit may include a ninth lens (309). The ninth lens (309) may be the ninth lens disposed from the object side. The ninth lens (309) may be the second lens disposed from the image side. The ninth lens (309) may be disposed between the eighth lens (308) and the tenth lens (310). The ninth lens (309) may be disposed between the eighth lens (308) and the image side. An additional lens may be disposed between the 9th lens (309) and the 8th lens (308) or between the 9th lens (309) and the 10th lens (310).

The 9th lens (309) may have a positive (+) refractive power. The ninth lens (309) may have a convex meniscus shape on the object side. The ninth lens (309) may have the object side surface (S17) formed convexly. The ninth lens (309) may have the object side surface (S17) formed convexly relative to the optical axis. The ninth lens (309) may have an upper side surface (S18) formed concavely. The ninth lens (309) may have the upper side surface (S18) formed concavely relative to the optical axis. The object side surface or upper side surface of the ninth lens (309) may include at least one inflection point.

The curvature radius of the object side surface (S17) of the ninth lens (309) may be positive. The curvature radius of the object side surface (S17) of the ninth lens (309) on the optical axis may be positive. The curvature radius of the upper side surface (S18) of the ninth lens (309) may be positive. The curvature radius of the upper side surface (S18) of the ninth lens (309) on the optical axis may be positive. The value of the curvature radius of the object side surface of the ninth lens (309) may be smaller than the value of the curvature radius of the upper side surface of the ninth lens (309). The ninth lens (309) may be a solid lens. Both surfaces of the ninth lens (309) may be formed as aspherical surfaces. One of the two surfaces of the ninth lens (309) may be formed as a spherical surface, and the other surface may be formed as an aspherical surface. The ninth lens (309) may have a surface including one or more inflection points.

The ninth lens (309) may satisfy the range 1.6<N9<1.7. Additionally, the ninth lens (309) may satisfy the range 1.65<N9<1.7. N9 is the refractive index of the ninth lens (309). The ninth lens (309) may satisfy the range 20<V9<30. Additionally, the ninth lens (309) may satisfy the range 22<V9<28. V9 is the Abbe number of the ninth lens (309).

The lens unit may include a tenth lens (310). The tenth lens (310) may be the lens most adjacent to the upper side. The tenth lens (310) may be disposed between the ninth lens (309) and the image side. An additional lens may be disposed between the tenth lens (310) and the ninth lens (309) or between the tenth lens (310) and the filter (900).

The tenth lens (310) may have a negative (−) refractive power. The tenth lens (310) may have a convex meniscus shape on the object side. The tenth lens (310) may have the object side surface (S19) formed convexly. The tenth lens (310) may have the object side surface (S19) formed convexly relative to the optical axis. The tenth lens (310) may have an upper side surface (S20) formed concavely. The tenth lens (310) may have the upper side surface (S20) formed concavely relative to the optical axis. The object side surface or upper side surface of the tenth lens (310) may include at least one inflection point.

The curvature radius of the object side surface (S19) of the tenth lens (310) may be positive. The curvature radius of the object side surface (S19) of the tenth lens (310) on the optical axis may be positive. The curvature radius of the upper side surface (S20) of the tenth lens (310) may be positive. The curvature radius of the upper side surface (S20) of the 10th lens (310) along the optical axis may be positive. The value of the curvature radius of the object side surface of the 10th lens (310) may be greater than the value of the curvature radius of the upper side surface of the 10th lens (310). The 10th lens (310) may be a solid lens. The two surfaces of the 10th lens (310) may be formed as aspherical surfaces. One of the two surfaces of the 10th lens (310) may be formed as a spherical surface, and the other surface may be formed as an aspherical surface. The 10th lens (310) may have a surface including one or more inflection points.

The tenth lens (310) may satisfy the range 1.5<N10<1.6. Additionally, the tenth lens (310) may satisfy the range 1.52<N10<1.55. N10 is the refractive index of the tenth lens (310). The tenth lens (310) may satisfy the range of 50<V10<60. Additionally, the tenth lens (310) may satisfy the range of 52<V10<58. V10 is the Abbe number of the tenth lens (310).

The imaging lens may include an aperture (STOP). The aperture (STOP) may be disposed between the first lens (301) and the second lens (302). The aperture (STOP) may be disposed closer to the second lens (302) than to the first lens (301). The aperture (STOP) may be spaced apart from the object side surface of the first lens (301). The aperture (STOP) may regulate the amount of light incident from a subject. The aperture (STOP) may regulate the amount of light passing through the first lens (301). The aperture (STOP) can regulate the amount of light entering the second lens (302). The aperture (STOP) may include an aperture stop.

TABLE 5

| | | | | | | Semi | Focal |
|---|---|---|---|---|---|---|---|
| Lens | Surface | Radius | Thickness | nd | vd | Aperture | length |
| 1 | S1 | 2.64 | 0.40 | 1.55 | 56.11 | 1.409 | −60.43 |
| | S2 | 2.31 | 0.10 | | | 1.270 | |
| 2 | S3(Stop) | 2.13 | 0.45 | 1.55 | 56.11 | 0.999 | 3.60 |
| | S4 | −23.05 | 0.10 | | | 1.015 | |
| 3 | S5 | −169.44 | 0.25 | 1.55 | 56.11 | 1.033 | −4309.87 |
| | S6 | −182.67 | 0.10 | | | 1.077 | |
| 4 | S7 | 4.55 | 0.28 | 1.68 | 19.24 | 1.133 | −11.80 |
| | S8 | 2.83 | 0.25 | | | 1.174 | |
| 5 | S9 | −280.65 | 0.25 | 1.55 | 56.11 | 1.190 | 146.18 |
| | S10 | −62.21 | 0.10 | | | 1.274 | |
| 6 | S11 | −19.25 | 0.35 | 1.55 | 56.11 | 1.305 | −774.31 |
| | S12 | −20.30 | 0.20 | | | 1.422 | |
| 7 | S13 | −17.49 | 0.28 | 1.55 | 56.11 | 1.463 | 27.18 |
| | S14 | −8.08 | 0.32 | | | 1.611 | |
| 8 | S15 | −5.92 | 0.30 | 1.68 | 19.24 | 1.746 | −5.29 |
| | S16 | 9.32 | 0.10 | | | 1.903 | |
| 9 | S17 | 2.07 | 0.58 | 1.62 | 25.59 | 1.930 | 4.85 |
| | S18 | 5.90 | 0.50 | | | 2.624 | |
| 10 | S19 | 3.11 | 0.50 | 1.54 | 55.66 | 3.273 | −13.86 |
| | S20 | 2.07 | 0.30 | | | 3.727 | |
| Filter | S21 | Infinity | 0.11 | 1.52 | 64.2 | 3.901 | |
| | S22 | Infinity | 0.39 | | | 3.937 | |
| | Image | Infinity | 0.01 | | | 4.106 | |

Table 5 shows the surface number (Surface), curvature radius (Radius), center thickness of each lens or distance between lens surfaces (Thickness), refractive index (Index, nd), Abbe number (Abbe, vd), effective radius (Semi Aperture), and focal length (Focal length) of the lens according to the third embodiment of the present invention. Here, the units for curvature radius 5 and thickness or distance may be mm.

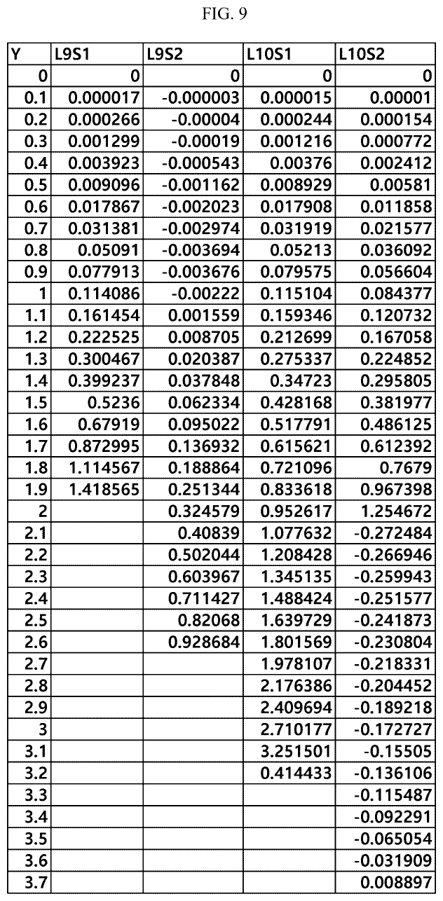

FIG. 9 is a table showing the Sag values of the object side surface and sensor side surface of the ninth lens and tenth lens according to the third embodiment of the present invention.

The object side 17th surface (S17) and sensor side 18th surface (S18) of the ninth lens (309) may have at least one critical point extending from the optical axis (OA) to the end of the effective area. The sensor side 18th surface (S18) of the ninth lens (309) may have a critical point at a point where the Y value is 0.8 mm to 1.0 mm from the optical axis (OA). If the sensor side 18th surface (S18) of the 9th lens (309) has a critical point, the critical point may be located within a range of 30% to 40% of the effective radius from the optical axis (OA).

The object side 19th surface (S19) and the sensor side 20th surface (S20) of the 10th lens (310) may have at least one critical point extending from the optical axis (OA) to the end of the effective area. The object-side 19th surface (S19) of the 10th lens (310) may have a critical point at a point where the Y value is 3.1 mm to 3.2 mm along the optical axis (OA). Here, Y denotes the distance in the direction perpendicular to the optical axis (OA). When the object-side 19th surface (S19) of the 10th lens (310) has a critical point, the critical point may be located within a range that is 90% or more but not more than 95% of the effective radius from the optical axis (OA). The sensor-side 20th surface (S20) of the 10th lens (310) may have a critical point at a point where the Y value is 2 mm to 2.1 mm from the optical axis (OA). If the sensor-side 20th surface (S20) of the 10th lens (310) has a critical point, the critical point may be located within a range where the distance from the optical axis (OA) is 50% or more and 60% or less of the effective radius.

TABLE 6

| | Third |
|---|---|
| | embodiment |
| TTL | 6.10 |
| F | 4.56 |
| Fno | 2.2 |
| ImgH * 2 | 8.2 |
| FOV | 70 |

Table 6 shows the characteristics of the imaging lens according to the third embodiment of the present invention.

TTL denotes the optical axis distance from the object-side surface vertex of the first lens (301) to the image surface, F denotes the total focal length, Fno denotes the ratio of the focal length to the effective diameter of the lens, ImgH denotes the distance from the optical axis (OA) to the diagonal end of the image sensor (800) or half of the maximum diagonal length, FOV denotes the field of view in the diagonal direction of the optical system. Here, the units of TTL, F, and ImgH may be mm, and the unit of FOV may be degrees.

The configuration of the optical system according to the fourth embodiment of the present invention will now be described with reference to the drawings.

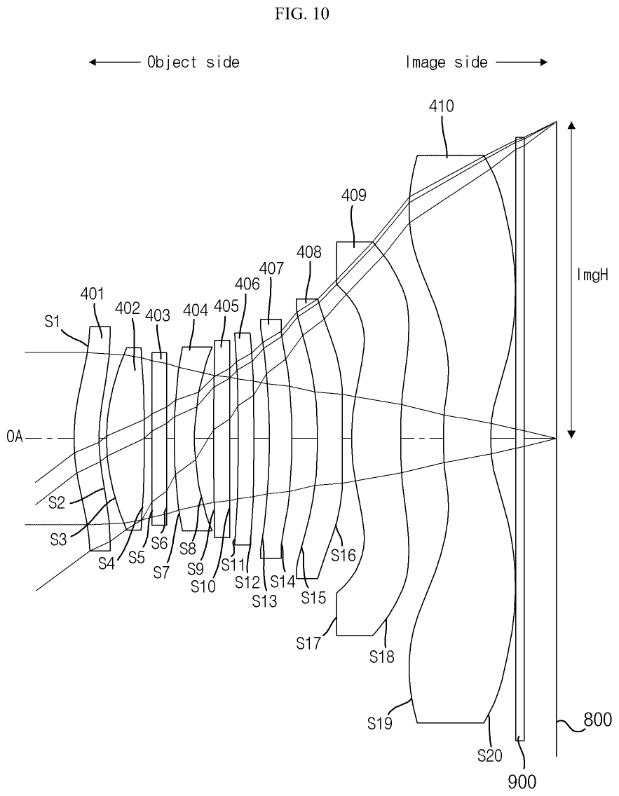

FIG. 10 is a side cross-sectional view of the optical system and a camera module having the same according to the fourth embodiment.

The optical system according to the fourth embodiment may include a lens unit, which may include a first lens (401) to a tenth lens (410). The first to tenth lenses (401, 402, 403, 404, 405, 406, 407, 408, 409, 410) may be sequentially disposed along the optical axis (OA). Light corresponding to the information of an object may pass through the first lens (401) to the tenth lens (410) and the filter (900) and enter the image sensor (800).

The lens unit may be disposed, in order from the object side to the image side, as a first lens (401), a second lens (402), an aperture (STOP), a third lens (403), a fourth lens (404), a fifth lens (405), a sixth lens (406), a seventh lens (407), an eighth lens (408), a ninth lens (409), and a tenth lens (410). The imaging lens according to the fourth embodiment may be composed of eight or fewer lenses. Alternatively, the imaging lens according to the fourth embodiment may be composed of nine or more lenses.

In other embodiments, one or more additional lenses, plates, or optical elements may be added between the first lens (401) and the tenth lens (410). Additionally, one or more additional lenses, plates, or optical elements may be added in front of the first lens (401) or behind the tenth lens (410). Furthermore, one or more additional lenses, plates, or optical elements may be added between the aperture (STOP) and the lens, between the lens and the filter (900), and between the filter (900) and the image sensor (800). In this case, the filter (900) may be a plate lens. The refractive power of the plate lens may be ‘0’. The refractive power of the flat lens may be zero. Additionally, a filter layer may be disposed between the aperture (STOP) and the lens, between the lens and the filter (900), and between the filter (900) and the image sensor (800). In this case, the filter layer may be coated to function as a filter.

The lens unit may include a first lens (401). The first lens (401) may be closest to the object side. The first lens (401) may be the first lens disposed on the object side. The first lens (401) may be the first lens adjacent to the object side. An additional lens may be disposed between the first lens (401) and the second lens (402). The second to eighth lenses (402, 403, 404, 405, 406, 407, 408) may be disposed between the first lens (401) and the tenth lens (410). Between the first lens (401) and the tenth lens (410), additional lenses other than the second to ninth lenses (402, 403, 404, 405, 406, 407, 408, 409) may be disposed. At least two lenses may be additionally disposed between any two of the first to tenth lenses (401, 402, 403, 404, 405, 406, 407, 408, 409, 410).

The first lens (401) may have a negative (−) refractive power. The first lens (401) may have a convex meniscus shape on the object side. The first lens (401) may have the object side surface (S1) formed convexly. The first lens (401) may have the object side surface (S1) formed convexly relative to the optical axis. The first lens (401) may have an upper side surface (S2) formed concavely. The first lens (401) may have an upper side surface (S2) formed concavely relative to the optical axis. The object side surface or upper side surface of the first lens (401) may include at least one inflection point.

The curvature radius of the object side surface (S1) of the first lens (401) may be positive. The curvature radius of the object side surface (S1) of the first lens (401) at the optical axis may be positive. The curvature radius of the upper side surface (S2) of the first lens (401) may be positive. The curvature radius of the upper surface (S2) of the first lens (401) along the optical axis may be positive. The absolute value of the curvature radius of the object side surface (S1) of the first lens (401) may be greater than the absolute value of the curvature radius of the upper side surface (S2) of the first lens (401). The first lens (401) may be a solid lens. Both surfaces of the first lens (401) may be formed as aspherical surfaces. One of the two surfaces of the first lens (401) may be formed as a spherical surface, and the other surface may be formed as an aspherical surface.

The first lens (401) may satisfy the range 1.5<N1<1.6. Additionally, the first lens (401) may satisfy the range 1.52<N1<1.58. N1 is the refractive index of the first lens (401). The first lens (401) may satisfy the range of 50<V1<60. Additionally, the first lens (401) may satisfy the range of 52<V1<58. V1 is the Abbe number of the first lens (401).

The lens unit may include a second lens (402). The second lens (402) may be the second lens disposed from the object side. The second lens (402) may be the second lens adjacent to the first lens (401) from the object side. The second lens (402) may be arranged between the first lens (401) and the image side. The second lens (402) may be disposed between the first lens (401) and the third lens (403). An additional lens may be disposed between the second lens (402) and the first lens (401) or between the second lens (402) and the third lens (403).

The second lens (402) may have a positive (+) refractive power. The second lens (402) may be formed with both surfaces convex. The second lens (402) may be formed with the object side surface (S3) convex. The second lens (402) may be formed with the object side surface (S3) convex relative to the optical axis. The second lens (402) may have an upper side surface (S4) formed concavely. The second lens (402) may have the upper side surface (S4) formed concavely relative to the optical axis. The object side surface (S3) or upper side surface (S4) of the second lens (402) may include at least one inflection point.

The curvature radius of the object side surface (S3) of the second lens (402) may be positive. The curvature radius of the object side surface (S3) of the second lens (402) relative to the optical axis may be positive. The curvature radius of the upper side surface (S4) of the second lens (402) may be negative. The curvature radius of the second lens (402) on the optical axis of the upper side surface (S4) may be negative. The absolute value of the curvature radius of the object side surface (S3) of the second lens (402) may be smaller than the absolute value of the curvature radius of the upper side surface (S4) of the second lens (402). The second lens (402) may be a solid lens. Both surfaces of the second lens (402) may be formed as aspherical surfaces. One of the two surfaces of the second lens (402) may be formed as a spherical surface, and the other surface may be formed as an aspherical surface.

The second lens (402) may satisfy the range 1.5<N2<1.6. Additionally, the second lens (402) may satisfy the range 1.52<N2<1.58. N2 is the refractive index of the second lens (402). The second lens (402) may satisfy the range 50<V2<60. Additionally, the second lens (402) may satisfy the range 55<V2<58. V2 is the Abbe number of the second lens (402).

The lens unit may include a third lens (403). The third lens (403) may be the third lens disposed from the object side. The third lens (403) may be the third lens adjacent to the object side. The third lens (403) may be disposed between the second lens (402) and the image side. The third lens (403) may be dispose between the second lens (402) and the fourth lens (404). An additional lens may be disposed between the third lens (403) and the second lens (402) or between the third lens (403) and the fourth lens (404).

The third lens (403) may have a positive (+) refractive power. The third lens (403) may have a convex shape on both sides. The third lens (403) may have the object side surface (S5) formed convexly. The third lens (403) may have the object side surface (S5) formed convexly relative to the optical axis. The third lens (403) may have a convex upper side surface (S6). The third lens (403) may have a convex upper side surface (S6) relative to the optical axis. The object side surface or upper side surface of the third lens (403) may include at least one inflection point.

The curvature radius of the object side surface (S5) of the third lens (403) may be positive. The curvature radius of the object side surface (S5) of the third lens (403) relative to the optical axis may be positive. The curvature radius of the upper side surface (S6) of the third lens (403) may be negative. The curvature radius of the upper side surface (S6) of the third lens (403) along the optical axis may be negative. The absolute value of the curvature radius of the object side surface of the third lens (403) may be smaller than the absolute value of the curvature radius of the upper side surface of the third lens (403). The third lens (403) may be a solid lens. Both surfaces of the third lens (403) may be formed as aspherical surfaces. One of the two surfaces of the third lens (403) may be formed as a spherical surface, and the other surface may be formed as an aspherical surface.

The third lens (403) may satisfy the range 1.5<N3<1.6. Additionally, the third lens (403) may satisfy the range 1.52<N3<1.58. N3 is the refractive index of the third lens (403). The third lens (403) may satisfy the range 50<V3<60. Additionally, the third lens (403) may satisfy the range 52<V3<58. V3 is the Abbe number of the third lens (403).

The lens unit may include a fourth lens (404). The fourth lens (404) may be the fourth lens disposed from the object side. The fourth lens (404) may be the seventh lens disposed from the image side. The fourth lens (404) may be disposed between the third lens (403) and the image side. The fourth lens (404) may be disposed between the third lens (403) and the fifth lens (405). An additional lens may be disposed between the fourth lens (404) and the third lens (403) or between the fourth lens (404) and the fifth lens (405).

The fourth lens (404) may have a negative (−) refractive power. The fourth lens (404) may have a convex meniscus shape on the object side. The fourth lens (404) may have an object side surface (S7) formed convexly. The fourth lens (404) may have the object side surface (S7) formed convexly relative to the optical axis. The fourth lens (404) may have an upper side surface (S8) formed concavely. The fourth lens (404) may have an upper side surface (S8) that is concave relative to the optical axis. The object side surface or upper side surface of the fourth lens (404) may include at least one inflection point.

The curvature radius of the object side surface (S7) of the fourth lens (404) may be positive. The curvature radius of the object side surface (S7) of the fourth lens (404) relative to the optical axis may be positive. The curvature radius of the upper side surface (S8) of the fourth lens (404) may be positive. The curvature radius of the fourth lens (404) on the optical axis of the upper side surface (S8) may be positive. The absolute value of the curvature radius of the object side surface (S7) of the fourth lens (404) may be greater than the absolute value of the curvature radius of the upper side surface (S8) of the fourth lens (404). The fourth lens (404) may be a solid lens. Both surfaces of the fourth lens (404) may be formed as aspherical surfaces. One of the two surfaces of the fourth lens (404) may be formed as a spherical surface, and the other surface may be formed as an aspherical surface.

The fourth lens (404) may satisfy the range 1.6<N4<1.7. Additionally, the fourth lens (404) may satisfy the range 1.65<N4<1.7. N4 is the refractive index of the fourth lens (404). The fourth lens (404) may satisfy the range 15<V4<30. Additionally, the fourth lens (404) may satisfy the range 17<V4<20. V4 is the Abbe number of the fourth lens (404).

The lens unit may include a fifth lens (405). The fifth lens (405) may be the fifth lens disposed from the object side. The fifth lens (405) may be the sixth lens disposed from the image side. The fifth lens (405) may be disposed between the fourth lens (404) and the image side. The fifth lens (405) may be disposed between the fourth lens (404) and the sixth lens (406). An additional lens may be disposed between the fifth lens (405) and the fourth lens (404) or between the fifth lens (405) and the sixth lens (406).

The fifth lens (405) may have a positive (+) refractive power. The fifth lens (405) may have a convex meniscus shape on the image side. The fifth lens (405) may have an object side surface (S9) formed concavely. The fifth lens (405) may have the object side surface (S9) formed concavely relative to the optical axis. The fifth lens (405) may have an upper side surface (S10) formed convexly. The fifth lens (405) may have the upper side surface (S10) convex relative to the optical axis. The object side surface or upper side surface of the fifth lens (405) may include at least one inflection point.

The curvature radius of the object side surface (S9) of the fifth lens (405) may be negative. The curvature radius of the object side surface (S9) of the fifth lens (405) relative to the optical axis may be negative. The curvature radius of the upper side surface (S10) of the fifth lens (405) may be negative. The curvature radius of the upper side surface (S10) of the fifth lens (405) along the optical axis may be negative. The absolute value of the curvature radius of the object side surface (S9) of the fifth lens (405) may be greater than the absolute value of the curvature radius of the upper side surface (S10) of the fifth lens (405). The fifth lens (405) may be a solid lens. Both surfaces of the fifth lens (405) may be formed as aspherical surfaces. One of the two surfaces of the fifth lens (405) may be formed as a spherical surface, and the other surface may be formed as an aspherical surface.

The fifth lens (405) may satisfy the range 1.5<N5<1.6. Additionally, the fifth lens (405) may satisfy the range 1.52<N5<1.58. N5 is the refractive index of the fifth lens (405). The fifth lens (405) may satisfy the range 50<V5<60. Additionally, the fifth lens (405) may satisfy the range 52<V5<58. V5 is the Abbe number of the fifth lens (405).

The lens unit may include a sixth lens (406). The sixth lens (406) may be the sixth lens disposed from the object side. The sixth lens (406) may be the fifth lens disposed from the image side. The sixth lens (406) may be disposed between the fifth lens (405) and the seventh lens (407). The sixth lens (406) may be disposed between the fifth lens (405) and the image side. An additional lens may be disposed between the sixth lens (406) and the fifth lens (405) or between the sixth lens (406) and the seventh lens (407).

The sixth lens (406) may have a positive (+) refractive power. The sixth lens (406) may have a convex meniscus shape on the image side. The sixth lens (406) may have an object side surface (S11) formed concavely. The sixth lens (406) may have the object side surface (S11) formed concavely relative to the optical axis. The sixth lens (406) may have an upper side surface (S12) formed convexly. The sixth lens (406) may have an upper side surface (S12) that is convex relative to the optical axis. The object side surface or upper side surface of the sixth lens (406) may include at least one inflection point.

The curvature radius of the object side surface (S11) of the sixth lens (406) may be negative. The curvature radius of the object side surface (S11) of the sixth lens (406) relative to the optical axis may be negative. The curvature radius of the upper side surface (S12) of the sixth lens (406) may be negative. The curvature radius of the upper side surface (S12) of the sixth lens (406) along the optical axis may be negative. The absolute value of the curvature radius of the object side surface of the sixth lens (406) may be greater than the absolute value of the curvature radius of the upper side surface of the sixth lens (406). The sixth lens (406) may be a solid lens. Both surfaces of the sixth lens (406) may be formed as aspherical surfaces. One of the two surfaces of the sixth lens (406) may be formed as a spherical surface, and the other surface may be formed as an aspherical surface. The sixth lens (406) may have a surface including one or more inflection points.

The sixth lens (406) may satisfy the range 1.5<N6<1.6. Additionally, the sixth lens (406) may satisfy the range 1.52<N6<1.58. N6 is the refractive index of the sixth lens (406). The sixth lens (406) may satisfy the range 50<V6<60. Additionally, the sixth lens (406) may satisfy the range 52<V6<58. V6 is the Abbe number of the sixth lens (406).

The lens unit may include a seventh lens (407). The seventh lens (407) may be the seventh lens disposed from the object side. The seventh lens (407) may be the fourth lens disposed from the image side. The seventh lens (407) may be disposed between the sixth lens (406) and the eighth lens (408). The seventh lens (407) may be disposed between the sixth lens (406) and the image side. An additional lens may be disposed between the seventh lens (407) and the sixth lens (406) or between the seventh lens (407) and the eighth lens (408).

The seventh lens (407) may have a positive (+) refractive power. The seventh lens (407) may have a convex meniscus shape on the image side. The seventh lens (407) may have an object side surface (S13) formed concavely. The seventh lens (407) may have the object side surface (S13) formed concavely relative to the optical axis. The seventh lens (407) may have an upper side surface (S14) formed convexly. The seventh lens (407) may have an upper side surface (S14) that is convex relative to the optical axis. The object side surface or upper side surface of the seventh lens (407) may include at least one inflection point.

The curvature radius of the object side surface (S13) of the seventh lens (407) may be negative. The curvature radius of the object side surface (S13) of the seventh lens (407) relative to the optical axis may be negative. The curvature radius of the upper side surface (S14) of the seventh lens (407) may be negative. The curvature radius of the upper side surface (S14) of the seventh lens (407) along the optical axis may be negative. The absolute value of the curvature radius of the object side surface of the seventh lens (407) may be greater than the absolute value of the curvature radius of the upper side surface of the seventh lens (407). The seventh lens (407) may be a solid lens. Both surfaces of the seventh lens (407) may be formed as aspherical surfaces. One of the two surfaces of the seventh lens (407) may be formed as a spherical surface, and the other surface may be formed as an aspherical surface. The seventh lens (407) may have a surface including one or more inflection points.

The seventh lens (407) may satisfy the range 1.5<N7<1.6. Additionally, the seventh lens (407) may satisfy the range 1.52<N7<1.58. N7 is the refractive index of the seventh lens (407). The seventh lens (407) may satisfy the range 50<V7<60. Additionally, the seventh lens (407) may satisfy the range 52<V7<58. V6 is the Abbe number of the seventh lens (407).

The lens unit may include an eighth lens (408). The eighth lens (408) may be the eighth lens disposed from the object side. The eighth lens (408) may be the third lens disposed from the image side. The eighth lens (408) may be disposed between the seventh lens (407) and the ninth lens (409). The eighth lens (408) may be disposed between the seventh lens (407) and the image side. An additional lens may be disposed between the eighth lens (408) and the seventh lens (407) or between the eighth lens (408) and the ninth lens (409).

The eighth lens (408) may have a negative (−) refractive power. The eighth lens (408) may have a concave shape on both sides. The eighth lens (408) may have an object side surface (S15) formed concavely. The eighth lens (408) may have the object side surface (S15) formed convexly relative to the optical axis. The eighth lens (408) may have an upper side surface (S16) formed concavely. The eighth lens (408) may have an upper side surface (S16) that is concave relative to the optical axis. The object side surface or upper side surface of the eighth lens (408) may include at least one inflection point.

The curvature radius of the object side surface (S15) of the eighth lens (408) may be negative. The curvature radius of the object side surface (S16) of the eighth lens (408) relative to the optical axis may be negative. The curvature radius of the upper side surface (S16) of the eighth lens (408) may be positive. The curvature radius of the upper side surface (S16) of the eighth lens (408) along the optical axis may be positive. The value of the curvature radius of the object side surface of the eighth lens (408) may be greater than the value of the curvature radius of the upper side surface of the eighth lens (408). The eighth lens (408) may be a solid lens. Both surfaces of the eighth lens (408) may be formed as aspherical surfaces. One of the two surfaces of the eighth lens (408) may be formed as a spherical surface, and the other surface may be formed as an aspherical surface. The eighth lens (408) may have a surface including one or more inflection points.

The eighth lens (408) may satisfy the range 1.6<N8<1.7. Additionally, the eighth lens (408) may satisfy the range 1.65<N8<1.7. N8 is the refractive index of the eighth lens (408). The eighth lens (408) may satisfy the range 10<V8<25. Additionally, the eighth lens (408) may satisfy the range 15<V8<20. V8 is the Abbe number of the eighth lens (408).

The lens unit may include a ninth lens (409). The ninth lens (409) may be the ninth lens disposed from the object side. The ninth lens (409) may be the second lens disposed from the image side. The ninth lens (409) may be disposed between the eighth lens (408) and the tenth lens (410). The ninth lens (409) may be disposed between the eighth lens (408) and the image side. An additional lens may be disposed between the 9th lens (409) and the 8th lens (408) or between the 9th lens (409) and the 10th lens (410).

The 9th lens (409) may have a positive (+) refractive power. The ninth lens (409) may have a convex meniscus shape on the object side. The ninth lens (409) may have the object side surface (S17) formed convexly. The ninth lens (409) may have the object side surface (S17) formed convexly relative to the optical axis. The ninth lens (409) may have an upper side surface (S18) formed concavely. The ninth lens (409) may have an upper side surface (S18) formed concavely relative to the optical axis. The object side surface or upper side surface of the ninth lens (409) may include at least one inflection point.

The curvature radius of the object side surface (S17) of the ninth lens (409) may be positive. The curvature radius of the object side surface (S17) of the ninth lens (409) relative to the optical axis may be positive. The curvature radius of the upper side surface (S18) of the ninth lens (409) may be positive. The curvature radius of the upper side surface (S18) of the ninth lens (409) along the optical axis may be positive. The value of the curvature radius of the object side surface of the ninth lens (409) may be smaller than the value of the curvature radius of the upper side surface of the ninth lens (409). The ninth lens (409) may be a solid lens. Both surfaces of the ninth lens (409) may be formed as aspherical surfaces. One of the two surfaces of the ninth lens (409) may be formed as a spherical surface, and the other surface may be formed as an aspherical surface. The ninth lens (409) may have a surface including one or more inflection points.

The ninth lens (409) may satisfy the range 1.6<N9<1.7. Additionally, the ninth lens (409) may satisfy the range 1.65<N9<1.7. N9 is the refractive index of the ninth lens (409). The ninth lens (409) may satisfy the range 20<V9<30. Additionally, the ninth lens (409) may satisfy the range 22<V9<28. V9 is the Abbe number of the ninth lens (409).

The lens unit may include a tenth lens (410). The tenth lens (410) may be the lens most adjacent to the image side. The tenth lens (410) may be disposed between the ninth lens (409) and the image side. An additional lens may be disposed between the tenth lens (410) and the ninth lens (409) or between the tenth lens (410) and the filter (900).

The tenth lens (410) may have a negative (−) refractive power. The tenth lens (410) may have a convex meniscus shape on the object side. The tenth lens (410) may have the object side surface (S19) formed convexly. The tenth lens (410) may have the object side surface (S19) formed convexly relative to the optical axis. The tenth lens (410) may have an upper side surface (S20) formed concavely. The tenth lens (410) may have an upper side surface (S20) formed concavely relative to the optical axis. The object side surface or upper side surface of the tenth lens (410) may include at least one inflection point.

The curvature radius of the object side surface (S19) of the tenth lens (410) may be positive. The curvature radius of the object side surface (S19) of the tenth lens (410) relative to the optical axis may be positive. The curvature radius of the upper side surface (S20) of the tenth lens (410) may be positive. The curvature radius of the upper side surface (S20) of the tenth lens (410) along the optical axis may be positive. The value of the curvature radius of the object side surface of the tenth lens (410) may be greater than the value of the curvature radius of the upper side surface of the tenth lens (410). The tenth lens (410) may be a solid lens. The two surfaces of the 10th lens (410) may be formed as aspherical surfaces. One of the two surfaces of the 10th lens (410) may be formed as a spherical surface, and the other surface may be formed as an aspherical surface. The 10th lens (410) may have a surface including one or more inflection points.

The tenth lens (410) may satisfy the range 1.5<N10<1.6. Additionally, the tenth lens (410) may satisfy the range 1.52<N10<1.55. N10 is the refractive index of the tenth lens (410). The tenth lens (410) may satisfy the range 50<V10<60. Additionally, the tenth lens (410) may satisfy the range 52<V10<58. V10 is the Abbe number of the tenth lens (410).

The imaging lens may include an aperture (STOP). The aperture (STOP) may be disposed between the first lens (401) and the second lens (402). The aperture (STOP) may be disposed closer to the second lens (402) than to the first lens (401). The aperture (STOP) may be spaced apart from the object side surface of the first lens (401). The stop (STOP) can regulate the amount of light entering from a subject. The aperture (STOP) can regulate the amount of light passing through the first lens (401). The aperture (STOP) can regulate the amount of light entering the second lens (402). The aperture (STOP) may include an aperture stop.

TABLE 7

| | | | | | | Semi | Focal |
|---|---|---|---|---|---|---|---|
| Lens | Surface | Radius | Thickness | nd | vd | Aperture | length |
| 1 | S1 | 2.63 | 0.31 | 1.55 | 56.11 | 1.409 | −297.34 |
| | S2 | 2.47 | 0.10 | | | 1.270 | |
| 2 | S3 | 2.28 | 0.47 | 1.55 | 56.11 | 0.999 | 3.88 |
| | S4 | −28.24 | 0.10 | | | 1.015 | |
| 3 | S5(Stop) | 776.72 | 0.19 | 1.55 | 56.11 | 1.033 | 165.78 |
| | S6 | −102.56 | 0.10 | | | 1.077 | |
| 4 | S7 | 4.67 | 0.25 | 1.68 | 19.24 | 1.133 | −9.98 |
| | S8 | 2.71 | 0.24 | | | 1.174 | |
| 5 | S9 | 133.34 | 0.20 | 1.55 | 56.11 | 1.190 | 145.23 |
| | S10 | −195.97 | 0.10 | | | 1.274 | |
| 6 | S11 | −26.25 | 0.20 | 1.55 | 56.11 | 1.305 | 182.85 |
| | S12 | −20.84 | 0.20 | | | 1.422 | |
| 7 | S13 | −20.18 | 0.29 | 1.55 | 56.11 | 1.463 | 26.65 |
| | S14 | −8.50 | 0.32 | | | 1.611 | |
| 8 | S15 | −5.87 | 0.31 | 1.68 | 19.24 | 1.746 | −5.37 |
| | S16 | 9.85 | 0.12 | | | 1.903 | |
| 9 | S17 | 2.10 | 0.62 | 1.62 | 25.59 | 1.930 | 4.74 |
| | S18 | 6.49 | 0.53 | | | 2.624 | |
| 10 | S19 | 3.14 | 0.60 | 1.54 | 55.66 | 3.273 | −7.86 |
| | S20 | 1.68 | 0.31 | | | 3.727 | |
| Filter | S21 | Infinity | 0.11 | 1.52 | 64.2 | 3.901 | |
| | S22 | Infinity | 0.39 | | | 3.937 | |
| | Image | Infinity | 0.01 | | | 4.106 | |

Table 7 shows the surface number (Surface), curvature radius (Radius), center thickness of each lens or distance between lens surfaces (Thickness), refractive index (Index, nd), Abbe number (Abbe, vd), effective radius (Semi Aperture), and focal length (Focal length) of the lens according to the fourth embodiment of the present invention. Here, the units for curvature radius and thickness or distance may be mm.

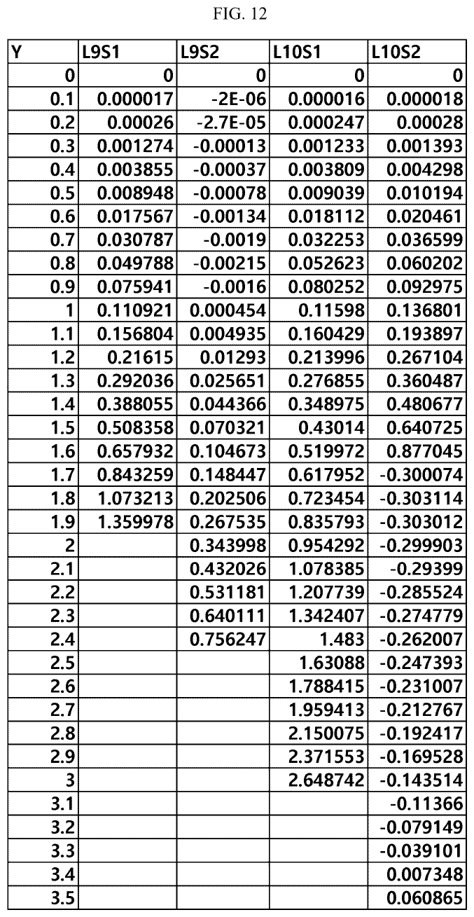

FIG. 12 is a table showing the Sag values of the object side surface and sensor side surface of the ninth lens and tenth lens according to the fourth embodiment of the present invention.

The object side 17th surface (S17) and sensor side 18th surface (S18) of the ninth lens (409) may have at least one critical point extending from the optical axis (OA) to the end of the effective area. The sensor side 18th surface (S18) of the 9th lens (409) may have a critical point at a point where the Y value is 0.8 mm to 1.0 mm from the optical axis (OA). If the sensor side 18th surface (S18) of the 9th lens (409) has a critical point, the critical point may be located within a range of 30% to 40% of the effective radius from the optical axis (OA).

The object-side 19th surface (S19) and sensor-side 20th surface (S20) of the 10th lens (410) may have at least one critical point extending to the end of the effective area along the optical axis (OA). The sensor-side 20th surface (S20) of the 10th lens (410) may have a critical point at a point where the Y value is 1.6 mm to 1.7 mm from the optical axis (OA). If the sensor-side 20th surface (S20) of the 10th lens (410) has a critical point, the critical point may be located within a range of 40% or more and 50% or less of the effective radius from the optical axis (OA).

TABLE 8

| | Fourth |
|---|---|
| | embodiment |
| TTL | 6.08 |
| F | 4.77 |
| Fno | 2.2 |
| ImgH * 2 | 8.2 |
| FOV | 73.6524 |

Table 8 shows the characteristics of the imaging lens according to the fourth embodiment of the present invention.

TTL denotes the optical axis distance from the object-side surface vertex of the first lens (401) to the image surface, F denotes the total focal length, Fno denotes the ratio of the focal length to the effective aperture of the lens, ImgH denotes the distance from the optical axis (OA) to the diagonal end of the image sensor (800) or half of the maximum diagonal length, FOV denotes the field of view in the diagonal direction of the optical system. Here, the units of TTL, F, and ImgH may be mm, and the unit of FOV may be degrees.

The optical system according to the first to fourth embodiments disclosed above may satisfy at least one or more of the mathematical equations described below. Accordingly, the optical system according to the first to fourth embodiments may have improved optical characteristics. For example, if the optical system according to the present embodiment satisfies at least one of the mathematical equations, the optical system can effectively control aberration characteristics such as chromatic aberration and distortion aberration, and can have good optical performance not only in the central portion but also in the peripheral portion of the field of view (FOV). Additionally, the optical system according to the first to fourth embodiments may have improved resolution. Furthermore, the thickness of the lens at the optical axis (OA) and the gap (spacing) between adjacent lenses at the optical axis (OA) as described in the mathematical equations may be referred to the embodiments disclosed above.

$$0.5 < TTL / ImgH * 2 < 0.9 \qquad [ Mathematical Equation 1 ]$$

Mathematical Equation 1 may allow setting the total optical axis length (TTL) of the optical system and the diagonal length (ImgH) from the optical axis of the image sensor (800). If the optical system according to the first to fourth embodiments satisfies Mathematical Equation 1, the optical system may have a TTL suitable for the image sensor (800), thereby providing improved image quality. Additionally, the ultra-thin characteristics of the camera lens group may be effectively achieved. Mathematical Equation 1 may preferably satisfy 0.7<TTL/ImgH<0.8 in the first to fourth embodiments.

$$Fno < 2.4 \qquad [ Mathematical Equation 2 ]$$

Mathematical Equation 2 may be used to set the range of Fno. When the optical system according to the first to fourth embodiments satisfies Mathematical Equation 2, the optical system may provide a bright image and effectively ensure the characteristic of a large aperture to emphasize the subject. Mathematical Equation 2 may preferably satisfy 2<Fno<2.3 in the first to fourth embodiments.

$$N 1 < 1.6 \qquad [ Mathematical Equation 3 ]$$

Mathematical Equation 3 may allow the refractive index of the first lens (101, 201, 301, 401) to be set. When the optical system according to the first to fourth embodiments satisfies Mathematical Equation 3, setting the refractive index of the first lens to a higher value may allow control over factors influencing the reduction of third-order aberrations (Zeiss aberrations) in the optical system and may reduce aberrations that may occur as the TTL increases. Mathematical Equation 3 may preferably satisfy 1.52<N1<1.57 in the first to fourth embodiments.

$$0 < \vert F 10 / F 1 \vert < 0.5 \qquad [ Mathematical Equation 4 ]$$

Mathematical Equation 4 may establish the relationship between the focal lengths of the first lens (101, 201, 301, 401) and the tenth lens (110, 210, 310, 410) in the optical system. When the optical system according to the first to fourth embodiments satisfies Mathematical Equation 4, the refractive power of the first and tenth lenses of the optical system may be controlled to improve resolution and affect the TTL and effective focal length (EFL). Mathematical Equation 4 may preferably satisfy 0<|F10/F1|<0.2 in the first to fourth embodiments.

$$5 < TTL < 6.5 \qquad [ Mathematical Equation 5 ]$$

Mathematical Equation 5 may set the range of TTL, which is the distance from the center of the first surface (S1) of the first lens (101, 201, 301, 401) to the optical axis (OA) of the image sensor (800). Mathematical Equation 5 may enable the provision of a compact mobile optical system. Mathematical Equation 5 may preferably satisfy the condition 6<TTL<6.2 in the first to fourth embodiments.

$$FOV > 65 \qquad [ Mathematical Equation 6 ]$$

Mathematical Equation 6 may set the range of the field of view (FOV) in the diagonal direction of the optical system. Mathematical Equation 6 in the first to fourth embodiments may preferably satisfy 70≤FOV<75.

$$0 < CT 1 / CT 2 < 1 \qquad [ Mathematical Equation 7 ]$$

In Mathematical Equation 7, CT1 denotes the thickness of the first lens (101, 201, 301, 401) on the optical axis (OA), and CT2 denotes the thickness (mm) of the second lens (102, 202, 302, 401) on the optical axis (OA). Mathematical Equation 7 may establish the relationship between the central thicknesses of the first and second lenses, enabling improvement of chromatic aberration in the optical system. Additionally, it allows setting the central thickness of the first aspherical lens (101, 201, 301, 401), thereby enhancing optical performance in both the central and peripheral regions of the field of view (FOV). Mathematical Equation 7 may satisfy the condition 0.5<CT1/CT2<1 in the first to fourth embodiments.

$$1 < TTL / F < 2 \qquad [ Mathematical Equation 8 ]$$

Mathematical Equation 8 may allow setting the total focal length (F) and total optical axis length (TTL) of the optical system. As a result, a mobile optical system can be provided. Mathematical Equation 8 may preferably satisfy the condition 1<TTL/F<1.5 in the first to fourth embodiments. When the optical system according to the first to fourth embodiments satisfies Mathematical Equation 8, the optical system can have an appropriate focal length within the set TTL range. If the value is below the lower limit of Mathematical Equation 8, it is necessary to increase the refractive power of the lenses, which makes it difficult to correct spherical aberration or distortion aberration. If the value exceeds the upper limit of Mathematical Equation 8, the lenses may become longer in terms of effective length or TTL, leading to the issue of the imaging lens system becoming larger.

$$4 < L 10 R 1 / CT 10 < 8 \qquad [ Mathematical Equation 9 ]$$

In Mathematical Equation 9, the curvature radius of the object side surface (S19) of the tenth lens (110, 210, 310, 410) and the central thickness of the tenth lens (110, 210, 310, 410) may be set, and the refractive power of the 10th lens (110, 210, 310, 410) can be controlled. As a result, good optical performance can be achieved in both the central and peripheral regions of the field of view. Preferably, Mathematical Equation 9 may satisfy the condition 5<L10R1/CT10<6.5 in the first to fourth embodiments. By adjusting the curvature radius and central thickness of the tenth lens (110, 210, 310, 410) having an aspherical surface according to Mathematical Equation 9, the TTL of the optical system may be reduced, and degradation of optical performance may be prevented.

$$1 < F / \vert L 1 R 1 \vert < 2 \qquad [ Mathematical Equation 10 ]$$

In Mathematical Equation 10, the effective focal length of the optical system and the curvature radius of the object side (S1) of the first lens (101, 201, 301, 401) are set, thereby controlling the effects on the incident light and the TTL. In the first to fourth embodiments, Mathematical Equation 10 may preferably satisfy the condition 1.5<F/|L1R1|<1.9.

$$1 < F / ImgH < 2 \qquad [ Mathematical Equation 11 ]$$

Mathematical Equation 11 may allow setting the total effective focal length (F) of the optical system and the diagonal length (ImgH) of the image sensor (800) from the optical axis. Such an optical system can exhibit improved aberration characteristics in the size of the mobile image sensor (800). In the first to fourth embodiments, Mathematical Equation 11 may preferably satisfy 1<F/ImgH<1.5.

$$30 < FOV / Fno < 40 \qquad [ Mathematical Equation 12 ]$$

Mathematical Equation 12 may establish the relationship between the diagonal field of view of the optical system and Fno. In the first to fourth embodiments, Mathematical Equation 12 may preferably satisfy 32<FOV/Fno<35. Here, Fno may be provided to be 2.3 or less, thereby providing a bright image.

$$1 < CT 9 / CT 10 < 2 \qquad [ Mathematical Equation 13 ]$$

In Mathematical Equation 13, CT9 denotes the thickness of the 9th lens (109, 209, 309, 409) at the optical axis (OA), and CT10 denotes the thickness of the 10th lens (110, 210, 310, 410) at the optical axis (OA). Mathematical Equation 13 may establish the relationship between the central thicknesses of the 9th and 10th lenses, enabling control over factors that influence aberrations. In the first to fourth embodiments, Mathematical Equation 13 may preferably satisfy the condition 1<CT9/CT10<1.5.

$$1 < \sum CT / \sum CG < 2.5 \qquad [ Mathematical Equation 14 ]$$

In Mathematical Equation 14, ECT is the sum of the central thicknesses of the lenses, and ECG is the sum of the gaps between adjacent lenses. When Mathematical Equation 14 is satisfied, the optical system can achieve good optical performance at the focal length in the specified field of view and reduce the size of the TTL. Preferably, the first, second, and fourth embodiments may satisfy 1.5<ΣCT/ΣCG<2, and the third embodiment may satisfy 1.8<ΣCT/ΣCG<2.3.

$$0.3 < CA \_ L 2 / ImgH < 0.8 \qquad [ Mathematical Equation 15 ]$$

In Mathematical Equation 15, CA_L2 is the effective focal length of the second lens (102, 202, 302, 402), and ImgH is the diagonal length (ImgH) of the image sensor (800) from the optical axis. When Mathematical Equation 15 is satisfied, the optical path entering the optical system can be controlled, and good optical performance can be achieved at the set field of view and focal length. Preferably, the first to fourth embodiments may satisfy 0.4<CA_L2/ImgH<0.8.

$$0.2 < CA \_ L 1 / CA \_ L 10 < 0.4 \qquad [ Mathematical Equation 16 ]$$

In Mathematical Equation 16, CA_L1 is the effective aperture size of the first lens (101.201, 301, 401), and CA_L10 is the effective aperture size of the tenth lens (110, 210, 310, 410). When Mathematical Equation 16 is satisfied, the optical paths of light entering the optical system and light exiting the image sensor can be controlled, and the optical system can achieve good optical performance at the set field of view and focal length. Preferably, the first to fourth embodiments may satisfy 0.3<CA_L1/CA_L10<0.4.

$$0.2 < CA \_ L 2 / CA \_ L 10 < 0.4 \qquad [ Mathematical Equation 17 ]$$

In Mathematical Equation 17, CA_L2 is the effective aperture size of the second lens (102, 202, 302, 402), and CA_L10 is the effective aperture size of the tenth lens (110, 210, 310, 410). When Mathematical Equation 17 is satisfied, the optical paths of light entering the optical system and light exiting the image sensor can be controlled, and the optical system can achieve good optical performance at the set field of view and focal length. Preferably, the first to fourth embodiments may satisfy 0.25<CA_L2/CA_L10<0.35.

$$1.2 < CA \_ L 1 / CA \_ L 2 < 1.5 \qquad [ Mathematical Equation 18 ]$$

In Mathematical Equation 18, CA_L1 is the effective aperture size of the first lens (101.201, 301, 401), and CA_L2 is the effective aperture size of the second lens (102, 202, 302, 402). When Mathematical Equation 18 is satisfied, the optical paths of light entering the optical system and light exiting the image sensor can be controlled, and the optical system can achieve good optical performance at the set field of view and focal length. Preferably, the first to fourth embodiments may satisfy the condition 1.2<CA_L1/CA_L2<1.35.

$$30 \% < CP\_ L 9 S 18 < 40 \% \qquad [ Mathematical Equation 19 ]$$

In Mathematical Equation 19, CP_L9S18 is the point where the critical point (Critical Point) of the sensor side 18th surface (S18) of the 9th lens (109, 209, 309, 409) is located within the effective radius. When Mathematica Equation 19 is satisfied, various aberrations occurring in the optical system can be corrected. Preferably, the first to fourth embodiments may satisfy the condition 30%<CP_L9S18<38%.

$$40 \% < CP\_ L 10 S 20 < 50 \% \qquad [ Mathematical Equation 20 ]$$

In Mathematical Equation 20, CP2_L10S20 is the point where the critical point (Critical Point) of the object side 20th surface (S20) of the 10th lens (110, 210, 310, 410) is located within the effective radius. When Mathematical Equation 20 is satisfied, various aberrations occurring in the optical system can be corrected. Preferably, the first to fourth embodiments may satisfy 40%<CP_L10S20<48%.

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} + … \qquad [ Mathematical Equation 21 ]$$

In Mathematical Equation 21, Z, as Sag, may represent the distance in the direction of the optical axis from an arbitrary position on the aspherical surface to the vertex of the aspherical surface. Y may represent the distance in the direction perpendicular to the optical axis from an arbitrary point on the aspherical surface to the optical axis. c may represent the curvature of the lens, and K may represent the conic constant. Additionally, A, B, C, D, E, and F may represent the aspheric constants.

Table 9 shows the results of the Mathematical Equations 1 to 20 described above in the optical system of the embodiment. Referring to Table 9, it can be seen that the optical system satisfies at least one, two or more, or three or more of the Mathematical Equations 1 to 20. In detail, the optical system according to the embodiment satisfies all of the Mathematical Equations 1 to 20. As a result, the optical system can achieve good optical performance in both the central and peripheral regions of the field of view (FOV) and exhibit excellent optical characteristics.

TABLE 9

| | | First | second | third | Fourth |
|---|---|---|---|---|---|
| Mathematical Equations | | embodiment | embodiment | embodiment | embodiment |
| 1 | 0.5 < TTL/ImgH * 2 < 0.9 | 0.74 | 0.74 | 0.74 | 0.74 |
| 2 | Fno < 2.4 | 2.2 | 2.2 | 2.2 | 2.2 |
| 3 | N1 < 1.6 | 1.55 | 1.55 | 1.55 | 1.55 |
| 4 | 0 < \|F10/F1\| < 0.5 | 0.021 | 0.029 | 0.229 | 0.026 |
| 5 | 5 < TTL < 6.5 | 6.05 | 6.06 | 6.1 | 6.075 |
| 6 | FOV > 65 | 73.7 | 72.8 | 70 | 73.6524 |
| 7 | 0 < CT1/CT2 < 1 | 0.659 | 0.673 | 0.888 | 0.659 |
| 8 | 1 < TTL/F < 2 | 1.284 | 1.297 | 1.337 | 1.274 |
| 9 | 4 < L10R1/CT10 < 8 | 5.283 | 5.413 | 6.22 | 5.233 |
| 10 | 1 < F/\|LIR1\| < 2 | 1.797 | 1.775 | 1.727 | 1.813 |
| 11 | 1 < F/ImgH < 5 | 1.148 | 1.139 | 1.112 | 1.163 |
| 12 | 30 < FOV/Fno < 40 | 33.5 | 33.090 | 31.818 | 33.478 |
| 13 | 1 < CT9/CT10 < 2 | 1.033 | 1.068 | 1.16 | 1.033 |
| 14 | 1 < ΣCT/ΣCG < 2.5 | 1.890 | 1.966 | 2.0564 | 1.9005 |
| 15 | 0.3 < CA_L2/ImgH < 0.8 | 0.770 | 0.510 | 0.491 | 0.491 |
| 16 | 0.2 < CA_L1/CA_L10 < 0.4 | 0.390 | 0.379 | 0.382 | 0.382 |
| 17 | 0.2 < CA_L2/CA_L10 < 0.4 | 0.301 | 0.293 | 0.287 | 0.287 |
| 18 | 1.2 < CA_L1/CA_L2 < 1.5 | 1.294 | 1.293 | 1.330 | 1.330 |
| 19 | 30% < CP_L9S18 < 40% | [symbol] | [symbol] | [symbol] | [symbol] |
| 20 | 40% < CP_L10S20 < 50% | [symbol] | [symbol] | [symbol] | [symbol] |

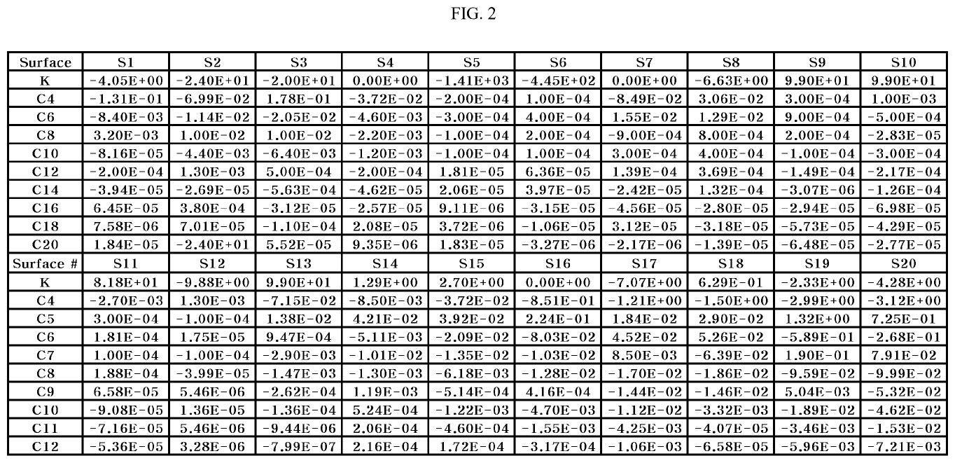

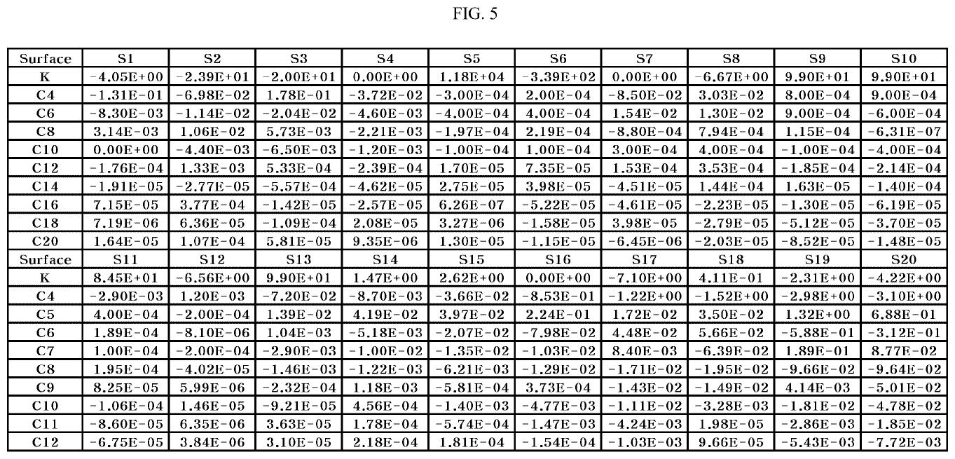

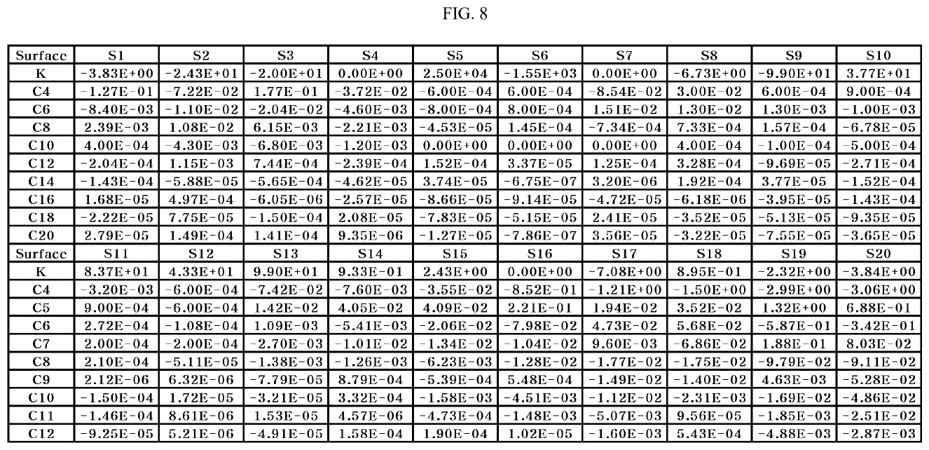

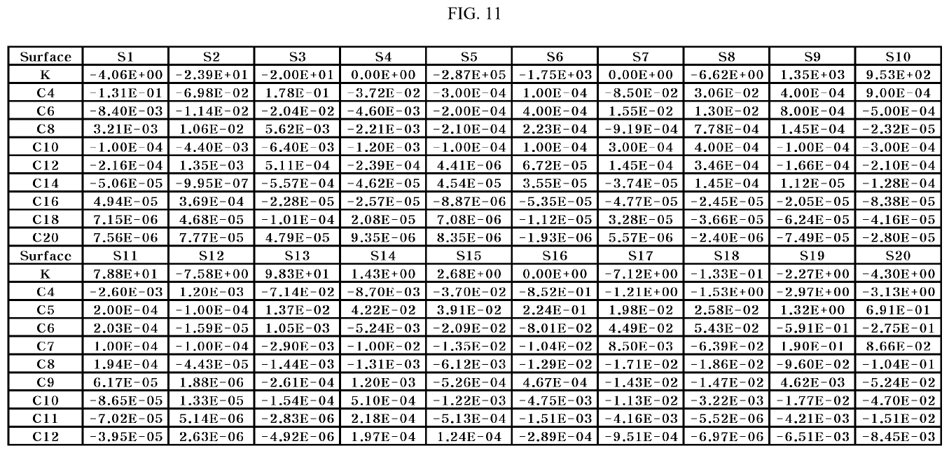

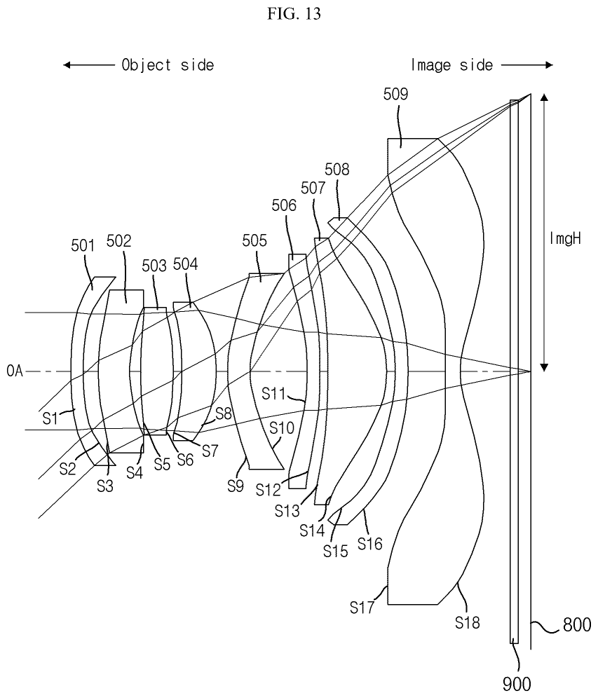

As described above, the camera module according to the first to fourth embodiments of the present invention has been described with reference to FIGS. 1 to 12. Hereinafter, the camera module according to the fifth to seventh embodiments of the present invention will be described with reference to FIGS. 13 to 30. The detailed description of the camera modules according to the fifth to seventh embodiments of the present invention is based on the detailed descriptions of the camera modules according to the first to fourth embodiments of the present invention, and the names, terms, and functions may be the same or different between the embodiments.

The following describes the configuration of the optical system according to the fifth embodiment of the present invention with reference to the drawings.

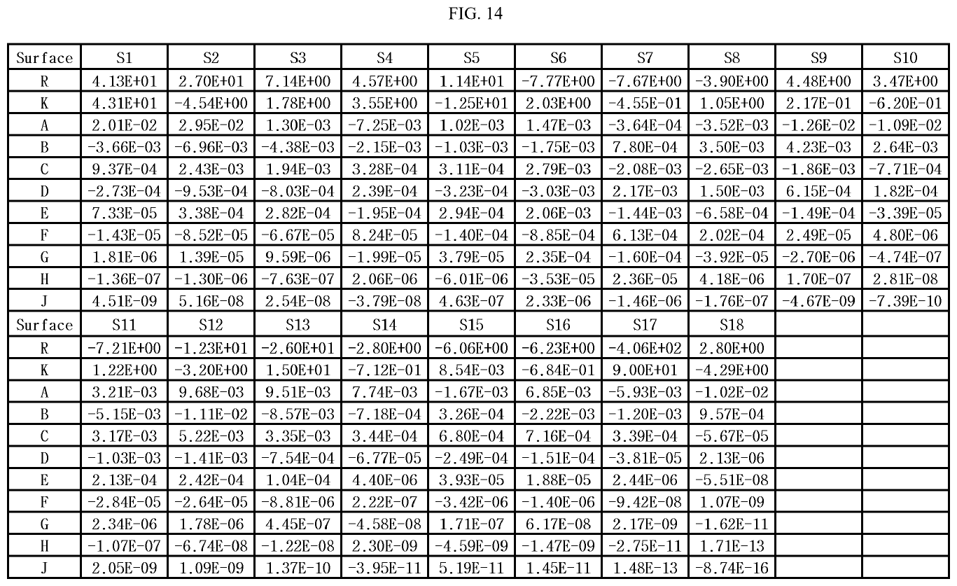

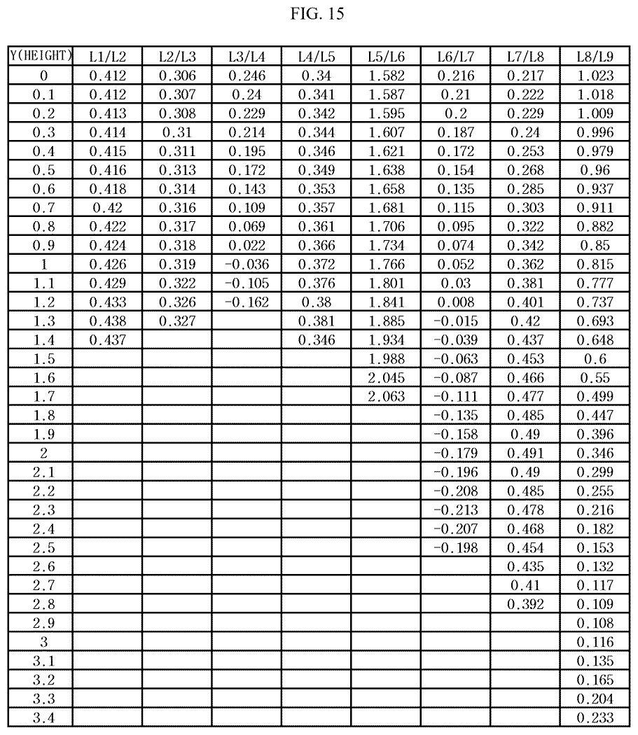

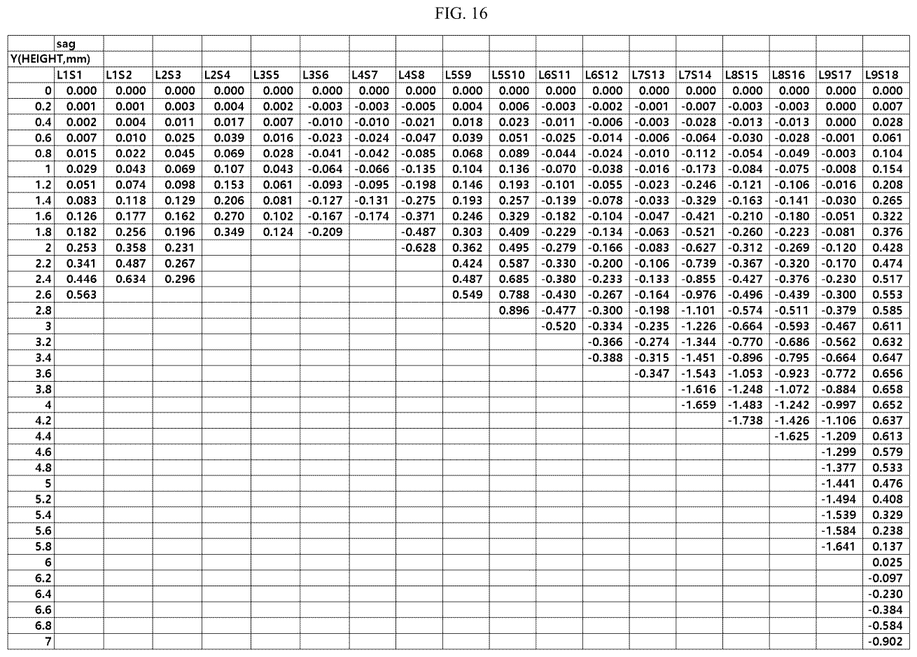

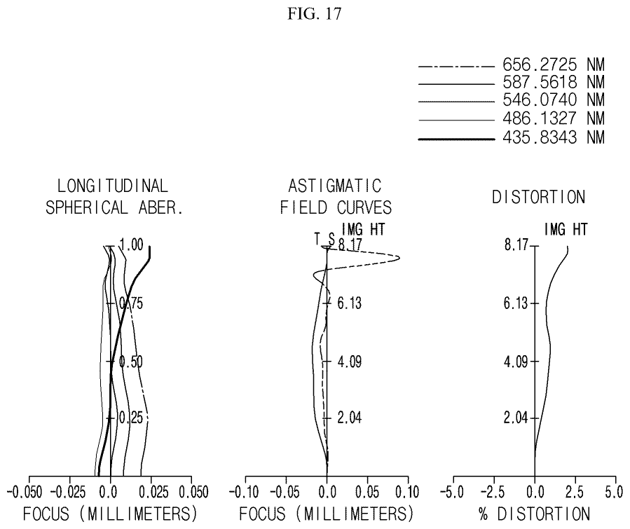

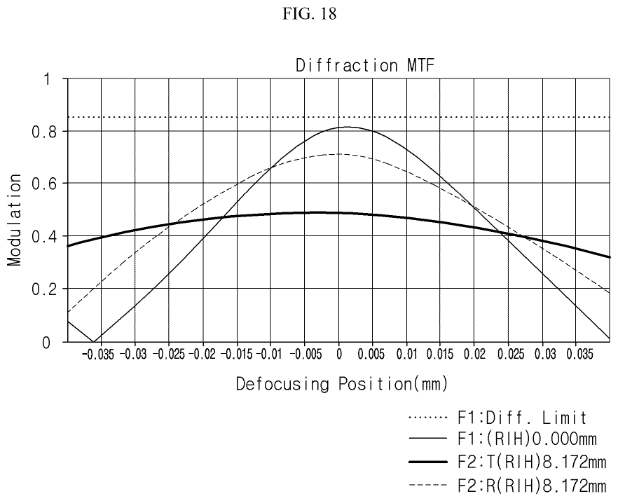

FIG. 13 is a side cross-sectional view of the optical system and a camera module having the same according to the fifth embodiment, FIG. 14 is a table showing the values of the aspheric coefficients of each lens surface and the conic constants (k) in the optical system according to the fifth embodiment, FIG. 15 is a table showing the thickness of each lens and the spacing between adjacent lenses in the optical system according to the fifth embodiment, FIG. 16 is a table showing the Sag values of each lens surface in the optical system according to the fifth embodiment, FIG. 17 is a graph showing data on the aberration characteristics of the optical system according to the fifth embodiment, and FIG. 18 is a graph showing data on the diffraction MTF (Modulation Transfer Function) of the optical system according to the fifth embodiment.

The optical system according to the fifth embodiment may include a lens unit, which may include a first lens (501) to a ninth lens (509). The first to ninth lenses (501, 502, 503, 504, 505, 506, 507, 508, 509) may be disposed sequentially along the optical axis (OA). Light corresponding to the information of the object may pass through the first lens (501) to the ninth lens (509) and the filter (900) and enter the image sensor (800).

The lens unit may be disposed, in order from the object side to the image side, as the first lens (501), the second lens (502), the third lens (503), the stop (STOP), the fourth lens (504), the fifth lens (505), the sixth lens (506), the seventh lens (507), the eighth lens (508), and the ninth lens (509).

In another embodiment, one or more additional lenses, plates, or optical members may be added between the first lens (501) and the ninth lens (509). Additionally, one or more additional lenses, plates, or optical members may be added in front of the first lens (501) or behind the ninth lens (509). Furthermore, one or more additional lenses, plates, or optical members may be added between the aperture (STOP) and the lens, between the lens and the filter (900), and between the filter (900) and the image sensor (800). In this case, the filter (900) may be a plate lens. The refractive power of the plate lens may be ‘0’. The refractive power of the flat lens may be zero. Additionally, a filter layer may be disposed between the aperture (STOP) and the lens, between the lens and the filter (900), and between the filter (900) and the image sensor (800). In this case, the filter layer may be coated to function as a filter.

The lens unit may include a first lens (501). The first lens (501) may be closest to the object side. The first lens (501) may be the first lens disposed on the object side. The first lens (501) may be the first lens adjacent to the object side. An additional lens may be disposed between the first lens (501) and the second lens (502). The second to eighth lenses (502, 503, 504, 505, 506, 507, 508) may be disposed between the first lens (501) and the ninth lens (509). Between the first lens (501) and the ninth lens (509), additional lenses other than the second to eighth lenses (502, 503, 504, 505, 506, 507, 508) may be disposed. At least two lenses may be additionally disposed between at least two of the first to ninth lenses (501, 502, 503, 504, 505, 506, 507, 508, 509).

The first lens (501) may have a negative (−) refractive power. The first lens (501) may have a convex meniscus shape on the object side. The first lens (501) may be formed convexly on the object side surface (S1). The first lens (501) may have the object side surface (S1) convexly formed relative to the optical axis. The first lens (501) may have the upper side surface (S2) concavely formed. The first lens (501) may have the upper side surface (S2) concavely formed relative to the optical axis. The first surface (S1) of the first lens (501) may be provided without any critical points from the optical axis (OA) to the end of the effective area. The second surface (S2) may be provided without at least one critical point from the optical axis (OA) to the end of the effective area.

The curvature radius of the object side surface (S1) of the first lens (501) may be positive. The curvature radius of the object side surface (S1) of the first lens (501) at the optical axis may be positive. The curvature radius of the upper side surface (S2) of the first lens (501) may be positive. The curvature radius of the upper side surface (S2) of the first lens (501) along the optical axis may be positive. The absolute value of the curvature radius of the object side surface (S1) of the first lens (501) may be greater than the absolute value of the curvature radius of the upper side surface (S2) of the first lens (501). The first lens (501) may be a solid lens. Both surfaces of the first lens (501) may be formed as aspherical surfaces. One of the two surfaces of the first lens (501) may be formed as a spherical surface, and the other surface may be formed as an aspherical surface.

The first lens (501) may satisfy the range 1.5<N1<1.6. Additionally, the first lens (501) may satisfy the range 1.52<N1<1.58. N1 is the refractive index of the first lens (501). The first lens (501) may satisfy the range 50<V1<60. Additionally, the first lens (501) may satisfy the range 52<V1<58. V1 is the Abbe number of the first lens (501).

The lens unit may include a second lens (502). The second lens (502) may be the second lens disposed from the object side. The second lens (502) may be the second lens adjacent to the object side. The second lens (502) may be disposed between the first lens (501) and the image side. The second lens (502) may be disposed between the first lens (501) and the third lens (503). An additional lens may be disposed between the second lens (502) and the first lens (501) or between the second lens (502) and the third lens (503).

The second lens (502) may have a negative (−) refractive power. The second lens (502) may have a convex meniscus shape on the object side. The second lens (502) may have a convex object side surface (S3). The second lens (502) may have a convex object side surface (S3) relative to the optical axis. The second lens (502) may have a concave upper side surface (S4). The second lens (502) may have the upper side surface (S4) concavely formed relative to the optical axis. The third surface (S3) of the second lens (502) may be provided without any critical points from the optical axis (OA) to the end of the effective area. The fourth surface (S4) may be provided without at least one critical point from the optical axis (OA) to the end of the effective area.

The curvature radius of the object side surface (S3) of the second lens (502) may be positive. The curvature radius of the object side surface (S3) of the second lens (502) at the optical axis may be positive. The curvature radius of the upper side surface (S4) of the second lens (502) may be negative. The curvature radius of the second lens (502) on the optical axis of the upper side surface (S4) may be negative. The absolute value of the curvature radius of the object side surface (S3) of the second lens (502) may be greater than the absolute value of the curvature radius of the upper side surface (S4) of the second lens (502). The second lens (502) may be a solid lens. Both surfaces of the second lens (502) may be formed as aspherical surfaces. One of the two surfaces of the second lens (502) may be formed as a spherical surface, and the other surface may be formed as an aspherical surface.

The second lens (502) may satisfy the range 1.6<N2<1.7. Additionally, the second lens (502) may satisfy the range 1.62<N2<1.65. N2 is the refractive index of the second lens (502). The second lens (502) may satisfy the range 20<V2<30. Additionally, the second lens (502) may satisfy the range 22<V2<25. V2 is the Abbe number of the second lens (502).

The lens unit may include a third lens (503). The third lens (503) may be the third lens disposed from the object side. The third lens (503) may be the third lens adjacent to the object side.

The third lens (503) may be disposed between the second lens (502) and the image side. The third lens (503) may be disposed between the second lens (502) and the fourth lens (504). An additional lens may be disposed between the third lens (503) and the second lens (502) or between the third lens (503) and the fourth lens (504).

The third lens (503) may have a positive (+) refractive power. The third lens (503) may be formed with both surfaces being convex. The third lens (503) may be formed with the object side surface (S5) being convex. The third lens (503) may have the object side surface (S5) convexly formed relative to the optical axis. The third lens (503) may have the upper side surface (S6) convexly formed. The third lens (503) may have the upper side surface (S6) convexly formed relative to the optical axis. The fifth surface (S5) of the third lens (503) may be provided without any critical points from the optical axis (OA) to the end of the effective area. The sixth surface (S6) may be provided without at least one critical point from the optical axis (OA) to the end of the effective area.

The curvature radius of the object side surface (S5) of the third lens (503) may be positive. The curvature radius of the object side surface (S5) of the third lens (503) at the optical axis may be positive. The curvature radius of the upper side surface (S6) of the third lens (503) may be negative. The curvature radius of the upper side surface (S6) of the third lens (503) relative to the optical axis may be negative. The absolute value of the curvature radius of the object side surface of the third lens (503) may be greater than the absolute value of the curvature radius of the upper side surface of the third lens (503). The third lens (503) may be a solid lens. Both surfaces of the third lens (503) may be formed as aspherical surfaces. One of the two surfaces of the third lens (503) may be formed as a spherical surface, and the other surface may be formed as an aspherical surface.

The third lens (503) may satisfy the range 1.5<N3<1.6. Additionally, the third lens (503) may satisfy the range 1.52<N3<1.58. N3 is the refractive index of the third lens (503). The third lens (503) may satisfy the range 50<V3<60. Additionally, the third lens (503) may satisfy the range 52<V3<58. V3 is the Abbe number of the third lens (503).

The lens unit may include a fourth lens (504). The fourth lens (504) may be the fourth lens disposed from the object side. The fourth lens (504) may be the sixth lens disposed from the image side. The fourth lens (504) may be disposed between the third lens (503) and the image side. The fourth lens (504) may be disposed between the third lens (503) and the fifth lens (505). An additional lens may be disposed between the fourth lens (504) and the third lens (503) or between the fourth lens (504) and the fifth lens (505).

The fourth lens (504) may have a positive (+) refractive power. The fourth lens (504) may have a convex meniscus shape on the upper side. The fourth lens (504) may have an object side surface (S7) formed concavely. The fourth lens (504) may have the object side surface (S7) formed concavely relative to the optical axis. The fourth lens (504) may have an upper side surface (S8) formed convexly. The fourth lens (504) may have an upper side surface (S8) that is convex relative to the optical axis. The seventh surface(S) of the fourth lens (504) may extend to the end of the effective area without any critical points relative to the optical axis (OA). The eighth surface (S8) may extend to the end of the effective area without at least one critical point relative to the optical axis (OA).

The curvature radius of the object side surface (S7) of the fourth lens (504) may be negative. The curvature radius of the object side surface (S7) of the fourth lens (504) at the optical axis may be negative. The curvature radius of the upper side surface (S8) of the fourth lens (504) may be negative. The curvature radius of the fourth lens (504) on the optical axis of the upper side surface (S8) may be negative. The absolute value of the curvature radius of the object side surface (S7) of the fourth lens (504) may be greater than the absolute value of the curvature radius of the upper side surface (S8) of the fourth lens (504). The fourth lens (504) may be a solid lens. Both surfaces of the fourth lens (504) may be formed as aspherical surfaces. One of the two surfaces of the fourth lens (504) may be formed as a spherical surface, and the other surface may be formed as an aspherical surface.

The fourth lens (504) may satisfy the range 1.5<N4<1.6. Additionally, the fourth lens (504) may satisfy the range 1.52<N4<1.58. N4 is the refractive index of the fourth lens (504). The fourth lens (504) may satisfy the range 50<V4<60. Additionally, the fourth lens (504) may satisfy the range 52<V4<58. V4 is the Abbe number of the fourth lens (504).

The lens unit may include a fifth lens (505). The fifth lens (505) may be the fifth lens disposed from the object side. The fifth lens (505) may be the fifth lens disposed from the image side. The fifth lens (505) may be disposed between the fourth lens (504) and the image side. The fifth lens (505) may be disposed between the fourth lens (504) and the sixth lens (506). An additional lens may be disposed between the fifth lens (505) and the fourth lens (504) or between the fifth lens (505) and the sixth lens (506).

The fifth lens (505) may have a negative (−) refractive power. The fifth lens (505) may have a convex meniscus shape on the object side. The fifth lens (505) may have the object side surface (S9) formed convexly. The fifth lens (505) may have the object side surface (S9) convexly formed relative to the optical axis. The fifth lens (505) may have the upper side surface (S10) concavely formed. The fifth lens (505) may have the upper side surface (S10) concavely formed relative to the optical axis. The ninth surface (S9) of the fifth lens (505) may be provided without any critical points from the optical axis (OA) to the end of the effective area. The tenth surface (S10) may be provided without at least one critical point from the optical axis (OA) to the end of the effective area.

The curvature radius of the object side surface (S9) of the fifth lens (505) may be positive. The curvature radius of the object side surface (S9) of the fifth lens (505) at the optical axis may be positive. The curvature radius of the upper side surface (S10) of the fifth lens (505) may be positive. The curvature radius of the upper side surface (S10) of the fifth lens (505) along the optical axis may be positive. The absolute value of the curvature radius of the object side surface (S9) of the fifth lens (505) may be greater than the absolute value of the curvature radius of the upper side surface (S10) of the fifth lens (505). The fifth lens (505) may be a solid lens. Both surfaces of the fifth lens (505) may be formed as aspherical surfaces. One of the two surfaces of the fifth lens (505) may be formed as a spherical surface, and the other surface may be formed as an aspherical surface.

The fifth lens (505) may satisfy the range 1.6<N5<1.7. Additionally, the fifth lens (505) may satisfy the range 1.62<N5<1.65. N5 is the refractive index of the fifth lens (505). The fifth lens (505) may satisfy the range 20<V5<30. Additionally, the fifth lens (505) may satisfy the range 20<V5<25. V5 is the Abbe number of the fifth lens (505).

The lens unit may include a sixth lens (506). The sixth lens (506) may be the sixth lens disposed from the object side. The sixth lens (506) may be the fourth lens disposed from the image side. The sixth lens (506) may be disposed between the fifth lens (505) and the seventh lens (507). The sixth lens (506) may be disposed between the fifth lens (505) and the image side. An additional lens may be disposed between the sixth lens (506) and the fifth lens (505) or between the sixth lens (506) and the seventh lens (507).

The sixth lens (506) may have a negative (−) refractive power. The sixth lens (506) may have a convex meniscus shape on the image side. The sixth lens (506) may have the object side surface (S11) formed concavely. The sixth lens (506) may have the object side surface (S11) concave relative to the optical axis. The sixth lens (506) may have the upper side surface (S12) convex. The sixth lens (506) may have the upper side surface (S12) convex relative to the optical axis. The eleventh surface (S11) of the sixth lens (506) may be provided without any critical points from the optical axis (OA) to the end of the effective area. The twelfth surface (S12) may be provided without at least one critical point from the optical axis (OA) to the end of the effective area.

The curvature radius of the object side surface (S11) of the sixth lens (506) may be negative. The curvature radius of the object side surface (S11) of the sixth lens (506) at the optical axis may be negative. The curvature radius of the upper side surface (S12) of the sixth lens (506) may be negative. The curvature radius of the upper side surface (S12) of the sixth lens (506) along the optical axis may be negative. The absolute value of the curvature radius of the object side surface of the sixth lens (506) may be smaller than the absolute value of the curvature radius of the upper side surface of the sixth lens (506). The sixth lens (506) may be a solid lens. Both surfaces of the sixth lens (506) may be formed as aspherical surfaces. One of the two surfaces of the sixth lens (506) may be formed as a spherical surface, and the other surface may be formed as an aspherical surface.

The sixth lens (506) may satisfy the range 1.6<N6<1.7. Additionally, the sixth lens (506) may satisfy the range 1.62<N6<1.65. N6 is the refractive index of the sixth lens (506). The sixth lens (506) may satisfy the range 20<V6<30. Additionally, the sixth lens (506) may satisfy the range 20<V6<25. V6 is the Abbe number of the sixth lens (506).

The lens unit may include a seventh lens (507). The seventh lens (507) may be the seventh lens disposed from the object side. The seventh lens (507) may be the third lens disposed from the image side. The seventh lens (507) may be disposed between the sixth lens (506) and the eighth lens (508). The seventh lens (507) may be disposed between the sixth lens (506) and the image side. An additional lens may be disposed between the seventh lens (507) and the sixth lens (506) or between the seventh lens (507) and the eighth lens (508).

The seventh lens (507) may have a positive (+) refractive power. The seventh lens (507) may have a convex meniscus shape on the upper side. The seventh lens (507) may have an object side surface (S13) formed concavely. The seventh lens (507) may have the object side surface (S13) formed concavely relative to the optical axis. The seventh lens (507) may have an upper side surface (S14) formed convexly. The seventh lens (507) may have the upper side surface (S14) convexly formed relative to the optical axis. The object side surface or upper side surface of the seventh lens (507) may include at least one inflection point.

The curvature radius of the object side surface (S13) of the seventh lens (507) may be negative. The curvature radius of the object side surface (S13) of the seventh lens (507) relative to the optical axis may be negative. The curvature radius of the upper side surface (S14) of the seventh lens (507) may be negative. The curvature radius of the upper side surface (S14) of the seventh lens (507) along the optical axis may be negative. The absolute value of the curvature radius of the object side surface of the seventh lens (507) may be greater than the absolute value of the curvature radius of the upper side surface of the seventh lens (507). The seventh lens (507) may be a solid lens. Both surfaces of the seventh lens (507) may be formed as aspherical surfaces. One of the two surfaces of the seventh lens (507) may be formed as a spherical surface, and the other surface may be formed as an aspherical surface. The thirteenth surface (S13) of the seventh lens (507) may be provided without any critical points from the optical axis (OA) to the end of the effective area. The 14th surface (S14) may be provided without at least one critical point from the optical axis (OA) to the end of the effective area.

The seventh lens (507) may satisfy the range 1.5<N7<1.6. Additionally, the seventh lens (507) may satisfy the range 1.52<N7<1.58. N7 is the refractive index of the seventh lens (507). The seventh lens (507) may satisfy the range 50<V7<60. Additionally, the seventh lens (507) may satisfy the range 52<V7<58. V6 is the Abbe number of the seventh lens (507).

The lens unit may include an eighth lens (508). The eighth lens (508) may be the eighth lens disposed from the object side. The eighth lens (508) may be the second lens disposed from the image side. The eighth lens (508) may be disposed between the seventh lens (507) and the ninth lens (509). The eighth lens (508) may be disposed between the seventh lens (507) and the image side. An additional lens may be disposed between the eighth lens (508) and the seventh lens (507) or between the eighth lens (508) and the ninth lens (509).

The eighth lens (508) may have a negative (−) refractive power. The eighth lens (508) may have a convex meniscus shape on the upper side. The eighth lens (508) may have the object side surface (S15) concavely formed. The eighth lens (508) may have the object side surface (S15) concave relative to the optical axis. The eighth lens (508) may have the upper side surface (S16) convex. The eighth lens (508) may have the upper side surface (S16) convex relative to the optical axis. The 15th surface (S15) of the 8th lens (508) may be provided without any critical points from the optical axis (OA) to the end of the effective area. The 16th surface (S16) may be provided without at least one critical point from the optical axis (OA) to the end of the effective area.

The curvature radius of the object side surface (S15) of the eighth lens (508) may be negative. The curvature radius of the object side surface (S16) of the eighth lens (508) at the optical axis may be negative. The curvature radius of the upper side surface (S16) of the eighth lens (508) may be negative. The curvature radius of the upper side surface (S16) of the eighth lens (508) along the optical axis may be negative. The value of the curvature radius of the object side surface of the eighth lens (508) may be greater than the value of the curvature radius of the upper side surface of the eighth lens (508). The eighth lens (508) may be a solid lens. Both surfaces of the eighth lens (508) may be formed as aspherical surfaces. One of the two surfaces of the eighth lens (508) may be formed as a spherical surface, and the other surface may be formed as an aspherical surface.

The eighth lens (508) may satisfy the range 1.5<N8<1.6. Additionally, the eighth lens (508) may satisfy the range 1.52<N8<1.58. N8 is the refractive index of the eighth lens (508). The eighth lens (508) may satisfy the range 50<V8<60. Additionally, the eighth lens (508) may satisfy the range 52<V8<58. V8 is the Abbe number of the eighth lens (508).

The lens unit may include a ninth lens (509). The ninth lens (509) may be the lens most adjacent to the image side. The ninth lens (509) may be disposed between the eighth lens (508) and the image side. An additional lens may be disposed between the ninth lens (509) and the eighth lens (508) or between the ninth lens (509) and the filter (900).

The ninth lens (509) may have a negative (−) refractive power. The ninth lens (509) may have a concave shape on both sides. The ninth lens (509) may have an object side surface (S17) formed concavely. The ninth lens (509) may have an object side surface (S17) formed concavely relative to the optical axis. The ninth lens (509) may have an upper side surface (S18) formed concavely. The ninth lens (509) may have an upper side surface (S18) formed concavely relative to the optical axis. The object side surface or upper side surface of the ninth lens (509) may include at least one inflection point.

The object side surface (S17) and upper side surface (S18) of the ninth lens (509) may have a point where the slope angle is the same in the 75-80% area of the effective diameter. The object side surface (S17) and upper side surface (S18) of the ninth lens (509) may have tangent lines that are parallel to each other at a point within the 75-80% area of the effective diameter. This minimizes specular reflection by aligning the specular reflection path and the normal path. The curvature radius of the object side surface (S17) of the ninth lens (509) may be negative. The curvature radius of the object side surface (S17) of the ninth lens (509) along the optical axis may be negative. The curvature radius of the upper side surface (S18) of the ninth lens (509) may be positive. The curvature radius of the upper side surface (S18) of the ninth lens (509) along the optical axis may be positive. The value of the curvature radius of the object side surface of the ninth lens (509) may be greater than the value of the curvature radius of the upper side surface of the ninth lens (509). The ninth lens (509) may be a solid lens. Both surfaces of the ninth lens (509) may be formed as aspherical surfaces. One of the two surfaces of the ninth lens (509) may be formed as a spherical surface, and the other surface may be formed as an aspherical surface. The ninth lens (509) may have a surface including one or more inflection points.

The 17th surface (S17) of the 9th lens (509) may be provided without a critical point from the optical axis (OA) to the end of the effective area. The 18th surface (S18) of the 9th lens (509) may have a critical point from the optical axis (OA) to the end of the effective area. If the 18th surface (S18) has a critical point, it may be located within the range of 50% to 60% of the effective radius (r92) from the optical axis (OA), preferably within the range of 54% to 57%. The critical point of the 18th surface (S18) may be located within a range of 3.5 mm to 4.2 mm from the optical axis (OA), preferably within a range of 3.8 mm to 4 mm.

The ninth lens (509) may satisfy the range 1.5<N9<1.6. Additionally, the ninth lens (509) may satisfy the range 1.52<N9<1.58. N9 is the refractive index of the ninth lens (509). The ninth lens (509) may satisfy the range of 50<V9<60. Additionally, the ninth lens (509) may satisfy the range of 52<V9<58. V9 is the Abbe number of the ninth lens (509).

The lens unit may include an aperture (STOP). The aperture can control the amount of light entering the optical system. In lenses placed between the object and the aperture, the effective diameter of the lens surface tends to increase as the distance from the object to the aperture increases. For the lens surfaces disposed between the aperture and the sensor, there is a tendency for the effective diameter of the lens surfaces to decrease as they move from the aperture toward the sensor. The fact that there is a tendency for the effective diameter of the lens surfaces to increase or decrease does not mean that the effective diameter of the lens surfaces only increases or decreases. For example, it also includes cases where the effective diameter of the lens surfaces increases and then decreases as they move from the aperture toward the sensor.

The aperture (STOP) may be disposed between the third lens (503) and the fourth lens (504). The aperture (STOP) may be disposed closer to the fourth lens (504) than to the third lens (503). The aperture (STOP) may be spaced apart from the object side surface of the third lens (503). The aperture (STOP) can regulate the amount of light entering from the subject. The aperture (STOP) can regulate the amount of light passing through the third lens (503). The aperture (STOP) can regulate the amount of light entering the fourth lens (504). The aperture (STOP) may include an aperture stop.

The optical system or camera module may include a filter (900). The filter (900) may be disposed between the lens closest to the sensor side among the lenses of the lens unit (100) and the image sensor (800). For example, the filter (900) may be disposed between the nth lens and the image sensor (800).

The cover glass may be disposed between the filter (900) and the image sensor (800), protecting the upper part of the image sensor (800) and preventing a decrease in the reliability of the image sensor (800). The cover glass may be removable. The cover glass may be a protective glass.

The filter (900) may include an infrared filter or an infrared cut-off filter (IR cut-off). The filter (900) may transmit light within a set wavelength band and filter out light from other wavelength bands. When the filter (900) includes an infrared filter, it can block radiant heat emitted from external light from being transmitted to the image sensor (800). Additionally, the filter (900) can transmit visible light and reflect infrared light.

The following describes the concept of the diagonal field of view (DFOV) of an imaging lens according to the present embodiment.

An imaging lens may have a field of view (FOV) of 70° or more. In this case, the field of view (FOV) may be the diagonal field of view (DFOV). The diagonal field of view (DFOV) may be distinguished from the horizontal field of view (HFOV) and the vertical field of view (VFOV). For example, the horizontal field of view (HFOV) can be 0.8 times the diagonal field of view (DFOV). Additionally, the field of view (FOV) may be distinguished from the half field of view (HFOV). The field of view (FOV) refers to the diameter of an imaginary circle connecting the four corners of an image sensor, while the horizontal field of view (HFOV) may refer to the radius of the aforementioned imaginary circle. In other words, the field of view (FOV) may be twice the horizontal field of view (HFOV).

The diagonal field of view (DFOV) may be calculated using the following mathematical equation.

$$DFOV = 2 * arctan ( ImgH / F ) \qquad [ Mathematical Equation ]$$

Here, ImgH*2 refers to the diagonal length of the effective area of the image sensor (800), and F refers to the effective focal length of the entire optical system.

TABLE 10

| | | | | | | Semi | Focal |
|---|---|---|---|---|---|---|---|
| Lens | Surface | Radius | Thickness | nd | vd | Aperture | length |
| 1 | S1 | 41.279 | 0.360 | 1.540 | 56.000 | 2.766 | −143.443 |
| | S2 | 26.967 | 0.411 | | | 2.450 | |
| 2 | S3 | 7.145 | 0.865 | 1.634 | 23.900 | 2.411 | −22.740 |
| | S4 | 4.569 | 0.706 | | | 1.902 | |
| 3 | S5 | 11.446 | 0.932 | 1.540 | 56.000 | 1.881 | 8.604 |
| | S6 | −7.766 | 0.248 | | | 1.771 | |
| 4 | S7(Stop) | −7.672 | 0.946 | 1.540 | 56.000 | 1.738 | 13.707 |
| | S8 | −3.899 | 0.340 | | | 2.022 | |
| 5 | S9 | 4.479 | 0.644 | 1.649 | 21.900 | 2.753 | −31.560 |
| | S10 | 3.474 | 1.580 | | | 2.873 | |
| 6 | S11 | −7.212 | 0.360 | 1.649 | 21.900 | 3.006 | −27.138 |
| | S12 | −12.339 | 0.218 | | | 3.440 | |
| 7 | S13 | −26.004 | 1.665 | 1.537 | 56.000 | 3.665 | 5.689 |
| | S14 | −2.799 | 0.215 | | | 3.917 | |
| 8 | S15 | −6.057 | 0.404 | 1.540 | 56.000 | 4.138 | −2250.180 |
| | S16 | −6.230 | 1.025 | | | 4.51 | |
| 9 | S17 | −406.098 | 0.419 | 1.537 | 56.000 | 5.77 | −5.173 |
| | S18 | 2.802 | 1.399 | | | 6.840 | |
| Filter | S19 | Infinity | 0.210 | | | 7.918 | |
| | S20 | Infinity | 0.352 | | | 7.986 | |
| | Image | Infinity | 0.000 | | | 8.173 | |

Table 10 shows the surface number (Surface), curvature radius (Radius), center thickness of each lens or distance between lens surfaces (Thickness), refractive index (Index, nd), Abbe number (Abbe, vd), effective radius (Semi Aperture), and focal length (Focal length) of the lens according to the fifth embodiment of the present invention. Here, the units for curvature radius and thickness or distance may be mm.

TABLE 11

| | Fifth | | Fifth |
|---|---|---|---|
| | embodiment | | embodiment |
| TTL | 12.9000 | ET1 | 0.3633 |
| SD(Stop~L9S2) | 9.2150 | ET2 | 0.9672 |
| TD(LIS1~L9S2) | 12.3377 | ET3 | 0.5952 |
| F | 7.9872 | ET4 | 0.5073 |
| F_LG1 | 15.70031 | ET5 | 0.9839 |
| F_LG2 | 22.3233 | ET6 | 0.9002 |
| Fno | 2.3288 | ET7 | 0.3728 |
| ImgH | 8.1727 | ET8 | 0.3166 |
| HFOV | 39.0600 | ET9 | 1.4164 |
| EPD | 3.4297 | | |
| BFL | 1.9613 | | |

Table 11 shows the characteristics of the optical system according to the fifth embodiment of the present invention.

TTL means the optical axis distance from the object side surface vertex of the first lens (501) to the image surface, SD means the optical axis distance from the aperture (STOP) to the upper side surface of the ninth lens (509), TD denotes the optical axis distance from the object-side surface vertex of the first lens (501) to the upper side surface of the ninth lens (509), F denotes the total focal length, F_LG1 denotes the composite focal length of the first lens (501) to the third lens (503) located on the object-side direction of the aperture (STOP), F_LG2 denotes the composite focal length of the fourth lens (504) to the ninth lens (509) located on the image side of the aperture (STOP), Fno denotes the ratio of the focal length to the effective diameter of the lens, ImgH denotes the distance from the optical axis (OA) to the diagonal end of the image sensor (800) or half of the maximum diagonal length, HFOV denotes the diagonal field of view of the optical system, EPD denotes the diameter of the entrance pupil (effective aperture), BFL denotes the optical axis distance from the upper side surface of the ninth lens (509) to the image surface, ET1 to ET9 denote the thickness of the edge region of each lens.

The configuration of the optical system according to the sixth embodiment of the present invention will be described below with reference to the drawings.

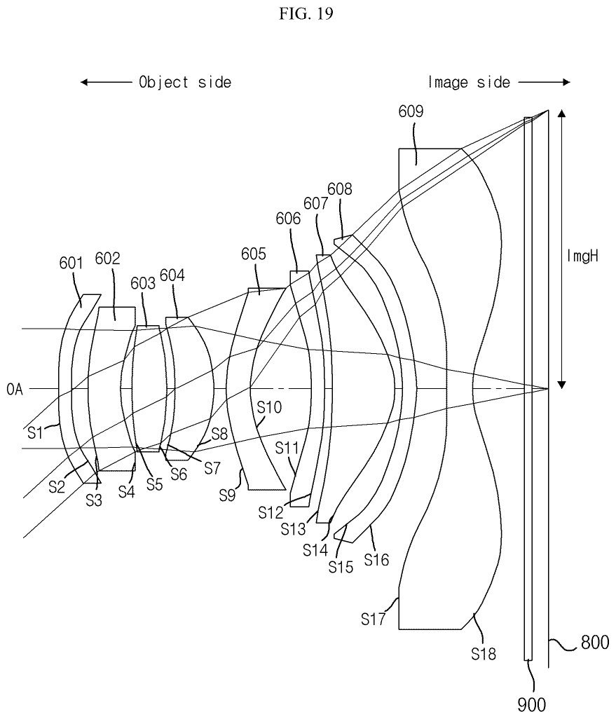

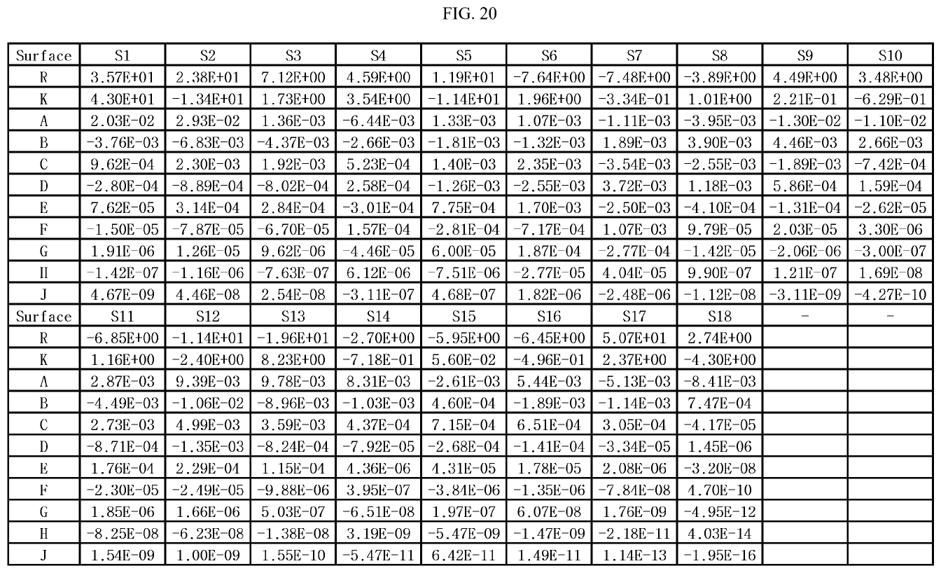

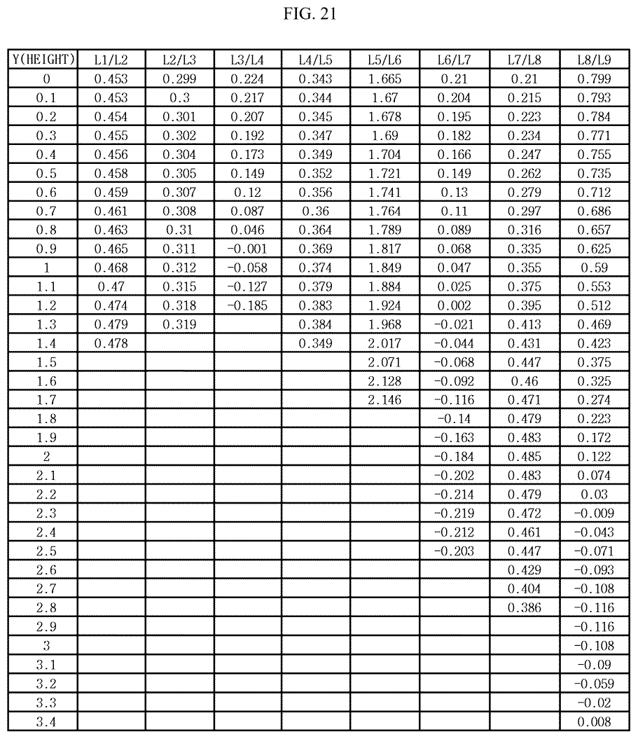

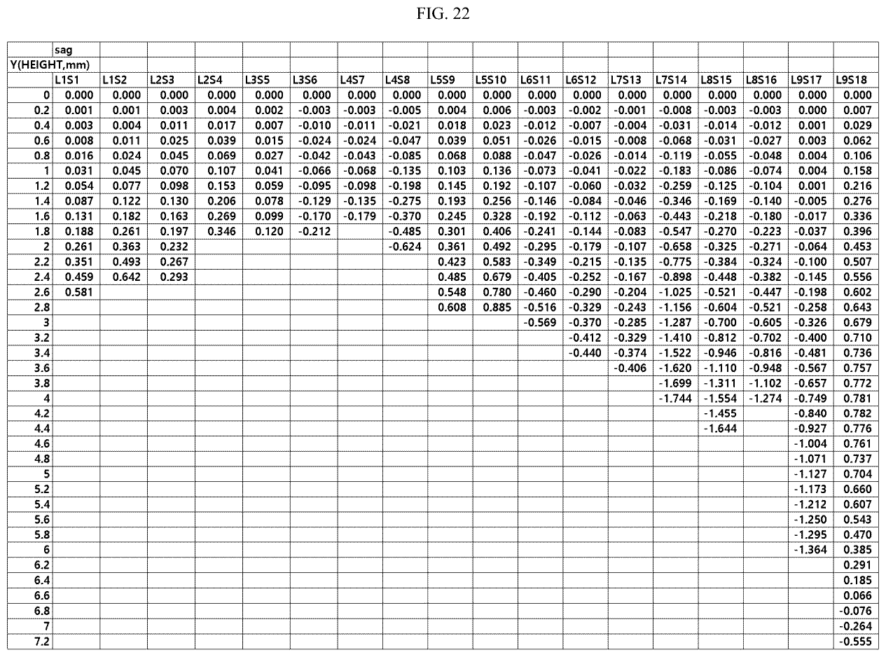

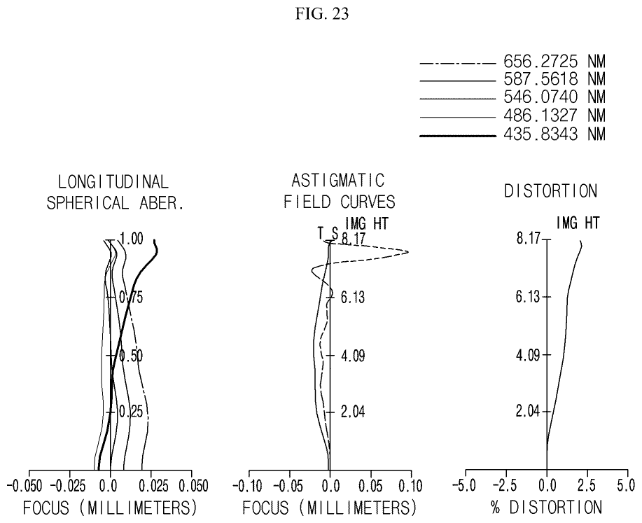

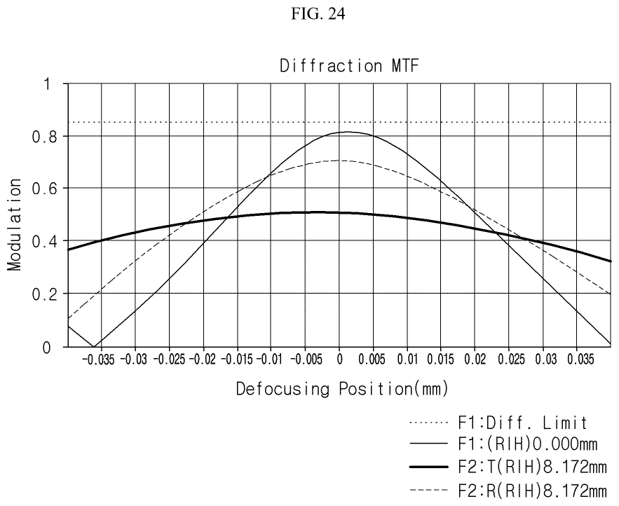

FIG. 19 is a side cross-sectional view of the optical system and a camera module having the same according to the sixth embodiment, FIG. 20 is a table showing the values of the aspheric coefficients of each lens surface and the conic constants (k) in the optical system according to the sixth embodiment, FIG. 21 is a table showing the thickness of each lens and the spacing between adjacent lenses in the optical system according to the sixth embodiment, FIG. 22 is a table showing the Sag values of each lens surface in the optical system according to the sixth embodiment, FIG. 23 is a graph showing data on the aberration characteristics of the optical system according to the sixth embodiment, and FIG. 24 is a graph showing data on the diffraction MTF (Modulation Transfer Function) of the optical system according to the sixth embodiment.

The optical system according to the sixth embodiment may include a lens unit, which may include a first lens (601) to a ninth lens (609). The first to ninth lenses (601, 602, 603, 604, 605, 606, 607, 608, 609) may be disposed sequentially along the optical axis (OA). Light corresponding to the information of the object may pass through the first lens (601) to the ninth lens (609) and the filter (900) and enter the image sensor (800).

The lens unit may be disposed, in order from the object side to the image side, as the first lens (601), the second lens (602), the third lens (603), the stop (STOP), the fourth lens (604), the fifth lens (605), the sixth lens (606), the seventh lens (607), the eighth lens (608), and the ninth lens (609).

In another embodiment, one or more additional lenses, plates, or optical components may be added between the first lens (601) and the ninth lens (609). Additionally, one or more additional lenses, plates, or optical components may be added in front of the first lens (601) or behind the ninth lens (609). Furthermore, one or more additional lenses, plates, or optical components may be added between the aperture (STOP) and the lens, between the lens and the filter (900), and between the filter (900) and the image sensor (800). In this case, the filter (900) may be a plate lens. The refractive power of the plate lens may be ‘0’. The refractive power of the flat lens may be zero. Additionally, a filter layer may be disposed between the aperture (STOP) and the lens, between the lens and the filter (900), and between the filter (900) and the image sensor (800). In this case, the filter layer may be coated to function as a filter.

The lens unit may include a first lens (601). The first lens (601) may be closest to the object side. The first lens (601) may be the first lens disposed on the object side. The first lens (601) may be the first lens adjacent to the object side. An additional lens may be disposed between the first lens (601) and the second lens (602). The second to eighth lenses (602, 603, 604, 605, 606, 607, 608) may be disposed between the first lens (601) and the ninth lens (609). Additional lenses other than the second to eighth lenses (602, 603, 604, 605, 606, 607, 608) may be disposed between the first lens (601) and the ninth lens (609). At least two lenses may be additionally arranged between at least two of the first to ninth lenses (601, 602, 603, 604, 605, 606, 607, 608, 609).

The first lens (601) may have a negative (−) refractive power. The first lens (601) may have a convex meniscus shape on the object side. The first lens (601) may have the object side surface (S1) formed convexly. The first lens (601) may have the object side surface (S1) convexly formed relative to the optical axis. The first lens (601) may have the upper side surface (S2) concavely formed. The first lens (601) may have the upper side surface (S2) concavely formed relative to the optical axis. The first surface (S1) of the first lens (601) may be provided without any critical points from the optical axis (OA) to the end of the effective area. The second surface (S2) may be provided without at least one critical point from the optical axis (OA) to the end of the effective area.

The curvature radius of the object side surface (S1) of the first lens (601) may be positive. The curvature radius of the object side surface (S1) of the first lens (601) at the optical axis may be positive. The curvature radius of the upper side surface (S2) of the first lens (601) may be positive. The curvature radius of the upper side surface (S2) of the first lens (601) along the optical axis may be positive. The absolute value of the curvature radius of the object side surface (S1) of the first lens (601) may be greater than the absolute value of the curvature radius of the upper side surface (S2) of the first lens (601). The first lens (601) may be a solid lens. Both surfaces of the first lens (601) may be formed as aspherical surfaces. One of the two surfaces of the first lens (601) may be formed as a spherical surface, and the other surface may be formed as an aspherical surface.

The first lens (601) may satisfy the range 1.5<N1<1.6. Additionally, the first lens (601) may satisfy the range 1.52<N1<1.58. N1 is the refractive index of the first lens (601). The first lens (601) may satisfy the range 50<V1<60. Additionally, the first lens (601) may satisfy the range 52<V1<58. V1 is the Abbe number of the first lens (601).

The lens unit may include a second lens (602). The second lens (602) may be the second lens disposed on the object side. The second lens (602) may be the second lens adjacent to the object side. The second lens (602) may be disposed between the first lens (601) and the image side. The second lens (602) may be disposed between the first lens (601) and the third lens (603). An additional lens may be disposed between the second lens (602) and the first lens (601) or between the second lens (602) and the third lens (603).

The second lens (602) may have a negative (−) refractive power. The second lens (602) may have a convex meniscus shape on the object side. The second lens (602) may have a convex object side surface (S3). The second lens (602) may have a convex object side surface (S3) relative to the optical axis. The second lens (602) may have a concave upper side surface (S4). The second lens (602) may have the upper side surface (S4) concavely formed relative to the optical axis. The third surface (S3) of the second lens (602) may be provided without any critical points from the optical axis (OA) to the end of the effective area. The fourth surface (S4) may be provided without at least one critical point from the optical axis (OA) to the end of the effective area.

The curvature radius of the object side surface (S3) of the second lens (602) may be positive. The curvature radius of the object side surface (S3) of the second lens (602) at the optical axis may be positive. The curvature radius of the upper side surface (S4) of the second lens (602) may be negative. The curvature radius of the second lens (602) on the optical axis of the upper side surface (S4) may be negative. The absolute value of the curvature radius of the object side surface (S3) of the second lens (602) may be greater than the absolute value of the curvature radius of the upper side surface (S4) of the second lens (602). The second lens (602) may be a solid lens. Both surfaces of the second lens (602) may be formed as aspherical surfaces. One of the two surfaces of the second lens (602) may be formed as a spherical surface, and the other surface may be formed as an aspherical surface.

The second lens (602) may satisfy the range 1.6<N2<1.7. Additionally, the second lens (602) may satisfy the range 1.62<N2<1.65. N2 is the refractive index of the second lens (602). The second lens (602) may satisfy the range 20<V2<30. Additionally, the second lens (602) may satisfy the range 22<V2<25. V2 is the Abbe number of the second lens (602).

The lens unit may include a third lens (603). The third lens (603) may be the third lens disposed from the object side. The third lens (603) may be the third lens adjacent to the object side. The third lens (603) may be disposed between the second lens (602) and the image side. The third lens (603) may be disposed between the second lens (602) and the fourth lens (604). An additional lens may be disposed between the third lens (603) and the second lens (602) or between the third lens (603) and the fourth lens (604).

The third lens (603) may have a positive (+) refractive power. The third lens (603) may be formed with both surfaces convex. The third lens (603) may be formed with the object side surface (S5) convex. The third lens (603) may have the object side surface (S5) convexly formed relative to the optical axis. The third lens (603) may have the upper side surface (S6) convexly formed. The third lens (603) may have the upper side surface (S6) convexly formed relative to the optical axis. The fifth surface (S5) of the third lens (603) may be provided without any critical points from the optical axis (OA) to the end of the effective area. The sixth surface (S6) may be provided without at least one critical point from the optical axis (OA) to the end of the effective area.

The curvature radius of the object side surface (S5) of the third lens (603) may be positive. The curvature radius of the object side surface (S5) of the third lens (603) at the optical axis may be positive. The curvature radius of the upper side surface (S6) of the third lens (603) may be negative. The curvature radius of the upper side surface (S6) of the third lens (603) along the optical axis may be negative. The absolute value of the curvature radius of the object side surface of the third lens (603) may be greater than the absolute value of the curvature radius of the upper side surface of the third lens (603). The third lens (603) may be a solid lens. Both surfaces of the third lens (603) may be formed as aspherical surfaces. One of the two surfaces of the third lens (603) may be formed as a spherical surface, and the other surface may be formed as an aspherical surface.

The third lens (603) may satisfy the range 1.5<N3<1.6. Additionally, the third lens (603) may satisfy the range 1.52<N3<1.58. N3 is the refractive index of the third lens (603).

The third lens (603) may satisfy the range 50<V3<60. Additionally, the third lens (603) may satisfy the range 52<V3<58. V3 is the Abbe number of the third lens (603).

The lens unit may include a fourth lens (604). The fourth lens (604) may be the fourth lens disposed from the object side. The fourth lens (604) may be the sixth lens disposed from the image side. The fourth lens (604) may be disposed between the third lens (603) and the image side. The fourth lens (604) may be disposed between the third lens (603) and the fifth lens (605). An additional lens may be disposed between the fourth lens (604) and the third lens (603) or between the fourth lens (604) and the fifth lens (605).

The fourth lens (604) may have a positive (+) refractive power. The fourth lens (604) may have a convex meniscus shape on the image side. The fourth lens (604) may have an object side surface (S7) formed concavely. The fourth lens (604) may have the object side surface (S7) formed concavely relative to the optical axis. The fourth lens (604) may have an upper side surface (S8) formed convexly. The fourth lens (604) may have an upper side surface (S8) that is convex relative to the optical axis. The seventh surface(S) of the fourth lens (604) may be provided without any critical points from the optical axis (OA) to the end of the effective area. The eighth surface (S8) may be provided without at least one critical point from the optical axis (OA) to the end of the effective area.

The curvature radius of the object side surface (S7) of the fourth lens (604) may be negative. The curvature radius of the object side surface (S7) of the fourth lens (604) at the optical axis may be negative. The curvature radius of the upper side surface (S8) of the fourth lens (604) may be negative. The curvature radius of the fourth lens (604) on the optical axis of the upper side surface (S8) may be negative. The absolute value of the curvature radius of the object side surface (S7) of the fourth lens (604) may be greater than the absolute value of the curvature radius of the upper side surface (S8) of the fourth lens (604). The fourth lens (604) may be a solid lens. Both surfaces of the fourth lens (604) may be formed as aspherical surfaces. One of the two surfaces of the fourth lens (604) may be formed as a spherical surface, and the other surface may be formed as an aspherical surface.

The fourth lens (604) may satisfy the range 1.5<N4<1.6. Additionally, the fourth lens (604) may satisfy the range 1.52<N4<1.58. N4 is the refractive index of the fourth lens (604). The fourth lens (604) may satisfy the range 50<V4<60. Additionally, the fourth lens (604) may satisfy the range 52<V4<58. V4 is the Abbe number of the fourth lens (604).

The lens unit may include a fifth lens (605). The fifth lens (605) may be the fifth lens disposed from the object side. The fifth lens (605) may be the fifth lens disposed from the image side. The fifth lens (605) may be disposed between the fourth lens (604) and the image side. The fifth lens (605) may be disposed between the fourth lens (604) and the sixth lens (606). An additional lens may be disposed between the fifth lens (605) and the fourth lens (604) or between the fifth lens (605) and the sixth lens (606).

The fifth lens (605) may have a negative (−) refractive power. The fifth lens (605) may have a convex meniscus shape on the object side. The fifth lens (605) may have the object side surface (S9) formed convexly. The fifth lens (605) may have the object side surface (S9) convexly formed relative to the optical axis. The fifth lens (605) may have the upper side surface (S10) concavely formed. The fifth lens (605) may have the upper side surface (S10) concavely formed relative to the optical axis. The ninth surface (S9) of the fifth lens (605) may be provided without any critical points from the optical axis (OA) to the end of the effective area. The tenth surface (S10) may be provided without at least one critical point from the optical axis (OA) to the end of the effective area.

The curvature radius of the object side surface (S9) of the fifth lens (605) may be positive. The curvature radius of the object side surface (S9) of the fifth lens (605) at the optical axis may be positive. The curvature radius of the upper side surface (S10) of the fifth lens (605) may be positive. The curvature radius of the upper side surface (S10) of the fifth lens (605) along the optical axis may be positive. The absolute value of the curvature radius of the object side surface (S9) of the fifth lens (605) may be greater than the absolute value of the curvature radius of the upper side surface (S10) of the fifth lens (605). The fifth lens (605) may be a solid lens. Both surfaces of the fifth lens (605) may be formed as aspherical surfaces. One of the two surfaces of the fifth lens (605) may be formed as a spherical surface, and the other surface may be formed as an aspherical surface.

The fifth lens (605) may satisfy the range 1.6<N5<1.7. Additionally, the fifth lens (605) may satisfy the range 1.62<N5<1.65. N5 is the refractive index of the fifth lens (605). The fifth lens (605) may satisfy the range 20<V5<30. Additionally, the fifth lens (605) may satisfy the range 20<V5<25. V5 is the Abbe number of the fifth lens (605).

The lens unit may include a sixth lens (606). The sixth lens (606) may be the sixth lens disposed from the object side. The sixth lens (606) may be the fourth lens disposed from the image side. The sixth lens (606) may be disposed between the fifth lens (605) and the seventh lens (607). The sixth lens (606) may be disposed between the fifth lens (605) and the image side. An additional lens may be disposed between the sixth lens (606) and the fifth lens (605) or between the sixth lens (606) and the seventh lens (607).

The sixth lens (606) may have a negative (−) refractive power. The sixth lens (606) may have a convex meniscus shape on the upper side. The sixth lens (606) may have the object side surface (S11) concavely formed. The sixth lens (606) may have the object side surface (S11) concave relative to the optical axis. The sixth lens (606) may have the upper side surface (S12) convex. The sixth lens (606) may have the upper side surface (S12) convex relative to the optical axis. The eleventh surface (S11) of the sixth lens (606) may be provided without any critical points from the optical axis (OA) to the end of the effective area. The twelfth surface (S12) may be provided without at least one critical point from the optical axis (OA) to the end of the effective area.

The curvature radius of the object side surface (S11) of the sixth lens (606) may be negative. The curvature radius of the object side surface (S11) of the sixth lens (606) at the optical axis may be negative. The curvature radius of the upper side surface (S12) of the sixth lens (606) may be negative. The curvature radius of the upper side surface (S12) of the sixth lens (606) along the optical axis may be negative. The absolute value of the curvature radius of the object side surface of the sixth lens (606) may be smaller than the absolute value of the curvature radius of the upper side surface of the sixth lens (606). The sixth lens (606) may be a solid lens. Both surfaces of the sixth lens (606) may be formed as aspherical surfaces. One of the two surfaces of the sixth lens (606) may be formed as a spherical surface, and the other surface may be formed as an aspherical surface. The sixth lens (606) may have a surface including one or more inflection points.

The sixth lens (606) may satisfy the range 1.6<N6<1.7. Additionally, the sixth lens (606) may satisfy the range 1.62<N6<1.65. N6 is the refractive index of the sixth lens (606). The sixth lens (606) may satisfy the range 20<V6<30. Additionally, the sixth lens (606) may satisfy the range 20<V6<25. V6 is the Abbe number of the sixth lens (606).

The lens unit may include a seventh lens (607). The seventh lens (607) may be the seventh lens disposed from the object side. The seventh lens (607) may be the third lens disposed from the image side. The seventh lens (607) may be disposed between the sixth lens (606) and the eighth lens (608). The seventh lens (607) may be disposed between the sixth lens (606) and the image side. An additional lens may be disposed between the seventh lens (607) and the sixth lens (606) or between the seventh lens (607) and the eighth lens (608).

The seventh lens (607) may have a positive (+) refractive power. The seventh lens (607) may have a convex meniscus shape on the image side. The seventh lens (607) may have the object side surface (S13) formed concavely. The seventh lens (607) may have the object side surface (S13) concave relative to the optical axis. The seventh lens (607) may have the upper side surface (S14) convex. The seventh lens (607) may have the upper side surface (S14) convex relative to the optical axis. The 13th surface (S13) of the 7th lens (607) may be provided without any critical points from the optical axis (OA) to the end of the effective area. The 14th surface (S14) may be provided without at least one critical point from the optical axis (OA) to the end of the effective area.

The curvature radius of the object side surface (S13) of the seventh lens (607) may be negative. The curvature radius of the object side surface (S13) of the seventh lens (607) at the optical axis may be negative. The curvature radius of the upper side surface (S14) of the seventh lens (607) may be negative. The curvature radius of the upper side surface (S14) of the seventh lens (607) along the optical axis may be negative. The absolute value of the curvature radius of the object side surface of the seventh lens (607) may be greater than the absolute value of the curvature radius of the upper side surface of the seventh lens (607). The seventh lens (607) may be a solid lens. Both surfaces of the seventh lens (607) may be formed as aspherical surfaces. One of the two surfaces of the seventh lens (607) may be formed as a spherical surface, and the other surface may be formed as an aspherical surface. The seventh lens (607) may have a surface including one or more inflection points.

The seventh lens (607) may satisfy the range 1.5<N7<1.6. Additionally, the seventh lens (607) may satisfy the range 1.52<N7<1.58. N7 is the refractive index of the seventh lens (607). The seventh lens (607) may satisfy the range 50<V7<60. Additionally, the seventh lens (607) may satisfy the range 52<V7<58. V6 is the Abbe number of the seventh lens (607).

The lens unit may include an eighth lens (608). The eighth lens (608) may be the eighth lens disposed from the object side. The eighth lens (608) may be the second lens arranged from the image side. The eighth lens (608) may be disposed between the seventh lens (607) and the ninth lens (609). The eighth lens (608) may be disposed between the seventh lens (607) and the image side. An additional lens may be disposed between the eighth lens (608) and the seventh lens (607) or between the eighth lens (608) and the ninth lens (609).

The eighth lens (608) may have a negative (−) refractive power. The eighth lens (608) may have a convex meniscus shape on the upper side. The eighth lens (608) may have the object side surface (S15) formed concavely. The eighth lens (608) may have the object side surface (S15) concave relative to the optical axis. The eighth lens (608) may have the upper side surface (S16) convex. The eighth lens (608) may have the upper side surface (S16) convex relative to the optical axis. The 15th surface (S15) of the 8th lens (608) may be provided without any critical points from the optical axis (OA) to the end of the effective area. The 16th surface (S16) may be provided without at least one critical point from the optical axis (OA) to the end of the effective area.

The curvature radius of the object side surface (S15) of the eighth lens (608) may be negative. The curvature radius of the object side surface (S16) of the eighth lens (608) at the optical axis may be negative. The curvature radius of the upper side surface (S16) of the eighth lens (608) may be negative. The curvature radius of the upper side surface (S16) of the eighth lens (608) along the optical axis may be negative. The value of the curvature radius of the object side surface of the eighth lens (608) may be greater than the value of the curvature radius of the upper side surface of the eighth lens (608). The eighth lens (608) may be a solid lens. Both surfaces of the eighth lens (608) may be formed as aspherical surfaces. One of the two surfaces of the eighth lens (608) may be formed as a spherical surface, and the other surface may be formed as an aspherical surface. The eighth lens (608) may have a surface including one or more inflection points.

The eighth lens (608) may satisfy the range 1.5<N8<1.6. Additionally, the eighth lens (608) may satisfy the range 1.52<N8<1.58. N8 is the refractive index of the eighth lens (608).

The eighth lens (608) may satisfy the range 50<V8<60. Additionally, the eighth lens (608) may satisfy the range 52<V8<58. V8 is the Abbe number of the eighth lens (608).

The lens unit may include a ninth lens (609). The ninth lens (609) may be the lens most adjacent to the image side. The ninth lens (609) may be disposed between the eighth lens (608) and the image side. An additional lens may be disposed between the ninth lens (609) and the eighth lens (608) or between the ninth lens (609) and the filter (900).

The ninth lens (609) may have a negative (−) refractive power. The ninth lens (609) may have a convex meniscus shape toward the object side. The ninth lens (609) may have the object side surface (S17) formed convexly. The ninth lens (609) may have the object side surface (S17) formed convexly relative to the optical axis. The ninth lens (609) may have an upper side surface (S18) formed concavely. The ninth lens (609) may have an upper side surface (S18) formed concavely relative to the optical axis. The object side surface or upper side surface of the ninth lens (609) may include at least one inflection point.

The 17th surface (S17) of the 9th lens (609) may be provided without a critical point from the optical axis (OA) to the end of the effective area. The 18th surface (S18) of the 9th lens (609) may have a critical point from the optical axis (OA) to the end of the effective area. If the 18th surface (S18) has a critical point, it may be located within the range of 55% to 65% of the effective radius (r92) from the optical axis (OA), preferably within the range of 58% to 61%. The critical point of the 18th surface (S18) may be located within the range of 4.0 mm to 4.5 mm from the optical axis (OA), preferably within the range of 4.2 mm to 4.4 mm.

The object side surface (S17) and upper side surface (S18) of the ninth lens (609) may have a point where the slope angle is the same within the 75% to 80% area of the effective diameter. The object side surface (S17) and upper side surface (S18) of the ninth lens (609) may have tangent lines that are parallel to each other at a point within the 75-80% area of the effective diameter. This may minimize the occurrence of specular (diffuse) reflection by aligning the specular (diffuse) reflection path and the normal path.

The curvature radius of the object side surface (S17) of the ninth lens (609) may be positive. The curvature radius of the object side surface (S17) of the ninth lens (609) along the optical axis may be positive. The curvature radius of the upper side surface (S18) of the ninth lens (609) may be positive. The curvature radius of the upper side surface (S18) of the ninth lens (609) along the optical axis may be positive. The value of the curvature radius of the object side surface of the ninth lens (609) may be greater than the value of the curvature radius of the upper side surface of the ninth lens (609). The ninth lens (609) may be a solid lens. Both surfaces of the ninth lens (609) may be formed as aspherical surfaces. One of the two surfaces of the ninth lens (609) may be formed as a spherical surface, and the other surface may be formed as an aspherical surface. The ninth lens (609) may have a surface including one or more inflection points.

The 17th surface (S17) of the 9th lens (609) may be provided without a critical point from the optical axis (OA) to the end of the effective area. The 18th surface (S18) of the 9th lens (609) may have a critical point from the optical axis (OA) to the end of the effective area. If the 18th surface (S18) has a critical point, it may be located within the range of 55% to 65% of the effective radius (r92) from the optical axis (OA), preferably within the range of 58% to 61%. The critical point of the 18th surface (S18) may be located within the range of 4 mm to 4.5 mm from the optical axis (OA), preferably within the range of 4.2 mm to 4.2 mm.

The ninth lens (609) may satisfy the range 1.5<N9<1.6. Additionally, the ninth lens (609) may satisfy the range 1.52<N9<1.58. N9 is the refractive index of the ninth lens (609). The ninth lens (609) may satisfy the range of 50<V9<60. Additionally, the ninth lens (609) may satisfy the range of 52<V9<58. V9 is the Abbe number of the ninth lens (609).

The lens unit may include an aperture (STOP). The aperture can control the amount of light entering the optical system. In lenses placed between an object and an aperture, the effective diameter of the lens surface tends to increase as the distance from the object to the aperture increases. For the lens surfaces disposed between the aperture and the sensor, there is a tendency for the effective diameter of the lens surfaces to decrease as they move from the aperture toward the sensor side. The fact that there is a tendency for the effective diameter of the lens surfaces to increase or decrease does not mean that the effective diameter of the lens surfaces only increases or decreases. For example, it may also include cases where the effective diameter of the lens surfaces increases and then decreases as they move from the aperture toward the sensor side.

The aperture (STOP) may be disposed between the third lens (603) and the fourth lens (604). The aperture (STOP) may be disposed closer to the fourth lens (604) than to the third lens (603). The aperture (STOP) may be spaced apart from the object side surface of the third lens (603). The aperture (STOP) can regulate the amount of light entering from the subject. The aperture (STOP) can regulate the amount of light passing through the third lens (603). The aperture (STOP) can regulate the amount of light entering the fourth lens (604). The aperture (STOP) may include an aperture stop.

The optical system or camera module may include a filter (900). The filter (900) may be disposed between the lens closest to the sensor side among the lenses of the lens unit (100) and the image sensor (800). For example, the filter (900) may be disposed between the nth lens and the image sensor (800).

A cover glass may be disposed between the filter (900) and the image sensor (800), protecting the upper portion of the image sensor (800) and preventing a decrease in the reliability of the image sensor (800). The cover glass may be removable. The cover glass may serve as a protective glass.

The filter (900) may include an infrared filter or an infrared cut-off filter (IR cut-off). The filter (900) can transmit light within a set wavelength band and filter out light from other wavelength bands. When the filter (900) includes an infrared filter, it can block radiant heat emitted from external light from being transmitted to the image sensor (800). Additionally, the filter (900) can transmit visible light and reflect infrared light.

TABLE 12

| | | | | | | Semi | Focal |
|---|---|---|---|---|---|---|---|
| Lens | Surface | Radius | Thickness | nd | vd | Aperture | length |
| 1 | S1 | 35.741 | 0.360 | 1.5800 | 56.0000 | 2.760 | −130.9493 |
| | S2 | 23.761 | 0.453 | | | 2.450 | |
| 2 | S3 | 7.117 | 0.899 | 1.6344 | 23.9000 | 2.403 | −23.3900 |
| | S4 | 4.587 | 0.299 | | | 1.983 | |
| 3 | S5 | 11.932 | 0.941 | 1.5800 | 56.0000 | 1.982 | 8.6586 |
| | S6 | −7.638 | 0.226 | | | 1.865 | |
| 4 | S7(Stop) | −7.477 | 1.043 | 1.5800 | 56.0000 | 1.768 | 13.4220 |
| | S8 | −3.888 | 0.343 | | | 2.090 | |
| 5 | S9 | 4.486 | 0.665 | 1.6494 | 21.9000 | 2.859 | −32.0956 |
| | S10 | 3.482 | 1.663 | | | 2.992 | |
| 6 | S11 | −6.853 | 0.360 | 1.6494 | 21.9000 | 3.076 | −26.9525 |
| | S12 | −11.401 | 0.212 | | | 3.440 | |
| 7 | S13 | −19.608 | 1.689 | 1.5371 | 56.0000 | 3.766 | 5.6286 |
| | S14 | −2.701 | 0.609 | | | 4.011 | |
| 8 | S15 | −5.955 | 0.404 | 1.5800 | 56.0000 | 4.190 | −601.2920 |
| | S16 | −6.446 | 0.801 | | | 4.59 | |
| 9 | S17 | 50.680 | 0.725 | 1.5371 | 56.0000 | 6.02 | −5.4505 |
| | S18 | 2.738 | 1.399 | | | 7.231 | |
| Filter | S19 | Infinity | 0.210 | | | 8.123 | |
| | S20 | Infinity | 0.449 | | | 8.181 | |
| | Image | Infinity | 0.000 | | | 8.382 | |

Table 12 shows the surface number (Surface), curvature radius (Radius), center thickness of each lens or distance between lens surfaces (Thickness), refractive index (Index, nd), Abbe number (Abbe, vd), effective radius (Semi Aperture), and focal length (Focal length) of the lens according to the sixth embodiment of the present invention. Here, the units for curvature radius and thickness or distance may be mm.

TABLE 13

| | Sixth | | Sixth |
|---|---|---|---|
| | embodiment | | embodiment |
| TTL | 13.3900 | ET1 | 0.3525 |
| SD(Stop~L9S2) | 9.5131 | ET2 | 1.0459 |
| TD(L1S1~L9S2) | 12.6907 | ET3 | 0.5739 |
| F | 8.1437 | ET4 | 0.5667 |
| F_LG1 | 15.821 | ET5 | 1.0263 |
| F_LG2 | 22.00632 | ET6 | 0.5093 |
| Fno | 2.3288 | ET7 | 0.3601 |
| ImgH | 8.3815 | ET8 | 0.3468 |
| HFOV | 38.3600 | ET9 | 1.4811 |
| EPD | 3.4970 | | |
| BFL | 2.0583 | | |

Table 13 shows the characteristics of the optical system according to the sixth embodiment of the present invention.

TTL means the optical axis distance from the object side surface vertex of the first lens (601) to the image surface, SD means the optical axis distance from the aperture (STOP) to the upper side surface of the ninth lens (609), TD denotes the optical axis distance from the object-side surface vertex of the first lens (601) to the upper side surface of the ninth lens (609), F denotes the total focal length, F_LG1 denotes the composite focal length of the first lens (601) to the third lens (603) located on the object-side direction of the aperture (STOP), F_LG2 denotes the composite focal length of the fourth lens (604) to the ninth lens (609) located on the image side direction of the aperture (STOP), Fno denotes the ratio of the focal length of the lens to its effective diameter, ImgH denotes the distance from the optical axis (OA) to the diagonal end of the image sensor (800) or half of the maximum diagonal length, HFOV denotes the diagonal field of view of the optical system, EPD denotes the diameter of the entrance pupil (effective aperture), BFL denotes the optical axis distance from the image surface of the ninth lens (609) to the upper surface, ET1 to ET9 represent the thickness of the edge region of each lens.

The following describes the configuration of the optical system according to the seventh embodiment of the present invention with reference to the drawings.

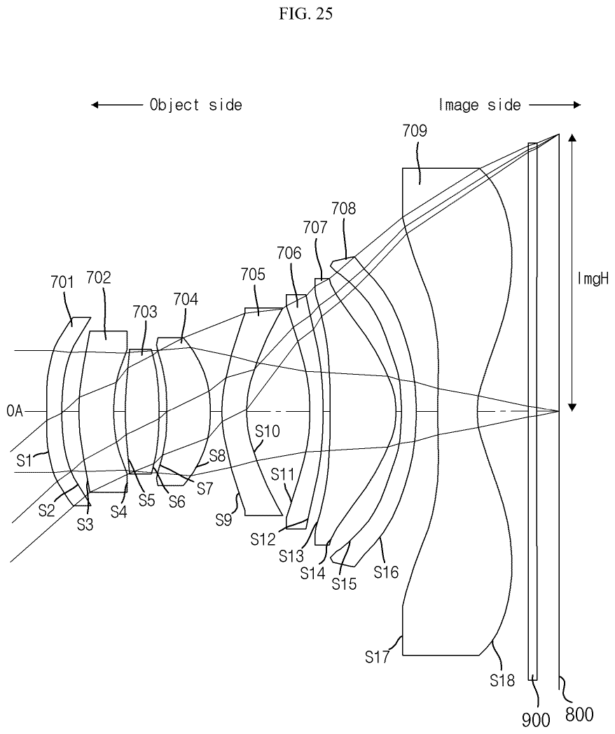

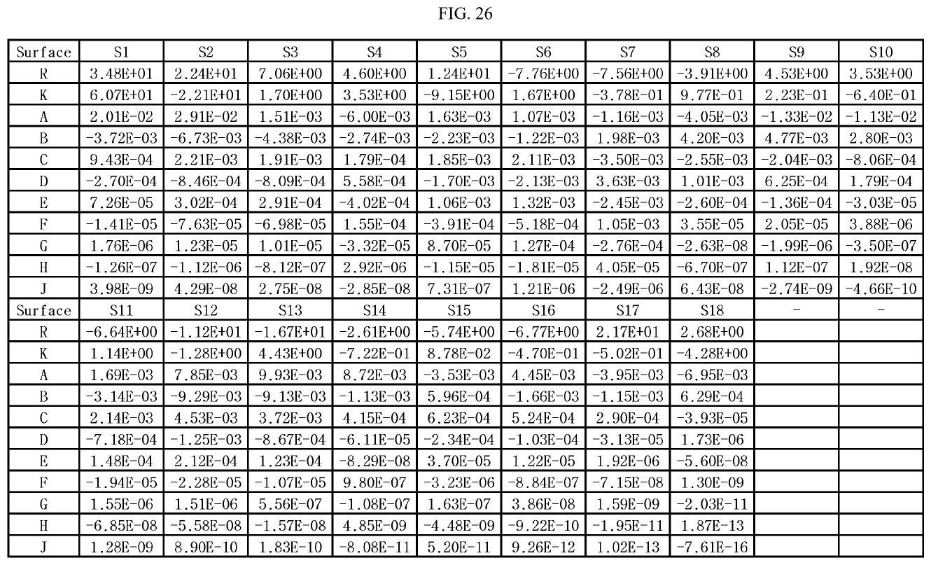

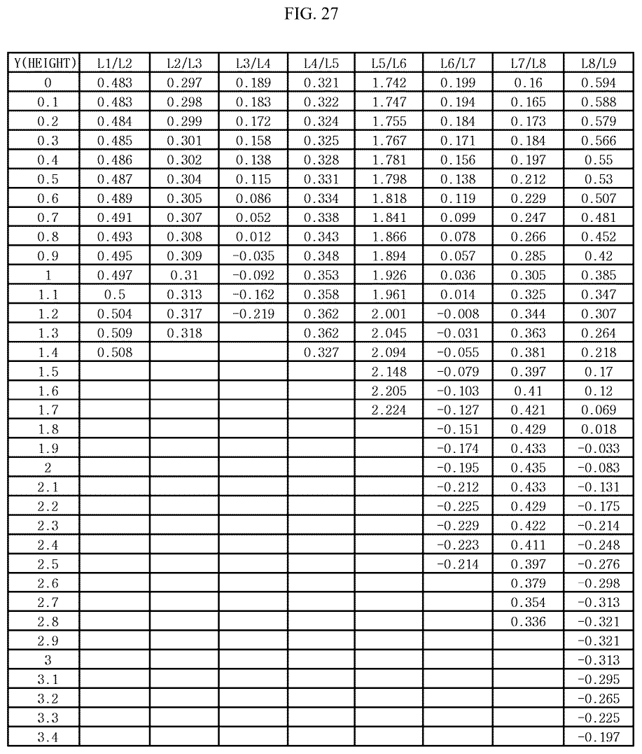

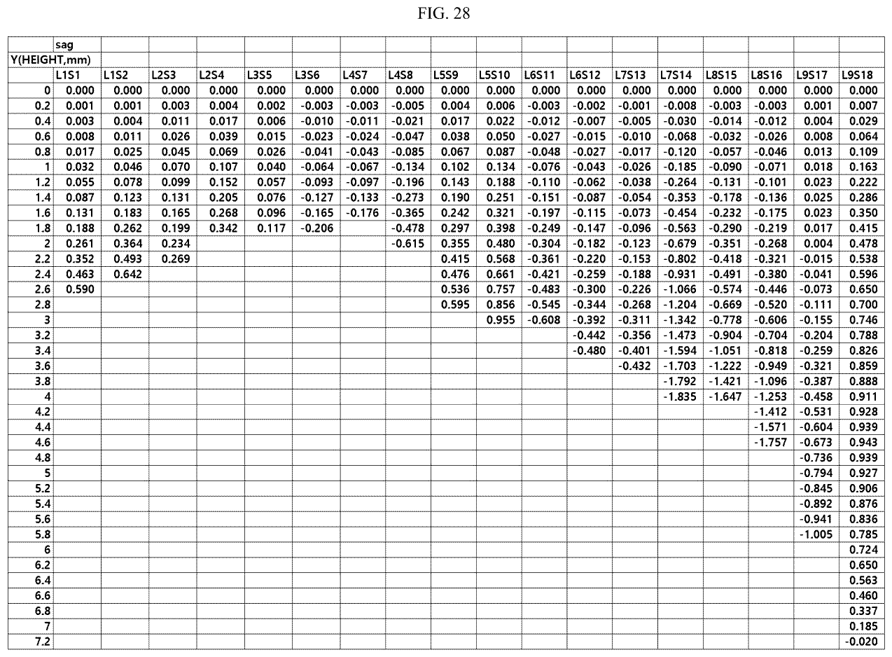

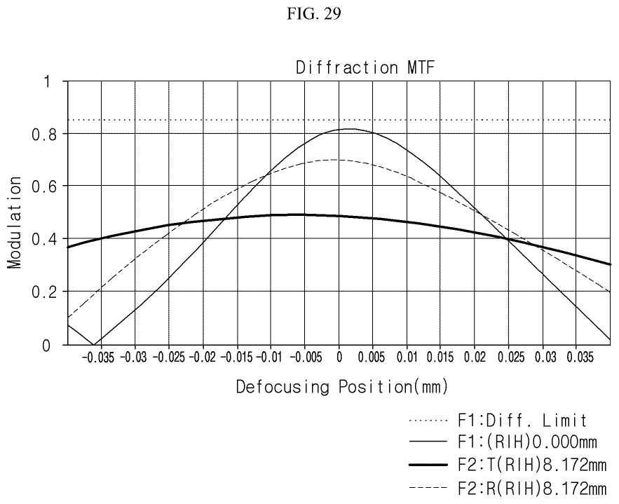

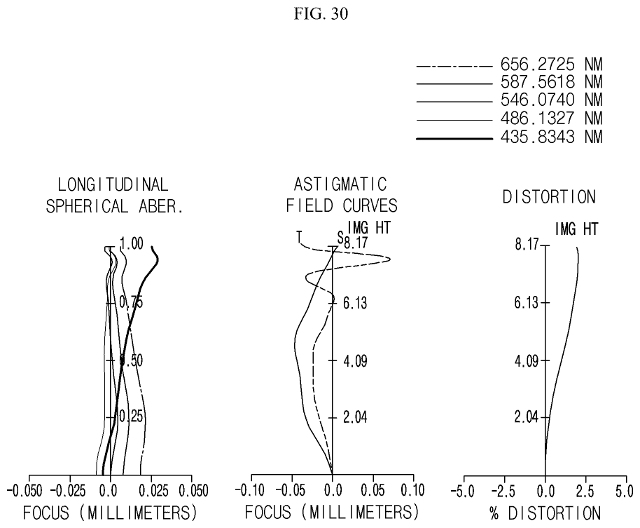

FIG. 25 is a side cross-sectional view of the optical system and a camera module having the same according to the seventh embodiment, FIG. 26 is a table showing the values of the aspheric coefficients of each lens surface and the conic constants (k) in the optical system according to the seventh embodiment, FIG. 27 is a table showing the thickness of each lens and the spacing between adjacent lenses in the optical system according to the seventh embodiment, FIG. 28 is a table showing the Sag values of each lens surface in the optical system according to the seventh embodiment, FIG. 29 is a graph showing data on the aberration characteristics of the optical system according to the seventh embodiment, and FIG. 30 is a graph showing data on the diffraction MTF (Modulation Transfer Function) of the optical system according to the seventh embodiment.

The optical system according to the seventh embodiment may include a lens unit, which may include a first lens (701) to a ninth lens (709). The first to ninth lenses (701, 702, 703, 704, 705, 706, 707, 708, 709) may be disposed sequentially along the optical axis (OA). Light corresponding to the information of the object may pass through the first lens (701) to the ninth lens (709) and the filter (900) and enter the image sensor (800).

The lens unit may be disposed, in order from the object side to the image side, as the first lens (701), the second lens (702), the third lens (703), the aperture (STOP), the fourth lens (704), the fifth lens (705), the sixth lens (706), the seventh lens (707), the eighth lens (708), and the ninth lens (709).

In other embodiments, one or more additional lenses, plates, and optical members may be added between the first lens (701) and the ninth lens (709). Additionally, one or more additional lenses, plates, and optical members may be added in front of the first lens (701) or behind the ninth lens (709). Furthermore, one or more additional lenses, plates, or optical members may be added between the aperture (STOP) and the lens, between the lens and the filter (900), and between the filter (900) and the image sensor (800). In this case, the filter (900) may be a plate lens. The refractive power of the plate lens may be ‘0’. The refractive power of the flat lens may be zero. Additionally, a filter layer may be disposed between the aperture (STOP) and the lens, between the lens and the filter (900), and between the filter (900) and the image sensor (800). In this case, the filter layer may be coated to function as a filter.

The lens unit may include a first lens (701). The first lens (701) may be closest to the object side. The first lens (701) may be the first lens disposed on the object side. The first lens (701) may be the first lens adjacent to the object side. An additional lens may be disposed between the first lens (701) and the second lens (702). The second to eighth lenses (702, 703, 704, 705, 706, 707, 708) may be disposed between the first lens (701) and the ninth lens (709). Additional lenses other than the second to eighth lenses (702, 703, 704, 705, 706, 707, 708) may be disposed between the first lens (701) and the ninth lens (709). At least two lenses may be additionally disposed between at least two of the first to ninth lenses (701, 702, 703, 704, 705, 706, 707, 708, 709).

The first lens (701) may have a negative (−) refractive power. The first lens (701) may have a convex meniscus shape on the object side. The first lens (701) may have the object side surface (S1) formed convexly. The first lens (701) may have the object side surface (S1) convexly formed relative to the optical axis. The first lens (701) may have the upper side surface (S2) concavely formed. The first lens (701) may have the upper side surface (S2) concavely formed relative to the optical axis. The first surface (S1) of the first lens (701) may be provided without any critical points from the optical axis (OA) to the end of the effective area. The second surface (S2) may be provided without at least one critical point from the optical axis (OA) to the end of the effective area.

The curvature radius of the object side surface (S1) of the first lens (701) may be positive. The curvature radius of the object side surface (S1) of the first lens (701) at the optical axis may be positive. The curvature radius of the upper side surface (S2) of the first lens (701) may be positive. The curvature radius of the upper side surface (S2) of the first lens (701) along the optical axis may be positive. The absolute value of the curvature radius of the object side surface (S1) of the first lens (701) may be greater than the absolute value of the curvature radius of the upper side surface (S2) of the first lens (701). The first lens (701) may be a solid lens. Both surfaces of the first lens (701) may be formed as aspherical surfaces. One of the two surfaces of the first lens (701) may be formed as a spherical surface, and the other surface may be formed as an aspherical surface.

The first lens (701) may satisfy the range 1.5<N1<1.6. Additionally, the first lens (701) may satisfy the range 1.52<N1<1.58. N1 is the refractive index of the first lens (701). The first lens (701) may satisfy the range 50<V1<60. Additionally, the first lens (701) may satisfy the range 52<V1<58. V1 is the Abbe number of the first lens (701).

The lens unit may include a second lens (702). The second lens (702) may be the second lens disposed from the object side. The second lens (702) may be the second lens adjacent to the object side. The second lens (702) may be disposed between the first lens (701) and the image side. The second lens (702) may be disposed between the first lens (701) and the third lens (703). An additional lens may be disposed between the second lens (702) and the first lens (701) or between the second lens (702) and the third lens (703). The second lens (702) may have a negative (−) refractive power. The second lens (702) may have a convex meniscus shape on the object side. The second lens (702) may have the object side surface (S3) formed convexly. The second lens (702) may have the object side surface (S3) convexly formed relative to the optical axis. The second lens (702) may have the upper side surface (S4) concavely formed. The second lens (702) may have the upper side surface (S4) concavely formed relative to the optical axis. The third surface (S3) of the second lens (702) may be provided without any critical points from the optical axis (OA) to the end of the effective area. The fourth surface (S4) may be provided without at least one critical point from the optical axis (OA) to the end of the effective area.

The curvature radius of the object side surface (S3) of the second lens (702) may be positive. The curvature radius of the object side surface (S3) of the second lens (702) at the optical axis may be positive. The curvature radius of the upper side surface (S4) of the second lens (702) may be negative. The curvature radius of the upper side surface (S4) of the second lens (702) at the optical axis may be negative. The absolute value of the curvature radius of the object side surface (S3) of the second lens (702) may be greater than the absolute value of the curvature radius of the upper side surface (S4) of the second lens (702).

The second lens (702) may be a solid lens. Both surfaces of the second lens (702) may be formed as aspherical surfaces. One of the two surfaces of the second lens (702) may be formed as a spherical surface, and the other surface may be formed as a non-spherical surface.

The second lens (702) may satisfy the range 1.6<N2<1.7. Additionally, the second lens (702) may satisfy the range 1.62<N2<1.65. N2 is the refractive index of the second lens (702). The second lens (702) may satisfy the range 20<V2<30. Additionally, the second lens (702) may satisfy the range 22<V2<25. V2 is the Abbe number of the second lens (702).

The lens unit may include a third lens (703). The third lens (703) may be the third lens disposed from the object side. The third lens (703) may be the third lens adjacent to the object side. The third lens (703) may be disposed between the second lens (702) and the image side. The third lens (703) may be disposed between the second lens (702) and the fourth lens (704). An additional lens may be disposed between the third lens (703) and the second lens (702) or between the third lens (703) and the fourth lens (704).

The third lens (703) may have a positive (+) refractive power. The third lens (703) may be formed with both surfaces convex. The third lens (703) may be formed with the object side surface (S5) convex. The third lens (703) may have the object side surface (S5) convexly formed relative to the optical axis. The third lens (703) may have the upper side surface (S6) convexly formed. The third lens (703) may have the upper side surface (S6) convexly formed relative to the optical axis. The fifth surface (S5) of the third lens (703) may be provided without any critical points from the optical axis (OA) to the end of the effective area. The sixth surface (S6) may be provided without at least one critical point from the optical axis (OA) to the end of the effective area.

The curvature radius of the object side surface (S5) of the third lens (703) may be positive. The curvature radius of the object side surface (S5) of the third lens (703) at the optical axis may be positive. The curvature radius of the upper side surface (S6) of the third lens (703) may be negative. The curvature radius of the upper side surface (S6) of the third lens (703) along the optical axis may be negative. The absolute value of the curvature radius of the object side surface of the third lens (703) may be greater than the absolute value of the curvature radius of the upper side surface of the third lens (703). The third lens (703) may be a solid lens. Both surfaces of the third lens (703) may be formed as aspherical surfaces. One of the two surfaces of the third lens (703) may be formed as a spherical surface, and the other surface may be formed as an aspherical surface.

The third lens (703) may satisfy the range 1.5<N3<1.6. Additionally, the third lens (703) may satisfy the range 1.52<N3<1.58. N3 is the refractive index of the third lens (703). The third lens (703) may satisfy the range 50<V3<60. Additionally, the third lens (703) may satisfy the range 52<V3<58. V3 is the Abbe number of the third lens (703).

The lens unit may include a fourth lens (704). The fourth lens (704) may be the fourth lens disposed from the object side. The fourth lens (704) may be the sixth lens disposed from the image side. The fourth lens (704) may be disposed between the third lens (703) and the image side. The fourth lens (704) may be disposed between the third lens (703) and the fifth lens (705). An additional lens may be disposed between the fourth lens (704) and the third lens (703) or between the fourth lens (704) and the fifth lens (705).

The fourth lens (704) may have a positive (+) refractive power. The fourth lens (704) may have a convex meniscus shape on the image side. The fourth lens (704) may have an object side surface (S7) formed concavely. The fourth lens (704) may have the object side surface (S7) formed concavely relative to the optical axis. The fourth lens (704) may have an upper side surface (S8) formed convexly. The fourth lens (704) may have an upper side surface (S8) that is convex relative to the optical axis. The seventh surface(S) of the fourth lens (704) may be provided without any critical points from the optical axis (OA) to the end of the effective area. The eighth surface (S8) may be provided without at least one critical point from the optical axis (OA) to the end of the effective area.

The curvature radius of the object side surface (S7) of the fourth lens (704) may be negative. The curvature radius of the object side surface (S7) of the fourth lens (704) at the optical axis may be negative. The curvature radius of the upper side surface (S8) of the fourth lens (704) may be negative. The curvature radius of the fourth lens (704) on the optical axis of the upper side surface (S8) may be negative. The absolute value of the curvature radius of the object side surface (S7) of the fourth lens (704) may be greater than the absolute value of the curvature radius of the upper side surface (S8) of the fourth lens (704). The fourth lens (704) may be a solid lens. Both surfaces of the fourth lens (704) may be formed as aspherical surfaces. One of the two surfaces of the fourth lens (704) may be formed as a spherical surface, and the other surface may be formed as an aspherical surface.

The fourth lens (704) may satisfy the range 1.5<N4<1.6. Additionally, the fourth lens (704) may satisfy the range 1.52<N4<1.58. N4 is the refractive index of the fourth lens (704). The fourth lens (704) may satisfy the range 50<V4<60. Additionally, the fourth lens (704) may satisfy the range 52<V4<58. V4 is the Abbe number of the fourth lens (704).

The lens unit may include a fifth lens (705). The fifth lens (705) may be the fifth lens disposed from the object side. The fifth lens (705) may be the fifth lens disposed from the image side. The fifth lens (705) may be disposed between the fourth lens (704) and the image side. The fifth lens (705) may be disposed between the fourth lens (704) and the sixth lens (706). An additional lens may be disposed between the fifth lens (705) and the fourth lens (704) or between the fifth lens (705) and the sixth lens (706).

The fifth lens (705) may have a negative (−) refractive power. The fifth lens (705) may have a convex meniscus shape on the object side. The fifth lens (705) may have the object side surface (S9) formed convexly. The fifth lens (705) may have the object side surface (S9) convexly formed relative to the optical axis. The fifth lens (705) may have the upper side surface (S10) concavely formed. The fifth lens (705) may have the upper side surface (S10) concavely formed relative to the optical axis. The ninth surface (S9) of the fifth lens (705) may be provided without any critical points from the optical axis (OA) to the end of the effective area. The tenth surface (S10) may be provided without at least one critical point from the optical axis (OA) to the end of the effective area.

The curvature radius of the object side surface (S9) of the fifth lens (705) may be positive. The curvature radius of the object side surface (S9) of the fifth lens (705) at the optical axis may be positive. The curvature radius of the upper side surface (S10) of the fifth lens (705) may be positive. The curvature radius of the upper side surface (S10) of the fifth lens (705) along the optical axis may be positive. The absolute value of the curvature radius of the object side surface (S9) of the fifth lens (705) may be greater than the absolute value of the curvature radius of the upper side surface (S10) of the fifth lens (705). The fifth lens (705) may be a solid lens. Both surfaces of the fifth lens (705) may be formed as aspherical surfaces. One of the two surfaces of the fifth lens (705) may be formed as a spherical surface, and the other surface may be formed as an aspherical surface.

The fifth lens (705) may satisfy the range 1.6<N5<1.7. Additionally, the fifth lens (705) may satisfy the range 1.62<N5<1.65. N5 is the refractive index of the fifth lens (705). The fifth lens (705) may satisfy the range 20<V5<30. Additionally, the fifth lens (705) may satisfy the range 20<V5<25. V5 is the Abbe number of the fifth lens (705).

The lens unit may include a sixth lens (706). The sixth lens (706) may be the sixth lens disposed from the object side. The sixth lens (706) may be the fourth lens disposed from the image side. The sixth lens (706) may be disposed between the fifth lens (705) and the seventh lens (707). The sixth lens (706) may be disposed between the fifth lens (705) and the image side. An additional lens may be disposed between the sixth lens (706) and the fifth lens (705) or between the sixth lens (706) and the seventh lens (707).

The sixth lens (706) may have a negative (−) refractive power. The sixth lens (706) may have a convex meniscus shape on the image side. The sixth lens (706) may have the object side surface (S11) concavely formed. The sixth lens (706) may have the object side surface (S11) concave relative to the optical axis. The sixth lens (706) may have the upper side surface (S12) convex. The sixth lens (706) may have the upper side surface (S12) convex relative to the optical axis. The eleventh surface (S11) of the sixth lens (706) may be provided without any critical points from the optical axis (OA) to the end of the effective area. The twelfth surface (S12) may be provided without at least one critical point from the optical axis (OA) to the end of the effective area.

The curvature radius of the object side surface (S11) of the sixth lens (706) may be negative. The curvature radius of the object side surface (S11) of the sixth lens (706) at the optical axis may be negative. The curvature radius of the upper side surface (S12) of the sixth lens (706) may be negative. The curvature radius of the upper side surface (S12) of the sixth lens (706) along the optical axis may be negative. The absolute value of the curvature radius of the object side surface of the sixth lens (706) may be smaller than the absolute value of the curvature radius of the upper side surface of the sixth lens (706). The sixth lens (706) may be a solid lens. Both surfaces of the sixth lens (706) may be formed as aspherical surfaces. One of the two surfaces of the sixth lens (706) may be formed as a spherical surface, and the other surface may be formed as an aspherical surface. The sixth lens (706) may have a surface including one or more inflection points.

The sixth lens (706) may satisfy the range 1.6<N6<1.7. Additionally, the sixth lens (706) may satisfy the range 1.62<N6<1.65. N6 is the refractive index of the sixth lens (706). The sixth lens (706) may satisfy the range 20<V6<30. Additionally, the sixth lens (706) may satisfy the range 20<V6<25. V6 is the Abbe number of the sixth lens (706).

The lens unit may include a seventh lens (707). The seventh lens (707) may be the seventh lens disposed from the object side. The seventh lens (707) may be the third lens disposed from the image side. The seventh lens (707) may be disposed between the sixth lens (706) and the eighth lens (708). The seventh lens (707) may be disposed between the sixth lens (706) and the image side. An additional lens may be disposed between the seventh lens (707) and the sixth lens (706) or between the seventh lens (707) and the eighth lens (708).

The seventh lens (707) may have a positive (+) refractive power. The seventh lens (707) may have a convex meniscus shape on the image side. The 7th lens (707) may have an object side surface (S13) formed concavely. The 7th lens (707) may have the object side surface (S13) formed concavely relative to the optical axis. The 7th lens (707) may have an upper side surface (S14) formed convexly. The seventh lens (707) may have an upper side surface (S14) that is convex relative to the optical axis. The object side surface or upper side surface of the seventh lens (707) may include at least one inflection point.

The curvature radius of the object side surface (S13) of the seventh lens (707) may be negative. The curvature radius of the object side surface (S13) of the seventh lens (707) relative to the optical axis may be negative. The curvature radius of the upper side surface (S14) of the seventh lens (707) may be negative. The curvature radius of the upper side surface (S14) of the seventh lens (707) along the optical axis may be negative. The absolute value of the curvature radius of the object side surface of the seventh lens (707) may be greater than the absolute value of the curvature radius of the upper side surface of the seventh lens (707). The seventh lens (707) may be a solid lens. Both surfaces of the seventh lens (707) may be formed as aspherical surfaces. One of the two surfaces of the seventh lens (707) may be formed as a spherical surface, and the other surface may be formed as an aspherical surface. The thirteenth surface (S13) of the seventh lens (707) may be provided without any critical points from the optical axis (OA) to the end of the effective area. The 14th surface (S14) may be provided without at least one critical point from the optical axis (OA) to the end of the effective area.

The seventh lens (707) may satisfy the range 1.5<N7<1.6. Additionally, the seventh lens (707) may satisfy the range 1.52<N7<1.58. N7 is the refractive index of the seventh lens (707). The seventh lens (707) may satisfy the range 50<V7<60. Additionally, the seventh lens (707) may satisfy the range 52<V7<58. V6 is the Abbe number of the seventh lens (707).

The lens unit may include an eighth lens (708). The eighth lens (708) may be the eighth lens disposed from the object side. The eighth lens (708) may be the second lens disposed from the image side. The eighth lens (708) may be disposed between the seventh lens (707) and the ninth lens (709). The eighth lens (708) may be disposed between the seventh lens (707) and the image side. An additional lens may be disposed between the eighth lens (708) and the seventh lens (707) or between the eighth lens (708) and the ninth lens (709).

The eighth lens (708) may have a negative (−) refractive power. The eighth lens (708) may have a convex meniscus shape on the image side. The eighth lens (708) may have an object side surface (S15) formed concavely. The eighth lens (708) may have the object side surface (S15) formed concavely relative to the optical axis. The eighth lens (708) may have an upper side surface (S16) formed convexly. The eighth lens (708) may have an upper side surface (S16) that is convex relative to the optical axis. The object side surface or upper side surface of the eighth lens (708) may include at least one inflection point.

The curvature radius of the object side surface (S15) of the eighth lens (708) may be negative. The curvature radius of the object side surface (S16) of the eighth lens (708) relative to the optical axis may be negative. The curvature radius of the upper side surface (S16) of the eighth lens (708) may be negative. The curvature radius of the upper side surface (S16) of the eighth lens (708) along the optical axis may be negative. The value of the curvature radius of the object side surface of the eighth lens (708) may be greater than the value of the curvature radius of the upper side surface of the eighth lens (708). The eighth lens (708) may be a solid lens. Both surfaces of the eighth lens (708) may be formed as aspherical surfaces. One of the two surfaces of the eighth lens (708) may be formed as a spherical surface, and the other surface may be formed as an aspherical surface. The fifteenth surface (S15) of the eighth lens (708) may be provided without any critical points from the optical axis (OA) to the end of the effective area. The 16th surface (S16) may be provided without at least one critical point from the optical axis (OA) to the end of the effective area.

The eighth lens (708) may satisfy the range 1.5<N8<1.6. Additionally, the eighth lens (708) may satisfy the range 1.52<N8<1.58. N8 is the refractive index of the eighth lens (708). The eighth lens (708) may satisfy the range 50<V8<60. Additionally, the eighth lens (708) may satisfy the range 52<V8<58. V8 is the Abbe number of the eighth lens (708).

The lens unit may include a ninth lens (709). The ninth lens (709) may be the lens most adjacent to the image side. The ninth lens (709) may be disposed between the eighth lens (708) and the image side. An additional lens may be disposed between the ninth lens (709) and the eighth lens (708) or between the ninth lens (709) and the filter (900).

The ninth lens (709) may have a negative (−) refractive power. The ninth lens (709) may have a convex meniscus shape toward the object side. The ninth lens (709) may have the object side surface (S17) formed convexly. The ninth lens (709) may have the object side surface (S17) formed convexly relative to the optical axis. The ninth lens (709) may have an upper side surface (S18) formed concavely. The ninth lens (709) may have an upper side surface (S18) formed concavely relative to the optical axis. The object side surface or upper side surface of the ninth lens (709) may include at least one inflection point.

The object side surface (S17) and upper side surface (S18) of the ninth lens (709) may have a point where the slope angle is the same in the 75-80% area of the effective diameter. The object side surface (S17) and upper side surface (S18) of the ninth lens (709) may have tangent lines that are parallel to each other at a point within the 75-80% area of the effective diameter. This may minimize the occurrence of specular (diffuse) reflection by making the specular (diffuse) reflection path and the normal path identical.

The curvature radius of the object side surface (S17) of the ninth lens (709) may be positive. The curvature radius of the object side surface (S17) of the ninth lens (709) along the optical axis may be positive. The curvature radius of the upper side surface (S18) of the ninth lens (709) may be positive. The curvature radius of the upper side surface (S18) of the ninth lens (709) along the optical axis may be positive. The value of the curvature radius of the object side surface of the ninth lens (709) may be greater than the value of the curvature radius of the upper side surface of the ninth lens (709). The ninth lens (709) may be a solid lens. Both surfaces of the ninth lens (709) may be formed as aspherical surfaces. One of the two surfaces of the ninth lens (709) may be formed as a spherical surface, and the other surface may be formed as an aspherical surface.

The ninth lens (709) may have a surface including one or more inflection points.

The ninth lens (709) may satisfy the range 1.5<N9<1.6. Additionally, the ninth lens (709) may satisfy the range 1.52<N9<1.58. N9 is the refractive index of the ninth lens (709). The ninth lens (709) may satisfy the range 50<V9<60. Additionally, the ninth lens (709) may satisfy the range 52<V9<58. V9 is the Abbe number of the ninth lens (709).

The 17th surface (S17) of the 9th lens (709) may be provided without a critical point from the optical axis (OA) to the end of the effective area. The 18th surface (S18) of the 9th lens (709) may have a critical point from the optical axis (OA) to the end of the effective area. When the 18th surface (S18) has a critical point, it can be located within the range of 60% to 68% of the effective radius (r92) from the optical axis (OA), preferably within the range of 63% to 67%. The critical point of the 18th surface (S18) may be located within a range of 4.5 mm to 5 mm, preferably 4.6 mm to 4.8 mm, from the optical axis (OA).

The lens unit may include an aperture (STOP). The aperture can control the amount of light entering the optical system. For lenses disposed between an object and the aperture, there is a tendency for the effective diameter of the lens surfaces to increase as they move from the object side toward the aperture. For lens surfaces disposed between the aperture and the sensor, there is a tendency for the effective diameter of the lens surfaces to decrease as they move from the aperture toward the sensor. The tendency for the effective diameter of lens surfaces to increase or decrease does not mean that the effective diameter of lens surfaces only increases or decreases. For example, it may also include cases where the effective diameter of lens surfaces increases and then decreases as moving from the aperture toward the sensor.

The aperture (STOP) may be disposed between the third lens (703) and the fourth lens (704). The aperture (STOP) may be disposed closer to the fourth lens (704) than to the third lens (703). The aperture (STOP) may be spaced apart from the object side surface of the third lens (703). The aperture (STOP) can regulate the amount of light entering from the subject. The aperture (STOP) can regulate the amount of light passing through the third lens (703). The aperture (STOP) can regulate the amount of light entering the fourth lens (704). The aperture (STOP) may include an aperture stop.

The optical system or camera module may include a filter (900). The filter (900) may be disposed between the lens closest to the sensor side among the lenses of the lens unit (100) and the image sensor (800). For example, the filter (900) may be disposed between the nth lens and the image sensor (800).

The cover glass may be disposed between the filter (900) and the image sensor (800), protecting the upper portion of the image sensor (800) and preventing a decrease in the reliability of the image sensor (800). The cover glass may be removable. The cover glass may be a protective glass.

The filter (900) may include an infrared filter or an infrared cut-off filter (IR cut-off). The filter (900) may transmit light within a set wavelength band and filter out light from other wavelength bands. When the filter (900) includes an infrared filter, it can block radiant heat emitted from external light from being transmitted to the image sensor (800). Additionally, the filter (900) can transmit visible light and reflect infrared light.

TABLE 14

| | | | | | | Semi | Focal |
|---|---|---|---|---|---|---|---|
| Lens | Surface | Radius | Thickness | nd | vd | Aperture | length |
| 1 | S1 | 34.759 | 0.384 | 1.540 | 56.000 | 2.762 | −116.1320 |
| | S2 | 22.380 | 0.482 | | | 2.450 | |
| 2 | S3 | 7.056 | 0.951 | 1.634 | 23.900 | 2.392 | −24.2000 |
| | S4 | 4.600 | 0.297 | | | 1.999 | |
| 3 | S5 | 12.383 | 0.934 | 1.540 | 56.000 | 1.999 | 8.8646 |
| | S6 | −7.760 | 0.192 | | | 1.874 | |
| 4 | S7(Stop) | −7.565 | 1.602 | 1.540 | 56.000 | 1.795 | 13.2270 |
| | S8 | −3.906 | 0.321 | | | 2.171 | |
| 5 | S9 | 4.527 | 0.663 | 1.649 | 21.900 | 2.908 | −33.1340 |
| | S10 | 3.531 | 1.740 | | | 3.029 | |
| 6 | S11 | −6.643 | 0.363 | 1.649 | 21.900 | 3.122 | −25.6710 |
| | S12 | −11.186 | 0.602 | | | 3.440 | |
| 7 | S13 | −16.725 | 1.759 | 1.537 | 56.000 | 3.703 | 5.5177 |
| | S14 | −2.613 | 0.159 | | | 3.912 | |
| 8 | S15 | −5.740 | 0.404 | 1.540 | 56.000 | 4.097 | −80.1767 |
| | S16 | −6.768 | 0.596 | | | 4.54 | |
| 9 | S17 | 21.710 | 1.072 | 1.537 | 56.000 | 5.44 | −5.7890 |
| | S18 | 2.676 | 1.399 | | | 6.961 | |
| Filter | S19 | Infinity | 0.210 | | | 7.707 | |
| | S20 | Infinity | 0.610 | | | 7.786 | |
| | Image | Infinity | 0.000 | | | 8.172 | |

Table 14 shows the surface number (Surface), curvature radius (Radius), center thickness of each lens or distance between lens surfaces (Thickness), refractive index (Index, nd), Abbe number (Abbe, vd), effective radius (Semi Aperture), and focal length (Focal length) of the lens according to the seventh embodiment of the present invention. Here, the units for curvature radius and thickness or distance may be mm.

TABLE 15

| | Seventh | | Seventh |
|---|---|---|---|
| | embodiment | | embodiment |
| TTL | 13.9395 | ET1 | 0.3616 |
| SD(Stop~L9S2) | 9.8794 | ET2 | 1.0926 |
| TD(L1S1~L9S2) | 13.1196 | ET3 | 0.5754 |
| F | 8.1437 | ET4 | 0.6722 |
| F_LG1 | 16.4521 | ET5 | 1.0068 |
| F_LG2 | 20.7022 | ET6 | 0.5282 |
| Fno | 2.2876 | ET7 | 0.3732 |
| ImgH | 8.1715 | ET8 | 0.4705 |
| HFOV | 37.6800 | ET9 | 2.1924 |
| EPD | 3.5600 | | |
| BFL | 2.2188 | | |

Table 15 shows the characteristics of the imaging lens according to the seventh embodiment of the present invention.

TTL refers to the optical axis distance from the object side surface vertex of the first lens (701) to the image surface, SD refers to the optical axis distance from the aperture (STOP) to the upper side surface of the ninth lens (709), TD denotes the optical axis distance from the object-side surface vertex of the first lens (701) to the upper side surface of the ninth lens (709), F denotes the total focal length, F_LG1 denotes the composite focal length of the first lens (701) to the third lens (703) located on the object-side direction of the aperture (STOP), F_LG2 denotes the composite focal length of the fourth lens (704) to the ninth lens (709) located on the image side direction of the aperture (STOP), Fno denotes the ratio of the focal length of the lens to the effective diameter, ImgH denotes the distance from the optical axis (OA) to the diagonal end of the image sensor (800) or half of the maximum diagonal length, HFOV denotes the diagonal field of view of the optical system, EPD denotes the diameter of the entrance pupil (effective aperture), BFL denotes the optical axis distance from the upper side surface of the ninth lens (709) to the image surface, ET1 to ET9 represent the thickness of the edge region of each lens.

The optical system according to the fifth to seventh embodiments described above may satisfy at least one or more of the mathematical equations described below. Accordingly, the optical system according to the fifth to seventh embodiments may have improved optical characteristics. For example, if the optical system according to the present embodiment satisfies at least one of the mathematical equations, the optical system can effectively control aberration characteristics such as chromatic aberration and distortion aberration, and can have good optical performance not only in the central portion but also in the peripheral portion of the field of view (FOV). Additionally, the optical system according to the fifth to seventh embodiments may have improved resolution. Furthermore, the thickness of the lens at the optical axis (OA) and the gap (spacing) between adjacent lenses at the optical axis (OA) as described in the mathematical equations may be referred to the embodiments disclosed above.

$$0.5 < F / TTL < 1.5 \qquad [ Mathematical Equation 21 ]$$

Mathematical Equation 21 may allow the total focal length (F) and total optical axis length (TTL) of an optical system to be set. This enables the provision of a mobile optical system. If the optical system according to the fifth to seventh embodiments satisfies Mathematical Equation 21, the optical system can have an appropriate focal length within the set TTL range. If the value is below the lower limit of Mathematical Equation 21, it is necessary to increase the refractive power of the lenses, which makes it difficult to correct spherical aberration or distortion aberration. If the value exceeds the upper limit of Mathematical Equation 21, the lenses may become longer in effective diameter or TTL, potentially leading to the enlargement of the imaging lens system.

Mathematical Equation 21 is preferably satisfied in the fifth to seventh embodiments, where 0.5<TTL/F<0.7.

$$1 < F / EPD < 3 \qquad [ Mathematical Equation 22 ]$$

Mathematical Equation 22 may allow setting the total focal length (F) of the optical system and the size (EPD) of the entrance pupil of the optical system. Accordingly, the total brightness of the optical system can be controlled. Mathematical Equation 22 may preferably satisfy 2<F/EPD<2.5 in the fifth to seventh embodiments.

$$2 < ET 9 / CT 9 < 5 \qquad [ Mathematical Equation 23 ]$$

Mathematical Equation 23 may establish the relationship between the edge thickness (ET9) and the center thickness (CT9) of the ninth lens (509, 609, 709). As a result, the distortion characteristics of the optical system can be improved, and conditions for image processing can be set. Mathematical Equation 23 may preferably satisfy the condition 2<ET9/CT9<3.5 in the fifth to seventh embodiments.

$$0.5 < CT 8 / ET 8 < 1.5 \qquad [ Mathematical Equation 24 ]$$

Mathematical Equation 24 may set the relationship between the edge thickness (ET8) and the center thickness (CT8) of the eighth lens (508, 608, 708). As a result, the distortion characteristics of the optical system can be improved, and conditions for image processing can be set. Mathematical Equation 24 may preferably satisfy 0.7<CT8/ET8<1.3 in the fifth to seventh embodiments.

$$1 < CT\_Max / Air\_Max < 1.5 \qquad [ Mathematical Equation 25 ]$$

Mathematical Equation 25 may establish the relationship between the maximum center thickness (CT_Max) of the first to ninth lenses and the maximum spacing (Air_Max) between adjacent lenses. As a result, the optical system can achieve good optical performance at the focal length corresponding to the set field of view and reduce the TTL, enabling the camera module to be miniaturized. Mathematical Equation 25 may preferably satisfy the condition 1<CT_Max/Air Max<1.2 in the fifth to seventh embodiments.

$$0 < F / \vert L 1 R 1 \vert < 0.5 \qquad [ Mathematical Equation 26 ]$$

In Mathematical Equation 26, the effective focal length of the optical system and the curvature radius of the object side surface (S1) of the first lens (501, 601, 701) are set, thereby enabling to control the effect on the incident light and the TTL. In the fifth to seventh embodiments, Mathematical Equation 26 may preferably satisfy the condition 0<F/|L1R1|<0.3.

$$10 < \sum Index < 20 \qquad [ Mathematical Equation 27 ]$$

In Mathematical Equation 27, Eindex denotes the sum of the refractive indices at the d-line for each of the multiple lenses. When Mathematical Equation 27 is satisfied, it is possible to control TTL in an optical system that combines aspherical lenses and spherical lenses, thereby achieving improved resolution. Mathematical Equation 27 may preferably satisfy 13<Σindex<15.

$$20 < \sum Abb / \sum Index < 30 \qquad [ Mathematical Equation 28 ]$$

Mathematical Equation 28 may establish the relationship between the sum of the Abbe numbers (Σabb) of each lens and the sum of the refractive indices (Zindex) at the d-line of each lens. When Mathematical Equation 28 is satisfied, the optical system can achieve improved aberration characteristics and resolution. Mathematical Equation 28 may set the sum of the Abbe numbers and the sum of the refractive indices of the lenses, enabling control of optical characteristics. It is desirable for the condition 25<Σabb/index<29 to be satisfied.

$$1 < Distortion < 2.5 \qquad [ Mathematical Equation 29 ]$$

In Mathematical Equation 29, distortion refers to the maximum value or absolute value of distortion from the center (0.0F) of the image sensor to the end point (1.0F) in the diagonal direction, based on the optical characteristics detected by the image sensor (300). If the optical system satisfies Mathematical Equation 29, the optical system can improve its distortion characteristics and set conditions for image processing. Preferably, it should satisfy 1.5<Distortion<2.2.

$$0 < CT 1 / CT 2 < 1 \qquad [ Mathematical Equation 30 ]$$

In Mathematical Equation 30, CT1 denotes the thickness of the first lens (501, 601, 701, 401) on the optical axis (OA), and CT2 denotes the thickness of the second lens (502, 602, 702, 401) on the optical axis (OA) (mm). Mathematical Equation 30 may establish the relationship between the central thicknesses of the first and second lenses, enabling improvement of chromatic aberration in the optical system. Additionally, it allows setting the central thickness of the first aspherical lens (501, 601, 701, 401), thereby enhancing optical performance in both the central and peripheral regions of the field of view (FOV). Mathematical Equation 30 may satisfy the condition 0.2<CT1/CT2<0.5 in the fifth to seventh embodiments.

$$Fno < 2.5 \qquad [ Mathematical Equation 31 ]$$

Mathematical Equation 31 may be used to set the range of Fno. When the optical system according to the fifth to seventh embodiments satisfies Mathematical Equation 31, the optical system can provide a bright image and effectively ensure the characteristic of a large aperture to emphasize the subject. Mathematical Equation 31 may preferably satisfy 2<Fno<2.4 in the fifth to seventh embodiments.

$$0.5 < TTL / {ImgH}^{*} 2 < 1 \qquad [ Mathematical Equation 32 ]$$

Mathematical Equation 32 may allow setting the total optical axis length (TTL) of the optical system and the diagonal length (ImgH) from the optical axis of the image sensor. When the optical system according to the fifth to seventh embodiments satisfies Mathematical Equation 32, the optical system can have a TTL suitable for the image sensor, thereby providing improved image quality. Additionally, the ultra-thin characteristics of the camera lens group can be effectively achieved. Mathematical Equation 32 may preferably satisfy 0.7<TTL/ImgH<0.9 in the fifth to seventh embodiments.

$$10 < TTL < 15 \qquad [ Mathematical Equation 33 ]$$

Mathematical Equation 33 may set the range of TTL, which is the distance from the center of the first surface (S1) of the first lens (501, 601, 701) to the optical axis (OA) of the image sensor. Mathematical Equation 33 enables the provision of a compact mobile optical system.

Mathematical Equation 33 may preferably satisfy the condition 12<TTL<14 in the fifth to seventh embodiments.

$$0 < \vert F 9 / F 1 \vert < 0.2 \qquad [ Mathematical Equation 34 ]$$

Mathematical Equation 34 may establish the relationship between the focal lengths of the first lens (501, 601, 701) and the ninth lens (509, 609, 709) in the optical system. When the optical system according to the fifth to seventh embodiments satisfies Mathematical Equation 34, the refractive power of the first and ninth lenses of the optical system can be controlled to improve resolution and affect the TTL and effective focal length (F). Mathematical Equation 34 may preferably satisfy 0<|F9/F1|<0.1 in the fifth to seventh embodiments.

$$0 < CT 8 / CT 9 < 1.5 \qquad [ Mathematical Equation 35 ]$$

In Mathematical Equation 35, CT8 denotes the thickness of the eighth lens (508, 608, 708) on the optical axis (OA), and CT9 denotes the thickness of the ninth lens (509, 609, 709) on the optical axis (OA). Mathematical Equation 35 establishes the relationship between the central thicknesses of the 8th and 9th lenses, enabling control over factors that influence aberrations. In the 5th to 7th embodiments Mathematical Equation 35 may preferably satisfy the condition 0<CT8/CT9<1.

$$1 < Σ CT / Σ CG < 2 \qquad [ Mathematical Equation 36 ]$$

In Mathematical Equation 36, ΣCT is the sum of the center thicknesses of the lenses, and ΣCG is the sum of the distances between adjacent lenses. When Mathematical Equation 36 is satisfied, the optical system can achieve good optical performance at the focal length within the specified field of view and reduce the TTL. Preferably, the fifth to seventh embodiments can satisfy 1.5<ΣCT/ΣCG<2.

$$FOV > 75 \qquad [ Mathematical Equation 37 ]$$

Mathematical Equation 37 may set the range of the field of view (Degree) in the diagonal direction of the optical system. If the optical system according to the fifth to seventh embodiments satisfies Mathematical Equation 37, the optical system can provide a mobile optical system with a field of view of 70 degrees or more. Mathematical Equation 37 may preferably satisfy 75<FOV<80 in the fifth to seventh embodiments.

$$0 < F / ImgH < 1 \qquad [ Mathematical Equation 38 ]$$

Mathematical Equation 38 may allow setting the total effective focal length (F) of the optical system and the diagonal length (ImgH) of the image sensor's optical axis. Such an optical system can have improved aberration characteristics in the size of a mobile image sensor. In the fifth to seventh embodiments, Mathematical Equation 38 may preferably satisfy 0.8<F/ImgH<1

$$30 < FOV / Fno < 40 \qquad [ Mathematical Equation 39 ]$$

Mathematical Equation 39 may establish the relationship between the diagonal field of view of the optical system and Fno. In the fifth to seventh embodiments, Mathematical Equation 39 may preferably satisfy 32<FOV/Fno<35. Here, Fno is provided to be less than 2.4 to provide a bright image.

$$0 < BFL / TD < 0.3 \qquad [ Mathematical Equation 40 ]$$

Mathematical Equation 40 may establish the relationship between the optical axis distance (TD) and the back focal length (BFL) of the lenses in an optical system. This allows the resolution of the optical system to be maintained while controlling its overall size. In the fifth to seventh embodiments, Mathematical Equation 40 preferably satisfies the condition 0<BFL/TD<0.2. When the condition value of BFL/TD is 0.2 or higher, the BFL is designed to be significantly larger than the TD, resulting in an increase in the overall size of the optical system. This makes it difficult to miniaturize the optical system and increases the distance between the 9th lens (509, 609, 709) and the image sensor, This can result in an increase in unnecessary light passing through the space between the ninth lens (509, 609, 709) and the image sensor, which may lead to degraded aberration characteristics and reduced resolution.

$$0.2 < CT 1 < 0.4 \qquad [ Mathematical Equation 41 ]$$

Mathematical Equation 41 may establish the relationship between the central thickness (CT1) of the first lens (501, 601, 701) and the optical axis. If the value is below the lower limit of Mathematical Equation 41, mass production of the actual lens becomes difficult, leading to poor manufacturability. If the value exceeds the upper limit of Mathematical Equation 42, the TTL of the optical system becomes longer, potentially causing the imaging lens system to become larger. In the fifth to seventh embodiments, Mathematical Equation 41 may preferably satisfy the condition 0.3<CT1<0.4.

$$0. 2 < CT 6 < 0.4 \qquad [ Mathematical Equation 42 ]$$

Mathematical Equation 42 may be used to set the relationship between the central thickness (CT6) of the sixth lens (506, 606, 706) on the optical axis. If the value is below the lower limit of Mathematical Equation 42, mass production of the actual lens becomes difficult, leading to poor manufacturability. If the value exceeds the upper limit of Mathematical Equation 42, the TTL of the optical system becomes longer, potentially causing the imaging lens system to become larger. In the fifth to seventh embodiments, Mathematical Equation 42 may preferably satisfy the condition 0.3<CT6<0.4.

$$0 < \vert F\_LG1 - F\_LG2 \vert < 10 \qquad [ Mathematical Equation 43 ]$$

Mathematical Equation 43 may establish the relationship between the composite focal length (F_LG1) of the first lens to the third lens located in the object side direction of the aperture (STOP) and the composite focal length (F_LG2) of the fourth lens to the ninth lens located in the image direction of the aperture (STOP). If Mathematical Equation 43 is not satisfied, the refractive power balance between the first lens group located in the object-side direction relative to the aperture (STOP) and the second lens group located in the image direction relative to the aperture (STOP) is not aligned, resulting in errors during tolerance analysis and potentially leading to low yield rates. In the fifth to seventh embodiments, Mathematical Equation 43 may preferably satisfy the condition 3<|F_LG1-F_LG2|<7.

$$0.3 < CA\_L3 / ImgH < 0.5 \qquad [ Mathematical Equation 44 ]$$

In Mathematical Equation 44, CA_L3 is the effective focal length of the third lens (503, 603, 703), and ImgH is the diagonal length (ImgH) of the image sensor's optical axis. When Mathematical Equation 44 is satisfied, the optical path entering the optical system can be controlled, and good optical performance can be achieved at the set field of view and focal length. Preferably, the fifth to seventh embodiments may satisfy the condition 0.4<CA_L3/ImgH<0.5.

$$0.3 < CA\_L1 / CA\_L9 < 0.5 \qquad [ Mathematical Equation 45 ]$$

In Mathematical Equation 45, CA_L1 is the effective diameter size of the first lens (501.601,701), and CA_L9 is the effective diameter size of the ninth lens (509,609,709). When Mathematical Equation 45 is satisfied, the optical paths of light entering the optical system and light exiting the image sensor can be controlled, and the optical system can achieve good optical performance at the set field of view and focal length. Preferably, the fifth to seventh embodiments may satisfy 0.35<CA_L1/CA_L9<0.45.

$$0. 1 < CA\_L3 / CA\_L9 < 0.4 \qquad [ Mathematical Equation 46 ]$$

In Mathematical Equation 46, CA_L3 is the effective diameter size of the third lens (503, 603, 703), and CA_L9 is the effective diameter size of the ninth lens (509, 609, 709). When Mathematical Equation 45 is satisfied, the optical paths of light entering the optical system and light exiting the image sensor can be controlled, and the optical system can achieve good optical performance at the set field of view and focal length. Preferably, the fifth to seventh embodiments may satisfy 0.2<CA_L3/CA_L9<0.35.

$$0.3 < CA\_LG1 \_AVG / CA\_LG2 \_AVG < 0.7 \qquad [ Mathematical Equation 47 ]$$

In Mathematical Equation 47, CA_LG1_AVG is the average effective diameter size of the first lens group (LG1), and CA_LG2_AVG is the average effective diameter size of the second lens group (LG2). When Mathematical Equation 47 is satisfied, the optical paths of light entering the optical system and light exiting the image sensor can be effectively controlled, enabling the optical system to achieve good optical performance at the set field of view and focal length. Preferably, the fifth to seventh embodiments may satisfy the condition 0.5<CA_LG1_AVG/CA LG2_AVG<0.6.

$$50 \% < CP\_L9S18 < 70 \% \qquad [ Mathematical Equation 48 ]$$

In Mathematical Equation 48, CP_L9S18 is the point where the critical point (Critical Point) of the sensor side 18th surface (S18) of the ninth lens (509, 609, 709) is located within the effective radius. When Mathematical Equation 48 is satisfied, various aberrations occurring in the optical system can be corrected. Preferably, the fifth to seventh embodiments may satisfy the condition 53%<CP_L9S18<67%.

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} + … \qquad [ Mathematical Equation 49 ]$$

In Mathematical Equation 49, Z, Sag, may represent the distance in the direction of the optical axis from an arbitrary position on the aspherical surface to the vertex of the aspherical surface. Y may represent the distance perpendicular to the optical axis from an arbitrary point on the aspherical surface to the optical axis. c may represent the curvature of the lens, and K can represent the conic constant. Additionally, A, B, C, D, E, and F may represent aspheric constants.

Table 16 shows the results of the Mathematical Equations 21 to 48 described above in the optical system of the embodiment. Referring to Table 16, it can be seen that the optical system satisfies at least one, two or three of the Mathematical Equations 21 to 48. In detail, the optical system according to the embodiment satisfies all of the Mathematical Equations 21 to 48. As a result, the optical system can have good optical performance in both the central and peripheral regions of the field of view (FOV) and excellent optical characteristics.

TABLE 16

| | | Fifth | Sixth | Seventh |
|---|---|---|---|---|
| Mathematical Equations | | embodiment | embodiment | embodiment |
| 21 | 0.5 < F/TTL < 1.5 | 0.6192 | 0.6100 | 0.5842 |
| 22 | 1 < F/EPD < 3 | 2.3288 | 2.3288 | 2.2876 |
| 23 | 2 < ET9/CT9 < 5 | 3.38043 | 2.042759 | 2.045149 |
| 24 | 0.5 < CT8/ET8 < 1.5 | 1.2758 | 1.1646 | 0.8585 |
| 25 | 1 < CT_Max/Air Max < 1.5 | 1.0536 | 1.0157 | 1.0508 |
| 26 | 0 < F/\|LIR1\| < 0.5 | 0.1935 | 0.2279 | 0.2343 |
| 27 | 10 < ΣIndex < 20 | 14.1674 | 14.1674 | 14.1674 |
| 28 | 20 < ΣAbb/ΣIndex < 30 | 28.4385 | 28.4385 | 28.4385 |
| 29 | 1 < Distortion < 2.5 | 2.0000 | 1.8476 | 2.0000 |
| 30 | 0 < CT1/CT2 < 1 | 0.41637 | 0.8003 | 0.4041 |
| 31 | Fno < 2.5 | 2.3288 | 2.3288 | 2.2876 |
| 32 | 0.5 < TTL/ImgH * 2 < 1 | 0.78921 | 0.796397 | 0.852934 |
| 33 | 10 < TTL < 15 | 12.9000 | 13.3900 | 13.9395 |
| 34 | 0 < \|F9/F1\| < 0.2 | 0.0360 | 0.0413 | 0.04984 |
| 35 | 0 < CT8/CT9 < 1.5 | 0.96392 | 0.557235 | 0.376875 |
| 36 | 1 < ΣCT/ΣCG < 2 | 1.51801 | 1.685091 | 1.938285 |
| 37 | FOV > 75 | 78.12 | 76.72 | 75.36 |
| 38 | 0 < F/ImgH < 1 | 0.9773 | 0.9716 | 0.9965 |
| 39 | 30 < FOV/Fno < 40 | 33.5447 | 32.9444 | 32.9434 |
| 40 | 0 < BFL/TD < 0.3 | 0.1589 | 0.1621 | 0.1691 |
| 41 | 0.2 < CT1 < 0.4 | 0.360 | 0.360 | 0.384 |
| 42 | 0.2 < CT6 < 0.4 | 0.360 | 0.360 | 0.363 |
| 43 | 0 < \|F_LG1-F_LG2\| < 10 | 6.623 | 6.185 | 3.8501 |
| 44 | 0.3 < CA_L3/ImgH < 0.5 | 0.446 | 0.459 | 0.474 |
| 45 | 0.3 < CA_L1/CA_L9 < 0.5 | 0.413 | 0.393 | 0.420 |
| 46 | 0.1 < CA_L3/CA_L9 < 0.4 | 0.289 | 0.290 | 0.312 |
| 47 | 0.3 < CA_LG1_AVG/ | 0.590 | 0.584 | 0.597 |
| | CA_LG2_AVG < 0.7 | | | |
| 48 | 50% < CP_L9S18 < 70% | 54%~57% | 58%~61% | 63%~66% |

The camera module according to the embodiment of the present invention will be described below with reference to the drawings.

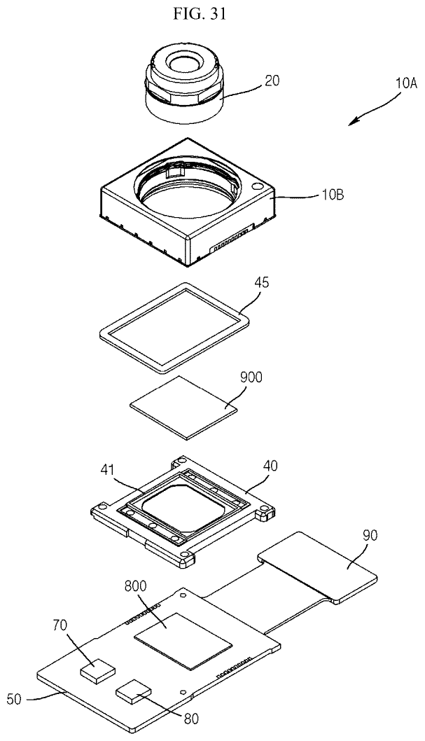

FIG. 31 is an exploded perspective view of a camera device according to the embodiment of the present invention.

The camera device (10A) may include a camera module.

The camera device (10A) may include a lens module (20). The lens module (20) may include at least one lens. The lens may be disposed at a location corresponding to an image sensor (800). The lens module (20) may include a lens and a barrel. The lens module (20) may be coupled to a bobbin (210) of a lens driving device (10B). The lens module (20) may be coupled to the bobbin (210) by screw coupling and/or adhesive. The lens module (20) may move integrally with the bobbin (210).

The camera device (10A) may include a filter (900). The filter (900) may serve to block light of a specific frequency band from passing through the lens module (20) and entering the image sensor (800). The filter (900) may be disposed parallel to the x-y plane. The filter (900) may be disposed between the lens module (20) and the image sensor (800). The filter (900) may be disposed on a sensor base (40). As a variant, the filter (900) may be disposed on the base of the lens driving device (10B). The filter (900) may include an infrared filter. The infrared filter may block infrared light from entering the image sensor (800).

The camera device (10A) may include a sensor base (40). The sensor base (40) may be disposed between the lens driving device (10B) and a printed circuit board (50). The sensor base (40) may include a protruder (41) on which the filter (900) is disposed. An opening may be formed in the portion of the sensor base (40) where the filter (900) is disposed to allow light passing through the filter (900) to enter the image sensor (800). An adhesive member (45) may be used to bond or adhere a base (410) of the lens driving device (10B) to the sensor base (40). The adhesive member (45) may additionally serve to prevent foreign matter from entering the interior of the lens driving device (10B). The adhesive member (45) may include one or more of epoxy, thermosetting adhesive, and ultraviolet-curable adhesive.

The camera device (10A) may include a printed circuit board (50) (PCB). The printed circuit board (50) may be a substrate or a circuit board. The lens driving device (10B) may be disposed on the printed circuit board (50). A sensor base (40) may be disposed between the printed circuit board (50) and the lens driving device (10B). The printed circuit board (50) may be electrically connected to the lens driving device (10B). An image sensor (800) may be disposed on the printed circuit board (50). The printed circuit board (50) may be equipped with various circuits, components, and controllers to convert the image formed on the image sensor (800) into an electrical signal and transmit it to an external device.

The camera device (10A) may include an image sensor (800). The image sensor (800) may be configured such that light passing through a lens and a filter (900) is incident and an image is formed. The image sensor (800) may be mounted on the printed circuit board (50). The image sensor (800) may be electrically connected to the printed circuit board (50). For example, the image sensor (800) may be bonded to the printed circuit board (50) using surface mounting technology (SMT). In another example, the image sensor (800) may be bonded to the printed circuit board (50) using flip chip technology. The image sensor (800) may be disposed such that its optical axis aligns with the lens's optical axis. In other words, the optical axis of the image sensor (800) and the optical axis of the lens may be aligned. The image sensor (800) can convert light incident on the effective image area of the image sensor (800) into an electrical signal. The image sensor (800) may be any one of a CCD (charge-coupled device), MOS (metal oxide semiconductor), CPD, or CID.

The camera device (10A) may include a motion sensor (70). The motion sensor (70) may be mounted on the printed circuit board (50). The motion sensor (70) may be electrically connected to the controller (80) through circuit patterns provided on the printed circuit board (50). The motion sensor (70) may output rotational angular velocity information based on the movement of the camera device (10A). The motion sensor (70) may include a two-axis or three-axis gyro sensor or an angular velocity sensor.

The camera device (10A) may include a controller (80). The controller (80) may be disposed on the printed circuit board (50). The controller (80) may be electrically connected to the AF coil and OIS coil of the lens driving device (10B). The controller (80) may individually control the direction, magnitude, and amplitude of the current supplied to the AF coil and OIS coil. The controller (80) may control the lens driving device (10B) to perform an auto focus function and/or an image stabilization function. Furthermore, the controller (80) may perform auto focus feedback control and/or image stabilization feedback control for the lens driving device (10B).

The camera device (10A) may include a connector (90). The connector (90) may be electrically connected to the printed circuit board (50). The connector (90) may include a port for electrically connecting to an external device.

The modified examples according to the present embodiment may include some configurations of the embodiment described with reference to FIGS. 1 to 12 and some configurations of the embodiment described with reference to FIGS. 13 to 30. That is, the modified examples may include the embodiment described with reference to FIGS. 1 to 12, but may omit some of the configurations of the embodiment described with reference to FIGS. 1 to 12 and include some of the configurations of the embodiment described with reference to FIGS. 13 to 30. Alternatively, the modified example may omit some configurations of the embodiment described with reference to FIGS. 13 to 30 and include some configurations of the embodiment described with reference to corresponding FIGS. 1 to 12. The features, structures, and effects described in the embodiments above are included in at least one embodiment and are not necessarily limited to a single embodiment. Furthermore, the features, structures, and effects illustrated in each embodiment may be combined or modified by those skilled in the art to other embodiments. Therefore, the contents related to such combinations and modifications should be interpreted as falling within the scope of the embodiments.

1. An optical system comprising, in sequence from an object side to an image side: a first lens having negative (−) refractive power; a second lens having negative (−) refractive power; a third lens having positive (+) refractive power; a fourth lens having positive (+) refractive power; a fifth lens having negative (−) refractive power; a sixth lens having negative (−) refractive power; a seventh lens having positive (+) refractive power; an eighth lens having negative (−) refractive power; and a ninth lens having negative (−) refractive power, wherein the thickness of the first lens among the first to ninth lenses is the smallest on the optical axis.

2. The optical system of claim 1, wherein the third has a convex shape on both sides on the optical axis.

3. The optical system of claim 1, wherein the absolute value of the focal length of the first lens is the largest among the first to seventh lenses.

4. The optical system of claim 1, wherein the sixth lens has a convex meniscus shape on the image side on the optical axis.

5. The optical system of claim 1, wherein the thickness of the sixth lens on the optical axis is smaller than the thickness of the seventh lens on the optical axis.

6. The optical system of claim 1, wherein the distance between the fifth lens and the sixth lens on the optical axis is greater than the distance between the eighth lens and the ninth lens on the optical axis.

7. The optical system of claim 1, wherein the seventh lens has a convex meniscus shape on the image side on the optical axis.

8. The optical system of claim 1, further comprising a first lens group comprising the first to third lenses and a second lens group comprising the fourth to ninth lenses, wherein the focal length of the first lens group is shorter than the focal length of the second lens group.

9. The optical system of claim 8, wherein the absolute value of the difference between the focal length of the first lens group and the focal length of the second lens group satisfies the condition of being 0 or greater and 10 or less.

10. The optical system of claim 1, satisfying the following condition:
<Condition>0.5<TTL/ImgH*2<1
(In the above condition, TTL denotes the distance from the object side surface of the first lens on the optical axis to the image sensor, and ImgH denotes the diagonal length of the image sensor on the optical axis).

11. An optical system comprising, in sequence from an object side to an image side: a first lens having negative (−) refractive power; a second lens having negative (−) refractive power; a third lens having positive (+) refractive power; a fourth lens having positive (+) refractive power; a fifth lens having negative (−) refractive power; a sixth lens having negative (−) refractive power; a seventh lens having positive (+) refractive power; an eighth lens having negative (−) refractive power; and a ninth lens having negative (−) refractive power,
wherein the thickness of the first lens on the optical axis is smaller than the thickness of the second lens on the optical axis.

12. The optical system of claim 11, wherein the third lens has a convex shape on both sides on the optical axis.

13. The optical system of claim 11, wherein the sixth lens has a convex meniscus shape on the image side on the optical axis.

14. The optical system of claim 11, wherein the seventh lens has a convex meniscus shape on the image side on the optical axis.

15. The optical system of claim 11, wherein the eighth lens has a convex meniscus shape on the image side on the optical axis.

16. An optical system comprising, in sequence from an object side to an image side: a first lens having negative (−) refractive power; a second lens having negative (−) refractive power; a third lens having positive (+) refractive power; a fourth lens having positive (+) refractive power; a fifth lens having negative (−) refractive power; a sixth lens having negative (−) refractive power; a seventh lens having positive (+) refractive power; an eighth lens having negative (−) refractive power; and a ninth lens having negative (−) refractive power,
wherein the third lens has a convex shape on both sides on the optical axis.

17. The optical system of claim 16, wherein the absolute value of the focal length of the first lens is the largest among the first to seventh lenses.

18. The optical system of claim 16, wherein the sixth lens has a convex meniscus shape on the image side on the optical axis.

19. The optical system of claim 16, wherein the seventh lens has a convex meniscus shape on the image side on the optical axis.

20. The optical system of claim 16, wherein the eighth lens has a convex meniscus shape on the image side on the optical axis.
